(19) United States
(12) Patent Application Publication
(10) Pub. No.: US 2013/0237435 A1
(43) Pub. Date: Sep. 12, 2013

(54) GENE CLUSTER, GENE SEARCHING/IDENTIFICATION METHOD, AND APPARATUS FOR THE METHOD

(71) Applicants: Masayuki Machida, Hokkaido (JP); Hideaki Koike, Ibaraki (JP); Maiko Umemura, Hokkaido (JP); Kiyoshi Asai, Tokyo (JP); Katsuhisa Horimoto, Tokyo (JP); Totai Mitsuyama, Tokyo (JP)

(72) Inventors: Masayuki Machida, Hokkaido (JP); Hideaki Koike, Ibaraki (JP); Maiko Umemura, Hokkaido (JP); Kiyoshi Asai, Tokyo (JP); Katsuhisa Horimoto, Tokyo (JP); Totai Mitsuyama, Tokyo (JP)

(73) Assignee: National Institute of Advanced Industrial Science and Technology, Chiyoda-ku, Tokyo (JP)

(21) Appl. No.: 13/825,453

(22) PCT Filed: Sep. 22, 2011
(86) PCT No.: PCT/JP2011/071731

§ 371 Date: May 16, 2013

(30) Foreign Application Priority Data
Sep. 22, 2010 (JP) 2010-212116
Mar. 10, 2011 (JP) 2011-053301
Mar. 11, 2011 (JP) 2011-053729

(51) Int. Cl. G06F 19/18

(52) U.S. Cl. CPC G06F 19/18
USPC 506/8; 506/39

(57) ABSTRACT

The present invention provides a method for searching for or identifying a useful gene logically, systematically, and efficiently in an extremely short time without largely relying on searcher's knowledge, experience, or the like and even without sequentially conducting gene disruption experiments as in conventional techniques of searching for a useful gene. The present invention also provides an apparatus for the method. Virtual gene clusters each comprising two or more genes are individually scored by summing the respective pieces of differential expression information (obtained using, for example, microarrays) of genomic genes on a per-cluster basis. On the basis of the obtained scores of the virtual gene clusters, a gene cluster containing a useful gene and the useful gene contained in the cluster are searched for.

### TECHNICAL FIELD

The present invention relates to a method for searching for or identifying a gene cluster and a useful gene for the purpose of searching for the target gene cluster and finding a novel useful gene in the gene cluster, and a searching apparatus for the method.

### BACKGROUND ART

Secondary metabolites are likely to be physiologically active and are exceedingly useful as pharmaceutical lead compounds. Diverse secondary metabolites have been found from various organism species such as ray fungi, fungi, and plants. Such secondary metabolites, however, are mostly expressed under unknown peculiar conditions. Accordingly, many secondary metabolites having useful properties may remain cryptic without being found. Alternatively, these secondary metabolites, even if found, are difficult to stably produce in sufficient amounts. This is disadvantageous to use.

With recent innovative progress in DNA sequencing techniques, the genomic information of various organism species, particularly, microbes, has accumulated at an accelerated rate. The genomic nucleotide sequences of thousands of microbial species will certainly have been elucidated 3 to 5 years later. If huge volumes of detailed information can be collected into a database or the like as to the correlation between such genomic gene sequences and the secondary metabolites, this allows prediction of information about the structures of secondary metabolites, their diversities, distributions in the living world, etc. on the basis of the gene sequences, and facilitates discovery of an unknown useful secondary metabolite and obtainment of a gene involved in the biosynthesis of the secondary metabolite. Use of this gene recombination technique also enables the secondary metabolite to be stably produced in large amounts.

Heretofore, activity screening-based search and structural determination have been practiced in order to find unknown useful secondary metabolites from various organism species. In this practice, attempts have been made to obtain information on genera or species, for example, by predicting genera from the morphological features of the organism species used or analyzing the nucleotide sequences of their rDNAs. These attempts, however, have rarely led to the identification of a gene involved in secondary metabolite production. Unfortunately, a secondary metabolite biosynthetic gene identified by such a method is often contradictory to the phylogenetic tree of genera or species. In addition, such a method hardly predicts the structures of secondary metabolites, their diversities, distributions in the living world, etc., due to the presence of many unknown genes that have not been elucidated functionally.

Also, a method for predicting a biosynthetic gene of a metabolite of interest has been practiced mainly using information such as metabolite assay (identification or quantification), genomic nucleotide sequences, and gene expression profiles from, for example, DNA microarrays prepared on the basis of the genomic nucleotide sequences. Specifically, a condition (culture condition, etc.) that improves the productivity of the metabolite of interest is established. Gene expression is assayed under this condition using DNA microarrays or the like and compared with gene expression obtained by the same assay under a condition that does not yield this metabolite, to thereby predict a gene induced by the production of this metabolite. However, the number of such induced genes usually reaches 100 to 1000 or more, for example, under varying culture conditions. Thus, the gene of interest is exceedingly difficult to identify.

Accordingly, in most cases, a plurality of conditions that yield this metabolite are established, and genes induced under all of these conditions are used as candidates. Nonetheless, frequently, no candidate is obtained as a gene inductively expressed universally under a plurality of conditions or gene candidates are too many to narrow down, on the grounds that: for example, results of an experiment using organisms are highly ambiguous; a measurement error is large (gene expression assay using a DNA microarray generally regards induction or inhibition as being actual when a difference equal to or greater than 2-fold is observed compared with a control); and the metabolic system is regulated in a complicated manner. Under the circumstances, it is almost impossible to identify the target gene.

To address these problems, the following devices or approaches have been practiced: approximately 10 to 1000 genes induced with relatively high intensity under each of the conditions are selected as candidates and reserved as candidates even if these genes are not induced commonly to all of the conditions; genes likely to be involved in the production of the metabolite of interest are selected from among candidate genes and narrowed down in consideration of their inductivity under each of the conditions; and, assuming that genes of the secondary metabolic system are likely to be clustered, candidate genes are searched for a set of genes positioned relatively close to each other on the genome and thereby narrowed down to probable genes. Such “narrowing down” has been carried out mainly by searcher's knowledge or experience or with reference to evidence, prediction, etc., described in other papers. The indispensable requirement for such a prediction process is that whether each predicted gene is actually essential for the biosynthesis of the metabolite of interest is verified sequentially for all the candidate genes by gene disruption or the like to identify the target gene. The gene disruption experiment usually requires approximately one month or longer at the earliest for several genes by a skilled technician. This step therefore consumes a great deal of time and effort. Accordingly, candidate genes narrowed down to the top 10 to 100 genes are usually subjected to the disruption experiment in order of priority. In this regard, a correct gene can be included in the top 10 candidates only by very good luck. In the absence of a transformation system, such verification itself is impossible because the gene disruption experiment cannot be conducted. For these reasons, gene identification is difficult to achieve.

Several approaches of identifying a secondary metabolism-related gene from a microbial genomic sequence have previously been reported as to NRPS and PKS (Non Patent Literatures 1 to 5). Some of these approaches have already been verified (Non Patent Literatures 3, 4, and 6). All of these approaches adopt a strategy of extracting motifs that perform specific reactions from gene sequence information by focusing on the specificity of these reactions. The range of genes to be identified is limited to NRPS and PKS. Specifically, the existing approaches are conceptually based on the one-to-one relationships between genes and functions and are essentially different from an approach proposed by the present invention based on biological findings that microbial secondary metabolism-related genes are positioned as an assembly on the genome. The approach proposed by the present invention has achieved, for the first time ahead of the existing approaches, identification of sets of genes including typical microbial secondary metabolic pathway genes NRPS and PKS as well as motifs involved in other reactions. The approach of the present invention identifies the sets of genes on the basis of expression information and can therefore exclude sets of genes that do not actually work, such as dormant genes or pseudogenes.

Alternatively, a method for identifying a gene producing an antimicrobial agent on the basis of genomic information is also disclosed (Patent Literature 1). Assuming that the antimicrobial agent is a protein or RNA as a gene product, this method identifies a gene with low “clone coverage” as a growth inhibitory gene. This method alone lacks sequence information and cannot serve as a method for searching for a gene involved in the production of exceedingly diverse secondary metabolites.
Patent Literature 1: WO2008/133479 (Univ. California)
Non Patent Literature 1: Wilkinson et al., Nat. Chem. Biol., vol. 3-7, 379-386 (2007)
Non Patent Literature 2: BMC Bioinform., vol. 10: 185, 1-10 (2009)
Non Patent Literature 3: Zazopoulos et al., Nat. Biotech., vol. 21, 187-190 (2003)
Non Patent Literature 4: Bergmann et al., Nat. Chem. Biol., vol. 3-4, 213-217 (2007)
Non Patent Literature 5: Challis et al., FEMS Microbiol. Lett., vol. 187, 111-114 (2000)
Non Patent Literature 6: Lautru et al., Nat. Chem. Biol., vol. 1-5, 265-269 (2005)

### SUMMARY OF INVENTION

### Technical Problem

An object of the present invention is to provide a method for searching for or identifying a useful gene logically, systematically, and efficiently in an extremely short time without largely relying on searcher's knowledge, experience, or the like and even without sequentially conducting gene disruption experiments as in conventional techniques of searching for a useful gene such as a gene involved in metabolite production, and to provide an apparatus for the method. The searching method and apparatus of the present invention accelerate search for a novel useful gene using genomic information that will continue to accumulate, can collect huge volumes of detailed information on the correlation between a genomic gene sequence and useful genes into a database or the like, and contribute to the discovery of many useful gene products.

### Solution to Problem

As a result of conducting diligent studies to attain the object, the present inventor have found that: conventional methods for searching for a useful gene by the expression induction or disruption experiments, etc., of genomic genes based on microarrays involve directly identifying a target gene from differential expression information on individual genomic genes, whereas virtual gene cluster units each comprising two or more genes are individually scored by summing the respective pieces of differential expression information (obtained using, for example, microarrays) of genomic genes and then, a gene cluster containing a useful gene and the useful gene contained in the cluster are detected from among these virtual gene clusters, whereby the useful gene can be searched for and identified much more accurately and efficiently than the conventional methods for searching for a useful gene. On the bases of these findings, the present invention has been completed. Specifically, the present invention is as follows:

1) The present invention provides the following method for searching for or identifying a useful gene:

(1) A method for searching for a gene cluster containing a target gene and/or the target gene in the gene cluster in the genome of an organism, comprising: individually scoring virtual gene cluster units each comprising two or more genes arranged on the genomic DNA, by summing the respective expression level fold changes of genomic genes caused between under a condition involving a change in the physiological state of organism cells and under a control condition; and, on the basis of the obtained scores, searching for a gene cluster containing a target gene which is a causative gene of the change in the physiological state and/or the target gene in the gene cluster.
(2) The method according to (1), wherein one or more comparison condition set(s) is established, each of which involves the condition involving a change in the physiological state of organism cells and the control condition.
(3) The method according to (1) or (2), wherein the comparison condition set involves at least a metabolite production inducing condition and a non-inducing condition or a metabolite production inhibiting condition and a non-inhibiting condition as the condition involving a change in the physiological state and the control condition, respectively.
(4) The method according to (3), wherein the gene involved in metabolite production is a gene involved in secondary metabolite production.
(5) The method according to any of (1) to (4), wherein the virtual gene clusters comprise, respectively, sets of genes extracted such that the number of genes is increased one by one from two consecutive genes on the genomic DNA until reaching the maximum possible number of genomic genes contained in a gene cluster and such that, with respect to each of the numbers of genes to be extracted, a starting point of the extraction is shifted one by one from a gene at one end of linear genomic DNA or from any gene in circular genomic DNA, in the order in which the genes are arranged on the genomic DNA.
(6) The method according to any of (1) to (5), wherein an assembly of the virtual gene clusters to be scored comprises virtual gene clusters comprising, respectively, sets of genes extracted such that the number of genes is increased one by one from two consecutive genes on the genomic DNA until reaching the maximum possible number of genomic genes contained in a gene cluster and such that, with respect to each of the numbers of genes to be extracted, a starting point of the extraction is shifted one by one from a gene at one end of linear genomic DNA or from any gene in circular genomic DNA, in the order in which the genes are arranged on the genomic DNA, wherein the virtual gene cluster assembly comprises all gene clusters present on the genome.
(7) The method according to any of (1) to (6), wherein the scoring of the virtual gene clusters is performed according to the following calculation formula a):

### Calculation Formula a)

$$M = \sum \frac{m - \overline{m}}{σ ( m )} \qquad [ Expression 1 ]$$

wherein M represents the score of each virtual gene cluster; m represents the expression level fold change of each gene contained in each virtual gene cluster to be scored; m̅ represents an average of the expression level fold changes (m values) of all genes contained in all virtual gene clusters; and σ(m) represents a standard deviation of the expression level fold changes (m values) of all genes contained in all virtual gene clusters.
(8) The method according to (7), wherein when any of the genes arranged on the genomic DNA is presumed to have a target gene function or presumed to have a little or no chance of having a target gene function, the following weighted calculation is applied to the gene concerned:

$$w \frac{m - \overline{m}}{σ ( m )} \qquad [ Expression 2 ]$$

wherein m represents the expression level fold change of the gene on the genomic DNA presumed to have a target gene function or presumed to have a little or no chance of having a target gene function; m̅ represents an average of the expression level fold changes (m values) of all genes contained in all virtual gene clusters; σ(m) represents a standard deviation of the expression level fold changes (m values) of all genes contained in all virtual gene clusters; and w represents any real number as a weight
(9) The method according to (7), wherein when any of the genes arranged on the genomic DNA is presumed to have a target gene function, virtual gene clusters each containing the gene presumed to have a target gene function are picked out and only the picked-out virtual gene clusters are scored.
(10) The method according to (4), wherein the virtual gene clusters are constructed from only genes in one or more of the following groups 1) to 3) or from one or more type(s) of genes including at least the genes, on the condition that the genes in each gene cluster reside in the vicinity on the genome:
1) genes of enzymes belonging to an enzyme class putatively involved in secondary metabolite production,
2) transporter genes, and
3) transcription factor-encoding genes.
(11) The method according to (10), wherein the scoring of the virtual gene clusters is performed according to the following calculation formula a):

### Calculation Formula a)

$$M = Σ \frac{m - \overline{m}}{σ ( m )} \qquad [ Expression 3 ]$$

wherein M represents the score of each virtual gene cluster; m represents the expression level fold change of each gene selected by annotation assignment, contained in each virtual gene cluster to be scored; m̅ represents an average of the expression level fold changes (m values) of all genes selected by annotation assignment, contained in all virtual gene clusters; and σ(m) represents a standard deviation of the expression level fold changes (m values) of all genes selected by annotation assignment, contained in all virtual gene clusters.
(12) The method according to any of (1) to (11), wherein virtual gene clusters each having a score diverging from the overall score distribution of the virtual gene clusters are selected as target gene cluster candidates.
(13) The method according to (12), wherein an index I (χ) indicating the degree of divergence from the overall score distribution of the virtual gene clusters is calculated according to the following calculation formula b), and on the basis of the calculated index I (χ), virtual gene clusters are selected as target gene cluster candidates:

### Calculation Formula b)

χ=−M log P [Expression 4]

wherein χ represents the index I indicating the degree of divergence of each virtual gene cluster; M represents the score of each virtual gene cluster; and P represents the frequency of appearance of each score M, wherein the cumulative total frequency of appearance of scores M is defined as 1 in the frequency distribution of the scores of all virtual gene clusters.
(14) The method according to (12), wherein an index II (υ) indicating the degree of divergence from the overall score distribution of the virtual gene clusters is calculated according to the following calculation formula c), and on the basis of the calculated index II (υ), virtual gene clusters are selected as target gene cluster candidates:

### Calculation Formula c)

υ=(M− M̅)^{d′}/(ασ(M))^{d′} [Expression 5]

wherein υ represents the index II indicating the degree of divergence of each virtual gene cluster; M represents the score of each virtual gene cluster; M̅ represents an average of the scores (M values) of all virtual gene clusters; σ(M) represents a standard deviation of the scores (M values) of all virtual gene clusters; a represents any positive real number; and d′ represents the positive even number of dimensions.
(15) The method according to (13) or (14), wherein on the basis of calculation results according to the following calculation formula d), at least virtual clusters wherein b is less than 100 are excluded to further narrow down the target gene cluster candidates:

### Calculation Formula d)

χ×υ>b [Expression 6]

wherein χ represents the index I of each virtual gene cluster calculated according to the calculation formula b) described in (13); υ represents the index II of each virtual gene cluster calculated according to the calculation formula c) described in (14); and b represents any positive real number as a threshold.

(16) A method comprising: individually scoring virtual gene cluster units each comprising two or more genes arranged on the genomic DNA, by summing the respective expression level fold changes of genomic genes caused between under a condition involving a change in the physiological state of organism cells and under a control condition; and, on the basis of the obtained scores, predicting the presence or absence of a target gene cluster in the genome or the gene size of the target gene cluster if present, wherein:

the virtual gene clusters are scored according to the following calculation formula a), the virtual gene clusters comprising, respectively, sets of genes extracted such that the number of genes is increased one by one from two consecutive genes on the genomic DNA until reaching the maximum possible number of genomic genes contained in a gene cluster and such that, with respect to each of the numbers of genes to be extracted, a starting point of the extraction is shifted one by one from a gene at one end of linear genomic DNA or from any gene in circular genomic DNA, in the order in which the genes are arranged on the genomic DNA; the respective scores of the virtual gene clusters thus obtained are grouped with respect to each of the numbers of genes contained in the gene clusters; a gene cluster score distribution index (E) is determined with respect to each of the groups of the numbers of genes according to the following calculation formula e); and the presence or absence of a preexisting target gene cluster in the genome or the gene size of the target cluster if present is predicted on the basis of the index:

### Calculation Formula a)

$$M = Σ \frac{m - \overline{m}}{σ ( m )} \qquad [ Expression 1 ]$$

wherein M represents the score of each virtual gene cluster; m represents the expression level fold change of each gene contained in each virtual gene cluster to be scored; m̅ represents an average of the expression level fold changes (m values) of all genes contained in all virtual gene clusters; and σ(m) represents a standard deviation of the expression level fold changes (m values) of all genes contained in all virtual gene clusters, and

### Calculation Formula e)

ε=Σ(M− M̅)_{d}/nσ(M)^{d} [Expression 7]

wherein ε represents a gene cluster score distribution index determined with respect to each of the numbers of genes; M represents the score of each virtual gene cluster contained in each group of the number of genes when all virtual gene clusters are grouped with respect to each of the numbers of genes; M̅ represents an average of the scores of all virtual gene clusters; n represents the total number of virtual gene clusters; σ(M) represents a standard deviation of the scores (M values) of all virtual gene clusters; and d represents the positive even number of dimensions arbitrarily set.
(17) The method according to (16), wherein the ε value when the number of genes is k (ε(k)) and the ε values when the number k of genes plus one or minus one (ε(k−1) and ε(k+1)) satisfy the following relationship, the target gene cluster is confirmed to be present in the genome and the number of genes contained in the target gene cluster is estimated as k:

ε(k)>ε(k−1) and ε(k)>ε(k+1) [Expression 8]

2) The present invention also provides the following apparatus for searching for or identifying a useful gene, and a program for the apparatus:

(18) An apparatus for searching for a gene cluster containing a target gene and/or the target gene in the gene cluster in the genome of an organism, comprising: a) means for storing the respective expression level fold changes of genes arranged on the genomic DNA between under a condition involving a change in the physiological state of organism cells and under a control condition, the expression level fold changes being calculated on the basis of the expression level data set of the genes under these two conditions; b) means for constructing virtual gene clusters by combining two or more genes arranged on the genomic DNA; c) means for individually scoring the virtual gene cluster units each comprising two or more genes arranged on the genomic DNA, by summing the respective stored calculated expression level fold changes of the genes, and storing the respective scores of the virtual gene clusters; and d) means for selecting, on the basis of the obtained scores, a gene cluster containing a target gene which is a causative gene of the change in the physiological state, or further comprising e) means for displaying the genes contained in the selected gene cluster.
(19) The apparatus according to (18), wherein the expression level data is fluorescence intensity information obtained using a DNA microarray for gene expression level measurement.
(20) The apparatus according to (19), wherein the fluorescence intensity information is numerical data output by a fluorescence intensity reader having means for reading out fluorescence intensity and converting the fluorescence intensity to a numerical value.
(21) The apparatus according to any of (18) to (20), wherein one or more comparison condition set(s) is established, each of which involves the condition involving a change in the physiological state of organism cells and the control condition, wherein the expression level data set of genes is input with respect to each of the conditions contained in the comparison condition set, and the expression level fold change of each same gene in the comparison condition set is calculated.
(22) The apparatus according to any of (18) to (21), wherein the target gene is a gene involved in metabolite production.
(23) The apparatus according to (22), wherein the gene involved in metabolite production is a gene involved in secondary metabolite production.
(24) The apparatus according to (22), wherein the established comparison condition set involves at least a metabolite production inducing condition and a non-inducing condition or a metabolite production inhibiting condition and non-inhibiting condition.
(25) The apparatus according to (24), wherein the metabolite is a secondary metabolite.
(26) The apparatus according to any of (18) to (25), wherein the virtual gene cluster constructing means constructs virtual gene clusters comprising, respectively, sets of genes extracted such that the number of genes is increased one by one from two consecutive genes on the genomic DNA until reaching the maximum possible number of genomic genes contained in a gene cluster and such that, with respect to each of the numbers of genes to be extracted, a starting point of the extraction is shifted one by one from a gene at one end of linear genomic DNA or from any gene in circular genomic DNA, in the order in which the genes are arranged on the genomic DNA.
(27) The apparatus according to any of (18) to (26), wherein the scoring of the virtual gene clusters is performed according to the following calculation formula a):

### Calculation Formula a)

$$M = Σ \frac{m - \overline{m}}{σ ( m )} \qquad [ Expression 1 ]$$

wherein M represents the score of each virtual gene cluster; m represents the expression level fold change of each gene contained in each virtual gene cluster to be scored; m̅ represents an average of the expression level fold changes (m values) of all genes contained in all virtual gene clusters; and σ(m) represents a standard deviation of the expression level fold changes (m values) of all genes contained in all virtual gene clusters.
(28) The apparatus according to (27), wherein the apparatus further has an annotation assigning means for selecting particular genes from among the genes arranged on the genomic DNA, wherein in the scoring of the gene clusters, the respective expression level fold changes of genes selected on the basis of an assigned annotation are calculated according to the following weighted calculation formula:

$$w \frac{m - \overline{m}}{σ ( m )} \qquad [ Expression 2 ]$$

wherein m represents the expression level fold change of [symbol] 304 [symbol] the gene on the genomic DNA presumed to have a target gene function or presumed to have a little or no chance of having a target gene function; m̅ represents an average of the expression level fold changes (m values) of all genes contained in all virtual gene clusters; σ(m) represents a standard deviation of the expression level fold changes (m values) of all genes contained in all virtual gene clusters; and w represents any real number as a weight.
(29) The apparatus according to (28), wherein the annotation assigning means assigns an annotation differing depending on the type of each gene function.
(30) The apparatus according to (29), wherein the genes selected on the basis of an annotation are genes in one or more of the following groups 1) to 3):
1) genes of enzymes belonging to an enzyme class putatively involved in secondary metabolite production,
2) transporter genes, and
3) transcription factor-encoding genes.
(31) The apparatus according to (27), wherein the apparatus further has an annotation assigning means described in any of (28) to (30) and means for picking out, from the constructed virtual gene clusters, virtual gene clusters containing the genes selected on the basis of an annotation, and only the picked-out virtual gene clusters are scored.
(32) The apparatus according to any of (18) to (25), wherein the apparatus further has an annotation assigning means for selecting particular genes from among the genes arranged on the genomic DNA, wherein the virtual gene cluster constructing means constructs the virtual gene clusters from only genes selected on the basis of an annotation or from one or more type(s) of genes including at least the genes, on the condition that the genes in each gene cluster are positioned in the vicinity on the genomic DNA.
(33) The apparatus according to (32), wherein the annotation assigning means described in (32) assigns an annotation according to the type of each gene function.
(34) The apparatus according to (33), wherein the genes selected on the basis of an annotation are genes in one or more of the following groups 1) to 3):
1) genes of enzymes belonging to an enzyme class putatively involved in secondary metabolite production,
2) transporter genes, and
3) transcription factor-encoding genes.
(35) The apparatus according to any of (32) to (34), wherein the scoring of the virtual gene clusters is performed according to the following calculation formula a):

### Calculation Formula a)

$$M = Σ \frac{m - \overline{m}}{σ ( m )} \qquad [ Expression 3 ]$$

wherein M represents the score of each virtual gene cluster; m represents the expression level fold change of each gene selected by annotation assignment, contained in each virtual gene cluster to be scored; m̅ represents an average of the expression level fold changes (m values) of all genes selected by annotation assignment, contained in all virtual gene clusters; and σ(m) represents a standard deviation of the expression level fold changes (m values) of all genes selected by annotation assignment, contained in all virtual gene clusters.
(36) The apparatus according to any of (18) to (35), wherein the apparatus further has means for selecting, as target gene cluster candidates, virtual gene clusters each having a score diverging from the overall score distribution of the virtual gene clusters.
(37) The apparatus according to (36), wherein the apparatus stores, as the target gene cluster candidate selecting means, a program of calculating an index I (χ) indicating the degree of divergence from the overall score distribution of the virtual gene clusters according to the following calculation formula b):

### Calculation Formula b)

χ=−M log P [Expression 4]

wherein χ represents the index I indicating the degree of divergence of each virtual gene cluster; M represents the score of each virtual gene cluster; and P represents the frequency of appearance of each score M, wherein the cumulative total frequency of appearance of scores M is defined as 1 in the frequency distribution of the scores of all virtual gene clusters.

(38) The apparatus according to (36), wherein the apparatus stores, as the target gene cluster candidate selecting means, a program of calculating an index II (υ) indicating the degree of divergence from the overall score distribution of the gene clusters according to the following calculation formula c):

### Calculation Formula c)

υ=(M− M̅)^{d′}/(ασ(M))^{d′} [Expression 5]

wherein υ represents the index II indicating the degree of divergence of each virtual gene cluster; M represents the score of each virtual gene cluster; M̅ represents an average of the scores (M values) of all virtual gene clusters; σ(M) represents a standard deviation of the scores (M values) of all virtual gene clusters; a represents any positive real number; and d′ represents the positive even number of dimensions.
(39) The apparatus according to (37) or (38), wherein the apparatus stores a program of further narrowing down the target gene cluster candidates by excluding at least virtual clusters wherein b is less than 100 on the basis of calculation results according to the following calculation formula d):

### Calculation Formula d)

χ×υ>b [Expression 9]

wherein χ represents the index I of each virtual gene cluster calculated according to the calculation formula b) described in (37); υ represents the index II of each virtual gene cluster calculated according to the calculation formula c) described in (38); and b represents any positive real number as a threshold.
(40) An apparatus for predicting the presence or absence of a target gene cluster in the genome or the gene size of the target gene cluster if present from a gene cluster distribution index (ε), comprising: a) means for inputting the respective expression levels of genes arranged on the genomic DNA, the expression levels being obtained under a condition involving a change in the physiological state of organism cells and under a control condition; b) an expression level fold change calculating means of calculating the ratio between the input expression levels of each same gene under these two conditions; c) means for individually scoring virtual gene cluster units each comprising two or more genes arranged on the genomic DNA, by summing the respective calculated expression level fold changes of the genes; and d) means for calculating a gene cluster distribution index (ε) with respect to each of the numbers of genes contained in the gene clusters, from the obtained scores of the virtual gene clusters, wherein: the apparatus further comprises means for constructing virtual gene clusters wherein the virtual gene clusters comprises, respectively, sets of genes extracted such that the number of genes is increased one by one from two consecutive genes on the genomic DNA until reaching the maximum possible number of genomic genes contained in a gene cluster and such that, with respect to each of the numbers of genes to be extracted, a starting point of the extraction is shifted one by one from a gene at one end of linear genomic DNA or from any gene in circular genomic DNA, in the order in which the genes are arranged on the genomic DNA; the virtual gene cluster unit scoring means comprises an operational unit based on the following calculation formula a); and the gene cluster distribution index (ε) calculating means is based on the following calculation formula e):

### Calculation Formula a)

$$M = Σ \frac{m - \overline{m}}{σ ( m )} \qquad [ Expression 1 ]$$

wherein M represents the score of each virtual gene cluster; m represents the expression level fold change of each gene contained in each virtual gene cluster to be scored; m̅ represents an average of the expression level fold changes (m values) of all genes contained in all virtual gene clusters; and σ(m) represents a standard deviation of the expression level fold changes (m values) of all genes contained in all virtual gene clusters, and

### Calculation Formula e)

ε=Σ(M− M̅)^{d}/nσ(M)^{d} [Expression 7]

wherein ε represents a gene cluster score distribution index determined with respect to each of the numbers of genes; M represents the score of each virtual gene cluster contained in each group of the number of genes when all virtual gene clusters are grouped with respect to each of the numbers of genes; M̅ represents an average of the scores of all virtual gene clusters; n represents the total number of virtual gene clusters; σ(M) represents a standard deviation of the scores (M values) of all virtual gene clusters; and d represents the positive even number of dimensions arbitrarily set.
(41) The apparatus according to (40), wherein the gene cluster distribution index ε value when the number of genes is k (ε(k)) and the ε values when the number of genes is k plus one or minus one (ε(k−1) and ε(k+1)) satisfy the following relationship, the target gene cluster is confirmed to be present in the genome, to produce an output indicating that the number of genes contained in the target gene cluster is estimated as k:

ε(k)>ε(k−1) and ε(k)>ε(k+1) [Expression 8]

(42) A program executing a virtual gene cluster constructing means described in (26), comprising executing the following means 1) or 2) on the basis of the positional information set of the genomic genes:
1) in the case of linear genomic gene

a. means for constructing sets of genes, wherein a gene positioned at one end of the genomic DNA is designated as a starting point, and consecutive genes on the genomic DNA are combined such that the number of genes is increased one by one in a direction toward the other end from two until reaching the maximum possible number of genes contained in a gene cluster, to construct sets of genes, the sets of genes comprising the gene designated as a starting point and being different in the number of the genes, and

b. means for constructing virtual gene clusters, wherein the gene designated as a starting point is shifted one by one in a direction toward the other end while sets of two or more genes comprising a new starting-point gene and being differ in the number of genes are constructed as same as the means a, and the constructed sets are combined with the sets of genes of the means a to construct virtual gene clusters consisting of sets of combined genes; or

2) in the case of circular genomic gene

means for sequentially performing the same process as the means 1)a and 1)b, wherein any gene on the genomic DNA is designated as a starting point, and the process is terminated when the gene designated as the initial starting point serves as a starting point again.

(43) A virtual gene cluster scoring program, comprising individually scoring virtual gene clusters constructed by a program according to (42) according to the following calculation formula a):

### Calculation Formula a)

$$M = Σ \frac{m - \overline{m}}{σ ( m )} \qquad [ Expression 1 ]$$

wherein M represents the score of each virtual gene cluster; m represents the expression level fold change of each gene contained in each virtual gene cluster to be scored; m̅ represents an average of the expression level fold changes (m values) of all genes contained in all virtual gene clusters; and σ(m) represents a standard deviation of the expression level fold changes (m values) of all genes contained in all virtual gene clusters.
(44) The program according to (43), wherein in the scoring of the gene clusters, the respective expression level fold changes of genomic genes selected on the basis of an assigned annotation are calculated according to the following weighted calculation formula:

$$w \frac{m - \overline{m}}{σ ( m )} \qquad [ Expression 2 ]$$

wherein m represents the expression level fold change of the gene on the genomic DNA presumed to have a target gene function or presumed to have a little or no chance of having a target gene function; m̅ represents an average of the expression level fold changes (m values) of all genes contained in all virtual gene clusters; σ(m) represents a standard deviation of the expression level fold changes (m values) of all genes contained in all virtual gene clusters; and w represents any real number as a weight.
(45) The scoring program according to (43), wherein the scoring program executes the scoring of the gene clusters by: selecting genomic genes on the basis of an assigned annotation; picking out, from the constructed gene clusters, virtual gene clusters containing the selected genomic genes; and scoring only the picked-out virtual gene clusters.
(46) A program executing a virtual gene cluster constructing means described in (32), wherein the program constructs virtual gene clusters from only genes selected on the basis of an annotation or from one or more type(s) of genes including at least the genes, on the condition that the genes in each gene cluster are positioned in the vicinity on the genomic DNA.
(47) A virtual gene cluster scoring program for scoring virtual gene clusters constructed by a program according to (46) according to the following calculation formula a):

### Calculation Formula a)

$$M = Σ \frac{m - \overline{m}}{σ ( m )} \qquad [ Expression 3 ]$$

wherein M represents the score of each virtual gene cluster; m represents the expression level fold change of each gene selected by annotation assignment, contained in each virtual gene cluster to be scored; m̅ represents an average of the expression level fold changes (m values) of all genes selected by annotation assignment, contained in all virtual gene clusters; and σ(m) represents a standard deviation of the expression level fold changes (m values) of all genes selected by annotation assignment, contained in all virtual gene clusters.
(48) A program for calculating the degree of divergence of the score of each virtual gene cluster calculated by a scoring program according to any of (43) to (45) and (47) from the overall score distribution of the virtual gene clusters, wherein the program calculates an index I (χ) according to the following calculation formula b):

### Calculation Formula b)

χ=−M log P [Expression 4]

wherein χ represents the index I indicating the degree of divergence of each virtual gene cluster; M represents the score of each virtual gene cluster; and P represents the frequency of appearance of each score M, wherein the cumulative total frequency of appearance of scores M is defined as 1 in the frequency distribution of the scores of all virtual gene clusters.
(49) A program for calculating the degree of divergence of the score of each virtual gene cluster calculated by a scoring program according to any of (43) to (45) and (47) from the overall score distribution of the virtual gene clusters, wherein the program calculates an index II (υ) according to the following calculation formula c):

### Calculation Formula c)

υ=(M− M̅)^{d′}/(ασ(M))^{d′} [Expression 5]

wherein υ represents the index II indicating the degree of divergence of each virtual gene cluster; M represents the score of each virtual gene cluster; M̅ represents an average of the scores (M values) of all virtual gene clusters; σ(M) represents a standard deviation of the scores (M values) of all virtual gene clusters; a represents any positive real number; and d′ represents the positive even number of dimensions.
(50) A program for use in means for individually scoring virtual gene cluster units each comprising two or more genes arranged on the genomic DNA, by summing the respective expression level fold changes of genomic genes caused between under a condition involving a change in the physiological state of organism cells and under a control condition, and means for calculating, on the basis of the obtained scores of the hypothetic gene clusters, a gene cluster distribution index (ε) with respect to each of the numbers of genes contained in the gene clusters and predicting the presence or absence of a target gene cluster in the genome or the gene size of the target gene cluster if present from the gene cluster distribution index (ε),

wherein the program executes at least the following means (A) to (C):

(A) means for constructing virtual gene clusters by the following means 1) or 2) on the basis of the positional information set of the genomic genes:
1) in the case of linear genomic gene

a. means for constructing sets of genes, wherein a gene positioned at one end of the genomic DNA is designated as a starting point, and consecutive genes on the genomic DNA are combined such that the number of genes is increased one by one in a direction toward the other end from two until reaching the maximum possible number of genes contained in a gene cluster, to construct sets of genes, the sets of genes comprising the gene designated as a starting point and being different in the number of the genes, and

b. means for constructing virtual gene clusters, wherein the gene designated as a starting point is shifted one by one in a direction toward the other end while sets of two or more genes comprising a new starting-point gene and being differ in the number of genes are constructed as same as means a, and the constructed sets are combined with the sets of genes of the means a to construct virtual gene clusters consisting of sets of combined genes; or

2) in the case of circular genomic gene

means for sequentially performing the same process as the means 1)a and 1)b, wherein any gene on the genomic DNA is designated as a starting point, and the process is terminated when the gene designated as the initial starting point serves as a starting point again;

(B) means for individually scoring the virtual gene clusters constructed by the unit (A) according to the following calculation formula a):

### Calculation Formula a)

$$w \frac{m - \overline{m}}{σ ( m )} \qquad [ Expression 1 ]$$

wherein M represents the score of each virtual gene cluster; m represents the expression level fold change of each gene contained in each virtual gene cluster to be scored; m̅ represents an average of the expression level fold changes (m values) of all genes contained in all virtual gene clusters; and σ(m) represents a standard deviation of the expression level fold changes (m values) of all genes contained in all virtual gene clusters; and
(C) means for calculating a gene cluster distribution index (ε) with respect to each of the numbers of genes contained in the virtual gene clusters according to the following calculation formula e) from the scores of the virtual gene clusters obtained by the means (B):

### Calculation Formula e)

ε=Σ(M− M̅)^{d}/nσ(M)^{d} [Expression 7]

wherein ε represents a gene cluster score distribution index determined with respect to each of the numbers of genes; M represents the score of each virtual gene cluster contained in each group of the number of genes when all virtual gene clusters are grouped with respect to each of the numbers of genes; M̅ represents an average of the scores of all virtual gene clusters; n represents the total number of virtual gene clusters; σ(M) represents a standard deviation of the scores (M values) of all virtual gene clusters; and d represents the positive even number of dimensions arbitrarily set.
(51) The program according to (50), wherein the gene cluster distribution index ε value when the number of genes is k (ε(k)) and the ε values when the number of genes is k plus one or minus one (ε(k−1) and ε(k+1)) satisfy the following relationship, the target gene cluster is confirmed to be present in the genome, to produce an output indicating that the number of genes contained in the target gene cluster is estimated as k:

ε(k)>ε(k−1) and ε(k)>ε(k+1) [Expression 8]

### Advantageous Effects of Invention

In the case of, for example, searching for a gene involved in metabolite production by conventional techniques mainly using DNA microarrays, the target gene is identified with, as an indicator, expression induction or strong expression intensity exhibited under a condition where the compound of interest is produced or the activity of interest is observed. It is however difficult to predict a correct gene with high accuracy, due to data ambiguity, errors, complexity, etc., peculiar to biological information. By contrast, in the gene searching method and apparatus of the present invention, virtual gene clusters are each constructed from two or more genes positioned adjacently or in the vicinity and first mined to search for a useful gene. This approach itself is exceedingly logical and mechanical and can identify a useful gene rapidly and accurately using a computer without largely relying on searcher's knowledge, experience, or the like as in the conventional DNA microarray analysis, while the approach can also identify a gene cluster containing the gene at the same time.

In the gene searching method of the present invention, an error, if any, in the search condition can be grasped from the obtained data alone. In this case, the search condition can be re-established to do the search over again. By contrast, the conventional methods requires verification experiments such as gene disruption experiments for determining whether analysis results are correct or not correct, and therefore inevitably requires a great deal of cost and labor. Thus, the gene searching method and apparatus of the present invention are obviously advantageous.

Also, the gene searching method and apparatus of the present invention are exceedingly suitable for search for a metabolite production-related gene, in particular, a secondary metabolite production-related gene, which has previously been difficult to achieve. This is because genes involved in secondary metabolite production are often clustered. In addition, sequence information on, for example, the useful gene, such as a secondary metabolite production-related gene, searched for and identified in this way, may be used to obtain novel analogous genes. Furthermore, the gene searching method and apparatus of the present invention can search for not only such a metabolite production-related gene but also a wide range of universal causative genes that bring about various changes in the physiological states of organisms, and by extension, gene clusters involved in such changes in the physiological states at the same time. As a result, other genes that coordinately work with the causative genes can also be identified. Thus, the present invention is exceedingly effective for searching for, for example, metabolite production-related genes, particularly, secondary metabolite production-related genes, various disease causative genes, or genes that coordinately work with these genes and can drastically improve techniques for obtainment of novel useful compounds, large-scale production thereof, pharmaceutical development, etc.

### BRIEF DESCRIPTION OF DRAWINGS

FIG. 1 is a diagram showing a flow chart of the method for searching for a gene cluster and a gene according to the present invention. This diagram shows the flow of analysis in the approach of the present invention.

FIG. 2 is a block diagram summarizing the apparatus of the present invention.

FIG. 3 is a diagram showing a flow chart of a virtual gene cluster constructing means in the apparatus of the present invention.

FIG. 4 is a diagram showing a flow chart of a virtual gene cluster scoring means in the apparatus of the present invention.

FIG. 5 is a diagram showing a flow chart of units of (a) weighted-scoring or (b) picking out and scoring virtual gene clusters on the basis of an annotation on the function concerned assigned to each gene in the apparatus of the present invention.

FIG. 6 is a diagram showing a flow chart of means for constructing virtual gene clusters using genes selected on the basis of an annotation on the function concerned in the apparatus of the present invention.

FIG. 7 is a diagram showing a flow chart of means for selecting virtual gene clusters on the basis of an index for the degree of divergence from the overall score distribution in the apparatus of the present invention.

FIG. 8 is a diagram showing a flow chart of means for narrowing down candidates for the gene cluster concerned on the basis of an index for the degree of score divergence of each virtual gene cluster in the apparatus of the present invention.

FIG. 9 is a diagram showing a flow chart of means for predicting the presence or absence of the target gene cluster contained in the gene expression level fold change data used contained in the apparatus of the present invention, and the size of the gene cluster concerned.

FIG. 10 is an example showing the behavior of a gene cluster score distribution index c.

FIG. 11 is a diagram showing the ranks of three genes essential for Aspergillus oryzae kojic acid production in all genes in terms of score m values in an array data system C1.

FIG. 12 is a diagram showing the ranks of three genes essential for Aspergillus oryzae kojic acid production in all genes in terms of score m values in an array data system C2.

FIG. 13 is a diagram showing the ranks of three genes essential for Aspergillus oryzae kojic acid production in all genes in terms of score m values in an array data system C3.

FIG. 14 is a diagram showing a score histogram of virtual gene cluster sizes ranged from 1 to 30 in Aspergillus oryzae. (Right) overall view under varying conditions and ncl values. Row: cluster size ncl=1 to 30 (from up to down), Column: systems C1, C2, and C3 from the left. (Left) enlarged view at ncl=5 in system C2. Abscissa: expression fold change score M value, Ordinate: frequency.

FIG. 15 is a diagram showing a gene cluster score distribution index ε for determining the presence or absence of the target gene cluster contained in the array data of Aspergillus oryzae. Abscissa: cluster size, Ordinate: ε value at the number of dimensions of 6.

FIG. 16 is a diagram showing an index χ for determining whether or not each virtual gene cluster is the target gene cluster in the array data acquisition system C2 of Aspergillus oryzae. Abscissa: cluster size, Ordinate: χ. A gene cluster having three kojic acid production-related genes as components has a local and global maximum at ncl=3.

FIG. 17 is a diagram showing an index υ for determining whether or not each virtual gene cluster is the target gene cluster in the array data acquisition system C2 of Aspergillus oryzae. Abscissa: cluster size, Ordinate: υ. 2 was adopted as the number d′ of dimensions. A gene cluster having three kojic acid production-related genes as components has a local and global maximum at ncl=3.

FIG. 18 is a diagram showing an estimate χ×υ for assessing whether or not each virtual gene cluster is the target gene cluster in the array data acquisition system C2 of Aspergillus oryzae. Abscissa: cluster size, Ordinate: χ×υ. 2 was adopted as the number d′ of dimensions. A gene cluster having three kojic acid production-related genes as components has a local and global maximum at ncl=3.

FIG. 19 is a diagram showing a score histogram of virtual gene cluster sizes ranged from 1 to 30 in Aspergillus oryzae after the score weighting of each virtual gene cluster according to a functional annotation. (Right) overall view under varying conditions and ncl values. Row: cluster size ncl=1 to 30 (from up to down), Column: systems C1, C2, and C3 from the left. (Left) enlarged view at ncl=5 in system C2. Abscissa: expression fold change score M value, Ordinate: frequency.

FIG. 20 is a diagram showing a gene cluster score distribution index ε for determining the presence or absence of the target gene cluster contained in the array data of Aspergillus oryzae after functional annotation-based weighting. Abscissa: cluster size, Ordinate: ε value at the number of dimensions of 6.

FIG. 21 is a diagram showing an index χ for determining whether or not each virtual gene cluster is the target gene cluster in the array data acquisition system C2 of Aspergillus oryzae after functional annotation-based weighting. Abscissa: cluster size, Ordinate: χ. A gene cluster having three kojic acid production-related genes as components has a local and global maximum at ncl=3.

FIG. 22 is a diagram showing an index υ for determining whether or not each virtual gene cluster is the target gene cluster in the array data acquisition system C2 of Aspergillus oryzae after functional annotation-based weighting. Abscissa: cluster size, Ordinate: υ. 2 was adopted as the number d′ of dimensions. A gene cluster having three kojic acid production-related genes as components has a local and global maximum at ncl=3.

FIG. 23 is a diagram showing an estimate χ×υ for assessing whether or not each virtual gene cluster is the target gene cluster in the array data acquisition system C2 of Aspergillus oryzae after functional annotation-based weighting. Abscissa: cluster size, Ordinate: χ×υ. 2 was adopted as the number d′ of dimensions. A gene cluster having three kojic acid production-related genes as components has a local and global maximum at ncl=3.

FIG. 24 is a Venn diagram showing the number of component genes having the functional annotation concerned based on a putative-gene function annotation in virtual gene clusters with a cluster size of 5 constructed from all genomic genes of Aspergillus oryzae.

FIG. 25 is a diagram showing changes in the rank of each kojic acid production-related gene cluster caused by functional annotation-based weighting in the distribution of score M values of virtual gene clusters with a cluster size of 5 in Aspergillus oryzae. (a) all virtual gene clusters, (b) virtual gene clusters each containing all of membrane transporter, transcriptional regulator, and oxidoreductase genes.

FIG. 26 is a diagram showing the rank of each kojic acid production-related gene cluster after functional annotation-based weighting in the distribution of score M values of virtual gene clusters with a cluster size of 5 in Aspergillus oryzae, wherein the functional annotation-based weighting is directed to two genes: membrane transporter and transcriptional regulator genes.

FIG. 27 is a diagram showing a score distribution resulting from the exclusion of one keyword (the membrane transporter gene is included, but the transcriptional regulator gene is not included) from functional annotations in the distribution of score M values of virtual gene clusters with a cluster size of 5 in Aspergillus oryzae.

FIG. 28 is a diagram showing a score histogram of virtual gene cluster sizes ranged from 1 to 30 in Aspergillus flavus. (Right) overall view under varying conditions and ncl values. Row: cluster size ncl=1 to 30 (from up to down), Column: systems C1, C2, and C3 from the left. (Left) enlarged view at ncl=5 in system C2. Abscissa: expression fold change score M value, Ordinate: frequency.

FIG. 29 is a diagram showing a gene cluster score distribution index ε for determining the presence or absence of the target gene cluster contained in the array data of Aspergillus flavus. Abscissa: cluster size, Ordinate: ε value at the number of dimensions of 6.

FIG. 30 is a diagram showing an index χ for determining whether or not each virtual gene cluster is the target gene cluster in the array data acquisition system C2 of Aspergillus flavus. Abscissa: cluster size, Ordinate: χ.

FIG. 31 is a diagram showing an index υ for determining whether or not each virtual gene cluster is the target gene cluster in the array data acquisition system C2 of Aspergillus flavus. Abscissa: cluster size, Ordinate: υ. 2 was adopted as the number d′ of dimensions.

FIG. 32 is a diagram showing an estimate χ×υ for assessing whether or not each virtual gene cluster is the target gene cluster in the array data acquisition system C2 of Aspergillus flavus. Abscissa: cluster size, Ordinate: χ×υ. 2 was adopted as the number d′ of dimensions.

FIG. 33 is a diagram showing a score histogram of virtual gene cluster sizes ranged from 1 to 30 in Aspergillus niger. (Right) overall view under varying conditions and ncl values. Row: cluster size ncl=1 to 30 (from up to down), Column: systems C1 and C2 from the left. (Left) enlarged view at ncl=5 in system C2. Abscissa: expression fold change score M value, Ordinate: frequency.

FIG. 34 is a diagram showing a gene cluster score distribution index ε for determining the presence or absence of the target gene cluster contained in the array data of Aspergillus niger. Abscissa: cluster size, Ordinate: ε value at the number of dimensions of 6.

FIG. 35 is a diagram showing an index χ for determining whether or not each virtual gene cluster is the target gene cluster in the array data acquisition systems C1 and C2 of Aspergillus niger. Abscissa: cluster size, Ordinate: χ. (a) C1, (b) C2.

FIG. 36 is a diagram showing an index υ for determining whether or not each virtual gene cluster is the target gene cluster in the array data acquisition systems C1 and C2 of Aspergillus niger. Abscissa: cluster size, Ordinate: υ. 2 was adopted as the number d′ of dimensions. (a) C1, (b) C2.

FIG. 37 is a diagram showing an estimate χ×υ for assessing whether or not each virtual gene cluster is the target gene cluster in the array data acquisition systems C1 and C2 of Aspergillus niger. Abscissa: cluster size, Ordinate: χ×υ. 2 was adopted as the number d′ of dimensions. (a) C1, (b) C2.

FIG. 38 is a diagram showing an index χ for determining whether or not a virtual gene cluster constructed to contain a gene having the functional annotation concerned is the target gene cluster in the array data acquisition system C2 of Aspergillus oryzae. Abscissa: cluster size, Ordinate: χ.

FIG. 39 is a diagram showing an index υ for determining whether or not a virtual gene cluster constructed to contain a gene having the functional annotation concerned is the target gene cluster in the array data acquisition system C2 of Aspergillus oryzae. Abscissa: cluster size, Ordinate: υ. 2 was adopted as the number d′ of dimensions.

FIG. 40 is a diagram showing an estimate χ×υ for assessing whether or not a virtual gene cluster constructed to contain a gene having the functional annotation concerned is the target gene cluster in the array data acquisition system C2 of Aspergillus oryzae. Abscissa: cluster size, Ordinate: χ×υ. 2 was adopted as the number d′ of dimensions.

FIG. 41 is a diagram showing virtual gene cluster numbers on the abscissa plotted against an estimate χ×υ for assessing whether or not a virtual gene cluster constructed to contain a gene having the functional annotation concerned is the target gene cluster in the array data acquisition system C2 of Aspergillus oryzae. Abscissa: virtual gene cluster ID, Ordinate: χ×υ. 2 was adopted as the number d′ of dimensions.

FIG. 42 is a diagram showing a score histogram of virtual gene cluster sizes ranged from 1 to 30 in Fusarium verticillioides. (Right) overall view at varying ncl values in systems C1 and C2. Row: cluster size ncl=1 to 30 (from up to down), Column: systems C1 and C2 from the left. (Left) enlarged view at ncl=14 in system C2. Abscissa: expression fold change score M value, Ordinate: frequency.

FIG. 43 is a diagram showing a gene cluster score distribution index e for determining the presence or absence of the target gene cluster contained in the array data of Fusarium verticillioides. Abscissa: cluster size, Ordinate: ε value at the number of dimensions of 6.

FIG. 44 is a diagram showing an index c for determining whether or not each virtual gene cluster is the target gene cluster in the array data acquisition systems C1 and C2 of Fusarium verticillioides. Abscissa: cluster size, Ordinate: χ. (Left) C1, (Right) C2.

FIG. 45 is a diagram showing an index υ for determining whether or not each virtual gene cluster is the target gene cluster in the array data acquisition systems C1 and C2 of Fusarium verticillioides. Abscissa: cluster size, Ordinate: υ. 2 was adopted as the number d′ of dimensions. (Left) C1, (Right) C2.

FIG. 46 is a diagram showing an estimate c′u for assessing whether or not each virtual gene cluster is the target gene cluster in the array data acquisition systems C1 and C2 of Fusarium verticillioides. Abscissa: virtual gene cluster starting-point gene ID, Ordinate: χ×υ. 2 was adopted as the number d′ of dimensions. The maximum absolute value of ncl was plotted for each virtual gene cluster. (Upper) C1, (Lower) C2.

FIG. 47 is a diagram showing a score histogram of virtual gene cluster sizes ranged from 1 to 30 in E. coli. (Right) overall view at varying ncl values in each system after 898, 908, and 919 minutes into culture. Row: cluster size ncl=1 to 30 (from up to down), Column: each system after 898, 908, and 919 minutes from the left. (Left) enlarged view at ncl=4 in the system after 908 minutes. Abscissa: expression fold change score M value, Ordinate: frequency.

FIG. 48 is a diagram showing a gene cluster score distribution index e for determining the presence or absence of the target gene cluster contained in the array data of E. coli. Abscissa: cluster size, Ordinate: value at the number of dimensions of 6.

FIG. 49 shows time-series data on turbidity indicating E. coli growth in the array data acquisition system of E. coli (excerpts from FIG. 1A of Reference 11). Abscissa: a length of time that passed from the start of culture, Ordinate: turbidity.

FIG. 50 is a diagram showing an index c for determining whether or not each virtual gene cluster is the target gene cluster in the array data acquisition system C2 of E. coli. Abscissa: cluster size, Ordinate: χ.

FIG. 51 is a diagram showing an index u for determining whether or not each virtual gene cluster is the target gene cluster in the array data acquisition system of E. coli. Abscissa: cluster size, Ordinate: υ. 2 was adopted as the number d′ of dimensions.

FIG. 52 is a diagram showing an estimate c′u for assessing whether or not each virtual gene cluster is the target gene cluster in the array data acquisition system of E. coli. Abscissa: cluster size, Ordinate: c′u. 2 was adopted as the number d′ of dimensions.

FIG. 53 is a diagram showing starting-point genomic gene ID on the abscissa plotted against an estimate c′u for assessing whether or not each virtual gene cluster is the target gene cluster in the array data acquisition system of E. coli. Abscissa: virtual gene cluster starting-point gene ID, Ordinate: χ×υ. 2 was adopted as the number d′ of dimensions. The maximum absolute value of ncl was plotted for each virtual gene cluster.

### DESCRIPTION OF EMBODIMENTS

The present invention relates to a method comprising: individually scoring virtual gene cluster units each comprising two or more genes arranged on the genomic DNA, by summing the respective expression level fold changes of genomic genes caused between under a condition involving a change in the physiological state of organism cells and under a control condition; and, on the basis of the obtained scores, first identifying a gene cluster containing a target gene which is a causative gene of the change in the physiological state, and further identifying the target gene from the cluster.

The present invention also relates to an apparatus for searching for a gene cluster containing a target gene and/or the target gene in the gene cluster in the genome of an organism (hereinafter, also simply referred to as the gene searching apparatus of the present invention), which reflects the method as a basic principle. The present invention further relates to an apparatus for predicting the presence or absence of a gene cluster and the size thereof by the partial application of the gene searching apparatus.

The searching method and apparatus of the present invention can be directed to a gene cluster containing a useful gene in the genome of every organism species, regardless of eukaryotes or prokaryotes.

According to the present invention, the approach and apparatus of the present invention can be applied to any known genomic sequence to search for a gene cluster and a useful gene in the cluster, even if each boundary between gene clusters is unidentified therein.

The change in the physiological state according to the present invention refers to, for example, a change in the metabolite yield of the organism, a change in the type and amount of a secretory substance, a difference in growth phase such as a growth rate, a difference in the phase of cell division such as resting phase or interphase, or a difference in cellular morphology or function (including a difference in differentiation state such as hyphae or conidia). In the present invention, one or two or more comparison condition set(s) is established, each of which involves the condition involving such a change in the physiological state and the control condition. The expression levels of genomic genes are measured under each of the conditions in each comparison condition set. The ratio (expression level fold change) therebetween is determined.

The condition involving a change in the physiological state includes a condition involving a change in the physiological state artificially induced, for example, by use of an agent or by the adjustment of a temperature, a nutrient, a medium, or a culture time and also includes a temporal condition where a change in the physiological state occurs over time without such particular induction. The control condition refers to a condition that involves no or a few changes in the physiological state which can be compared with the change in the physiological state under the condition involving a change in the physiological state.

In the case of, for example, searching for a gene cluster or gene involved in secondary metabolite production, the expression levels of genomic genes are measured under a secondary metabolite production inducing condition (or secondary metabolite production inhibiting condition) and under a secondary metabolite production non-inducing condition (or secondary metabolite producing condition) as the control condition.

The secondary metabolite production inducing condition and the secondary metabolite production non-inducing condition to be compared or the secondary metabolite production inhibiting condition and the secondary metabolite producing condition to be compared can be conditions that differ in metabolite production rate, yield, or the like. These conditions to be compared include, for example, the presence or absence of use of an agent or the adjustment of a temperature, a nutrient, or a medium and also include temporal conditions that differ in secondary metabolite yield in a time-dependent manner without such particular induction.

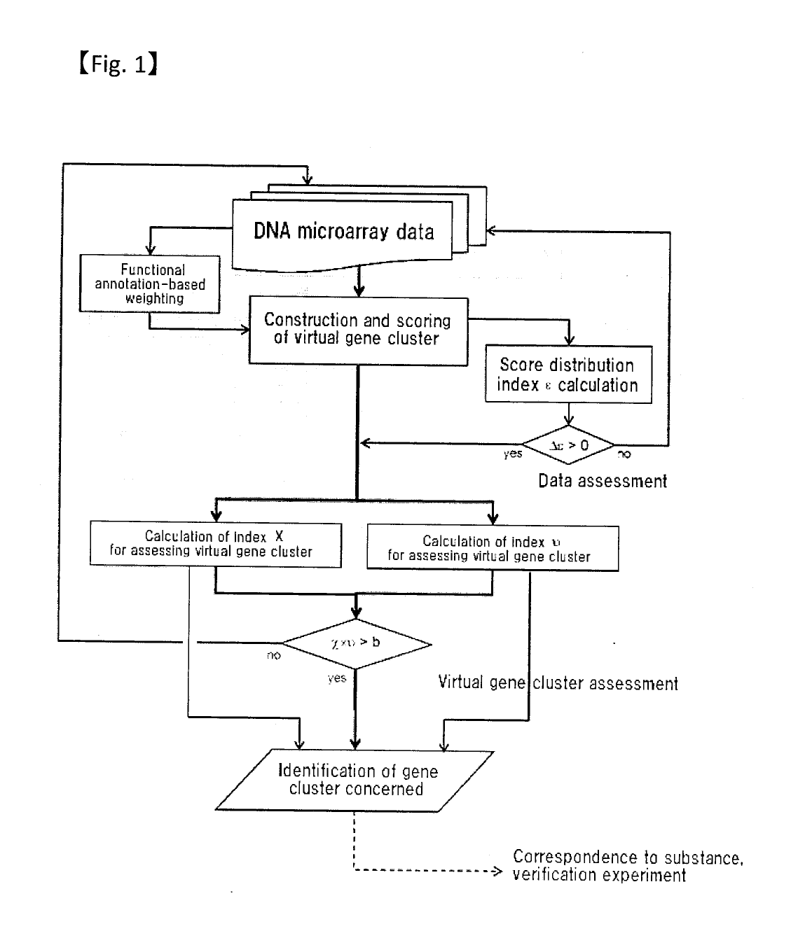

The overall flow of the method for searching for a gene cluster and a gene according to the present invention is shown in FIG. 1. In this diagram, a portion (including two open squares) within the large gray square is characteristic of the present invention.

In the process of the present invention, the expression levels of individual genes arranged on the genomic DNA are measured using, for example, microarrays, while the other procedures of the process can be performed by mathematical data processing based on the expression level data on the genes arranged on the genomic DNA. Accordingly, no experiment is required, and, for example, the selection of the genomic genes whose expression levels are to be measured can also be performed mechanically or without largely depending on searcher's special knowledge or guesswork. Thus, the searching method of the present invention is exceedingly suitable for use in computers. The present invention allows rapid and efficient search for a useful gene and is particularly effective for search for a gene involved in metabolite production, in particular, secondary metabolite production, and a gene cluster containing the gene, which has previously been difficult to achieve.

Hereinafter, the process of the present invention will be described more specifically.

Examples of the approach of constructing virtual gene clusters according to the present invention include: A) an approach whereby two or more genes arranged on the genomic DNA are combined in the order in which they are arranged to construct virtual gene clusters differing in size; and B) an approach whereby each virtual gene cluster is constructed from two or more genes that are positioned in the vicinity and may be clustered functionally. These two approaches differ in the intended range of genes whose expression levels are to be measured, and therefore differ in expression level fold change data used and genomic genes constituting the virtual gene clusters. These approaches, however, adopt other mathematical processes themselves, such as the scoring of the constructed virtual gene clusters, in common.

Hereinafter, the steps of the process of the present invention will be described specifically one by one (see FIG. 1).

### 1) Measurement of Expression Level and Acquisition of Expression Level Fold Change Data in the Approach A)

In the approach A), as a rule, the respective expression levels of all genes arranged on the genomic DNA are measured under a condition involving a change in the physiological state and under a control condition. The ratio between the expression levels under these two conditions is determined as an expression level fold change (value calculated with the expression level under the condition involving a change in the physiological state as a numerator and the expression level under the control condition as a denominator).

The expression level measurement can be performed by a method well known per se using, for example, microarrays having probes specific for the genes arranged on the genomic DNA.

In the case of targeting, for example, a useful gene involved in metabolite production, particularly, secondary metabolite production, cells are cultured under one or more secondary metabolite production inducing condition(s) (or secondary metabolite production inhibiting condition(s)). Genomic RNAs are extracted from the cells and assayed on microarrays using probes specific for the genes on the genomic DNA to measure the respective expression levels of the genes on the genomic DNA. On the other hand, their expression levels are measured under a secondary metabolite production non-inducing condition (or secondary metabolite producing condition) as the control condition. The ratio between the expression levels under these two conditions is determined and used as an expression level fold change.

Each gene expression level is measured, for example, by: extracting mRNAs from the cultured cells; labeling the mRNAs with dyes or the like; hybridizing the labeled mRNAs to oligo DNAs as probes using an array comprising an oligo DNA-immobilized substrate, the oligo DNAs each having a portion of the DNA sequence of each of the genes in each gene cluster; and washing the array, followed by measurement of luminescence intensity or the like.

### 2) Construction of Virtual Gene Cluster in the Approach A)

The virtual gene clusters comprise, respectively, sets of genes extracted such that the number of genes is increased one by one from two consecutive genes on the genomic DNA until reaching the maximum possible number of genes contained in a gene cluster and such that, with respect to each of the numbers of genes to be extracted, a starting point of the extraction is shifted one by one from a gene at one end of linear genomic DNA or from any gene in circular genomic DNA, in the order in which the genes are arranged on the genomic DNA.

This approach of constructing virtual gene clusters is more specifically shown, for example, as follows:

### (1) In the Case of Linear Genomic Gene

a) A gene positioned at one end of the genomic DNA is designated as a starting point, and consecutive genes on the genomic DNA are combined such that the number of genes is increased one by one (N+1) in a direction toward the other end from two until reaching the maximum possible number (ncl) of genes contained in a gene cluster, to construct sets of two or more genes that include the gene designated as a starting point and differ in the number of genes.

b) The gene designated as a starting point is shifted one by one in a direction toward the other end (shifting of starting-point gene) while sets of two or more genes that include a new starting-point gene and differ in the number of genes are constructed as same as above a), and the constructed sets are combined with the sets of genes of a) to construct virtual gene clusters consisting of sets of two or more combined genes.

### (2) In the Case of Circular Genomic Gene

Any gene on the genomic DNA is designated as a starting point, and the same process as above (1)a) and (1)b) are sequentially performed and terminated when the gene designated as the initial starting point serves as a starting point again (the second virtual gene cluster construction based on the gene designated as the initial starting point is not performed).

The construction of virtual gene clusters described above, each of which comprises two or more genes, adopts the approach wherein the number of genes is increased one by one from two. However, the present invention shall not preclude an approach wherein the number of genes is increased one by one from one. Specifically, in this case, the constructed virtual gene clusters coexist with single genes. In the present invention, virtual gene clusters each comprising the combination of two or more genes including such single genes coexisting therewith are constructed without exception. Furthermore, the score of each virtual gene cluster is determined by summing the respective expression level fold changes of the combined genes on a per-cluster basis. When the genome contains the target gene, the score of a virtual gene cluster containing this target gene is at least equal to or greater than the score of the target gene alone. Accordingly, the coexistence of the single genes is not a substantial problem. Thus, the present invention encompasses even the approach of constructing virtual genes wherein the number of genes is increased one by one from one gene, as long as this approach includes the approach wherein the number of genes is increased one by one from two.

In the case of, for example, 10 genes (designated as A to J) arranged on the genomic DNA as shown below, constructed virtual gene clusters comprise, respectively, sets of genes shown in Table 1.

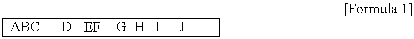

TABLE 1

| | Starting | | | | | | | | |
|---|---|---|---|---|---|---|---|---|---|
| | point | | | | | | | | |
| The number of genes | A | B | C | D | E | F | G | H | I |
| Nine virtual gene | AB | BC | CD | DE | EF | FG | GH | HI | IJ |
| clusters of 2 genes | | | | | | | | | |
| Eight virtual gene | ABC | BCD | CDE | DEF | EFG | FGH | GHI | HIJ | |
| clusters of 3 genes | | | | | | | | | |
| Seven virtual gene | ABCD | BCDE | CDEF | DEFG | EFGH | FGHI | GHIJ | | |
| clusters of 4 genes | | | | | | | | | |
| Six virtual gene | ABCDE | BCDEF | CDEFG | DEFGH | EFGHI | FGHIJ | | | |
| clusters of 5 genes | | | | | | | | | |
| Five virtual gene | ABCDEF | BCDEFG | CDEFGH | DEFGHI | EFGHIJ | | | | |
| clusters of 6 genes | | | | | | | | | |
| Four virtual gene | ABCDEFG | BCDEFGH | CDEFGHI | DEFGHIJ | | | | | |
| clusters of 7 genes | | | | | | | | | |
| Three virtual gene | ABCDEFGH | BCDEFGHI | CDEFGHIJ | | | | | | |
| clusters of 8 genes | | | | | | | | | |
| Two virtual gene | ABCDEFGHI | BCDEFGHIJ | | | | | | | |
| clusters of 9 genes | | | | | | | | | |
| One virtual gene | ABCDEFGHIJ | | | | | | | | |
| cluster of 10 genes | | | | | | | | | |

Specifically, the virtual gene clusters constructed by extraction as described above consist of the following sets of genes, respectively:

Nine virtual gene clusters of 2 genes: AB, BC, CD, DE, EF, FG, GH, HI, and IJ
Eight virtual gene clusters of 3 genes: ABC, BCD, CDE, DEF, EFG, FGH, GHI, and IJK
Seven virtual gene clusters of 4 genes: ABCD, BCDE, CDEF, DEFG, EFGH, FGHI, and GHIJ
Six virtual gene clusters of 5 genes: ABCDE, BCDEF, CDEFG, DEFGH, EFGHI, and FGHIJ
Five virtual gene clusters of 6 genes: ABCDEF, BCDEFG, CDEFGH, DEFGHI, and EFGHIJ
Four virtual gene clusters of 7 genes: ABCDEFG, BCDEFGH, CDEFGHI, and DEFGHIJ
Three virtual gene clusters of 8 genes: ABCDEFGH, BCDEFGHI, and CDEFGHIJ
Two virtual gene clusters of 9 genes: ABCDEFGHI and BCDEFGHIJ
One virtual gene cluster of 10 genes: ABCDEFGHIJ

Thus, in this case, 45 virtual gene clusters are constructed. These gene clusters are constructed merely in data and not actually constructed by experiments. In this context, the number of genes on the actual genomic DNA of, for example, Koji mold, is 12084 as recorded in the external database DOGAN (http://www.bio.nite.go.jp/dogan/project/view/AO). Alternatively, 14032 genes including more broadly defined genes were used in the preparation of DNA microarray platforms. The virtual gene clusters are constructed from proven consecutive genomic regions among these genes.

Theoretically, the upper limit of the number of genes to be extracted can be set to the number of genomic genes. The number of genes constituting the maximum possible gene cluster size may be used. In fact, the number of genes constructing each gene cluster is approximately 30 at the maximum and, usually, does not have to exceed this.

### 1′) Measurement of Expression Level and Acquisition of Expression Level Fold Change Data in the Approach B)

This approach B) is more convenient than the approach A) and is particularly suitable for search for a gene cluster involved in secondary metabolite production and the secondary metabolite production-related gene in the cluster.

In this approach, provided that genes in one or more group(s), preferably two or more groups, of (1) genes of enzymes belonging to an enzyme class putatively involved in secondary metabolism, (2) transporter genes, and (3) transcription factor-encoding genes are positioned in the vicinity in the sequence of the genomic DNA, virtual gene clusters are constructed from these genes or from combinations of genomic genes including these genes. In this case, the genes need to be positioned in the vicinity on the specific condition that the genes reside within approximately 30 genes as the upper limit in terms of the number of genes arranged on the genome.

The expression levels of the genes can be measured in the same way as in the approach A). For example, cells are cultured under a secondary metabolite production inducing condition (or secondary metabolite production inhibiting condition). Genomic RNAs are extracted from the cells and assayed on microarrays using probes specific for the genes on the genomic DNA to measure the respective expression levels of the genes on the genome. These expression levels are compared with expression levels measured under a secondary metabolite production non-inducing condition (or secondary metabolite producing condition) to determine expression level fold changes. In this approach, the expression levels of all genes on the genomic DNA are measured using microarrays. Since the differentially expressed genes to be extracted are limited to those described above, only probes having sequences corresponding to these genes may be used in the microarrays.

The secondary metabolite production inducing condition and the secondary metabolite production non-inducing condition to be compared or the secondary metabolite production inhibiting condition and the secondary metabolite producing condition to be compared can be conditions that differ in metabolite production rate, yield, or the like. These conditions to be compared include, for example, the presence or absence of use of an agent or the adjustment of a temperature, a nutrient, or a medium and also include temporal conditions that differ in secondary metabolite yield in a time-dependent manner without such particular induction.

This approach, as in the approach A), is carried out by mathematical data processing without the need of particular experiments other than the measurement of differential expression levels.

The (1) genes of enzymes belonging to an enzyme class putatively involved in secondary metabolism, (2) transporter genes, and (3) transcription factor-encoding genes in the genomic sequence can be determined, for example, from homology to genes of the same known enzyme class thereas or from motifs. For example, the presence or absence of these genes in the gene sequence of each virtual gene cluster can be determined on the basis of whether or not the gene cluster contains a nucleotide sequence encoding a common amino acid sequence for a motif specific for the amino acid sequence of each of the enzymes belonging to the enzyme class, the transporters, or the transcription factors. These procedures can be carried out using commercially available software. Specifically, these functional genes as well as genes to be weighted in the scoring of the virtual gene clusters as shown below are effectively selected by annotation (functional annotation) assignment and selection of genes of interest based on this annotation. Such annotation assignment is carried out on the basis of nucleotide sequence information, etc., on each gene on the genome to be mined, and performed for genes included in the positional information set of genes on the genome to be searched stored in a memory portion. This annotation assignment can be performed automatically using a computer.

For such annotation assignment, an apparatus user may designate every gene included in the stored positional information set of genomic genes, as a result of conducting homology or motif search or the like in advance as to the genes on the genome to be mined or searched, and then assign an annotation to the genes thus designated. The genome, however, contains a very large number of genes. Preferably, commercially available software for the motif search is stored, together with its accompanying motif information, in a computer or in the apparatus of the present invention, or an external computer in which the software is stored together with motif information is utilized. As a result, nucleotide sequence information on each gene on the genome to be mined can be input into the computer or the external computer to thereby search for a motif corresponding to the expected function and automatically select genes to be annotated. As another annotation-assigning means, the annotation may be assigned to all genes on the genome to be mined by the motif search, and genes corresponding to the expected function can then be selected from the type (gene function) of the assigned annotation.

In this way, the annotation assignment can be performed automatically without bothering a searcher. Annotations may be assigned to functionally similar genomic genes or may be assigned to plural types of functionally different genes. When annotations are assigned to plural types of functionally different genomic genes, these annotations are assigned distinguishably with respect to the respective functions of the genomic genes. In the case of targeting, for example, a gene cluster involved in secondary metabolite production or a gene in the cluster, the genes that are subject to annotation-based selection are selected as (1) genes of enzymes belonging to an enzyme class putatively involved in secondary metabolism, (2) transporter genes, and/or (3) transcription factor-encoding genes in the sequence of the genomic DNA.

In the determination of the enzyme genes (1), the enzyme class involved in secondary metabolism is deduced by estimating secondary metabolite production reaction from the chemical structure of the secondary metabolite, its precursor, coenzyme that may be involved therein, chemical or physical properties, known enzyme reaction cases, production efficiency or rate, etc. This deduction of the enzyme class does not mean that even particular enzymes that could actually have been involved in the reaction must be deduced. Rather, only more reliable enzyme class involved in the reaction may be deduced. For example, a certain enzyme may be confirmed to belong to the oxygenase family, but its species (subordinate concept) cannot be identified. In such a case, enzyme class are selected at an oxygenase level. The gene sequence of the genome is mined, and all genomic genes belonging to this category can be used as genes constituting the virtual gene clusters. However, if the enzyme class as a subordinate concept can be identified, a limited range of virtual gene clusters may be mined and search can accordingly be carried out more efficiently.

Alternatively, it may be assumed that a plurality of enzymes are involved in secondary metabolite production reaction. In such a case, a plurality of such enzyme class may be selected.

Likewise, the identification of genes involved directly in target secondary metabolite production is not necessarily required for the transporter genes and the transcription factor genes.

### 2′) Construction of Virtual Gene Cluster in the Approach B)

In the approach B), genes positioned in the vicinity in at least one or more group(s), preferably two or more groups, of 1) genes of enzymes belonging to an enzyme class putatively involved in secondary metabolism, 2) transporter genes, and 3) transcription factor-encoding genes are extracted and combined to construct virtual gene clusters. Alternatively, genes on the genomic DNA are extracted so as to include these genes to construct virtual gene clusters.

In the case of, for example, 10 genes (designated as A to J) arranged on the genomic DNA as shown below,

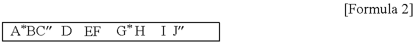

(* represents genes encoding the enzyme class concerned, and ″ represents transporter genes)
virtual gene clusters comprise sets of AC and GJ, respectively, in the former method. Alternatively, in the latter method, virtual gene clusters may comprise sets of ABC and GHIJ, respectively, or may comprise sets of a given number of genes, as in ABCDE or FGHIJ, respectively, by dividing the genome.

### 3) Scoring of Virtual Gene Cluster

The respective expression level fold changes of the genes arranged on the genomic DNA are thus acquired by the process 1) and normalized with respect to each comparison condition set. These expression level fold changes are summed according to calculation formula a) below for the virtual gene cluster units constructed by the process 2). The calculated values are used as the respective scores of the virtual gene clusters.

### Calculation Formula a)

$$w \frac{m - \overline{m}}{σ ( m )} \qquad [ Expression 1 ]$$

wherein M represents the score of each virtual gene cluster; m represents the expression level fold change of each gene contained in each virtual gene cluster to be scored; m̅ represents an average of the expression level fold changes (m values) of all genes contained in all virtual gene clusters; and σ(m) represents a standard deviation of the expression level fold changes (m values) of all genes contained in all virtual gene clusters.

In the above definitions, all genes contained in all virtual gene clusters refer to all genes on the genomic DNA extracted in order to construct all virtual gene clusters.

On the other hand, the respective expression level fold changes of the genes acquired by the process 1′) are also normalized with respect to each comparison condition set and summed for the virtual gene cluster units constructed by the process 2). This approach employs the expression level fold changes of only the particular genes selected by annotation assignment and therefore involves different definitions in the calculation formula a). Specifically, in the expression, M represents the score of each virtual gene cluster; m represents the expression level fold change of each gene selected by annotation assignment, contained in each virtual gene cluster to be scored; m̅ represents an average of the expression level fold changes (m values) of all genes selected by annotation assignment, contained in all virtual gene clusters; and s(m) represents a standard deviation of the expression level fold changes (m values) of all genes selected by annotation assignment, contained in all virtual gene clusters.

According to the present invention, the frequency distribution of the scores of a group of the virtual gene clusters thus obtained assumes substantially a normal distribution as a whole. If there exists a virtual gene cluster having a score deviating from such an overall score distribution, this virtual gene cluster can be confirmed to at least correspond to the target gene cluster.

Specifically, this virtual gene cluster has a score (which is the total differential expression level) increased as a consequence of coordination between at least two genes in the cluster under the metabolite production inducing condition, and can thus be regarded as the target gene cluster. The genes in this virtual gene cluster can be identified at least as genes that are contained in the actual gene cluster and involved in metabolite production. Further study on the genes in the virtual gene cluster and, if necessary, on the metabolite production mechanism can be expected to discover not only the target gene involved directly in metabolite production but also a gene having an unknown function, and by extension, to understand the whole picture of the metabolite production mechanism.

In the approach A), when any of the genes arranged on the genomic DNA is presumed to have a target gene function or can be presumed to have a little or no chance of having a target gene function, the gene concerned can be weighted according to the following calculation formula:

$$w \frac{m - \overline{m}}{σ ( m )} \qquad [ Expression 2 ]$$

wherein m represents the expression level fold change of the gene on the genomic DNA presumed to have a target gene function or presumed to have a little or no chance of having a target gene function; m̅ represents an average of the expression level fold changes (m values) of all genes contained in all virtual gene clusters; σ(m) represents a standard deviation of the expression level fold changes (m values) of all genes contained in all virtual gene clusters; and w represents any real number as a weight.

The weight w is set to larger than 1 for the gene presumed to have a target gene function and set to 0 or larger to smaller than 1 for the gene presumed to have a little or no chance of having a target gene function. The presumption to have a target gene function or to have little chance of having a target gene function can be made, for example, from homology to known genes or from motifs, in the same way as above, and can be made using the corresponding annotation assigning means.

Alternatively, when any of the genes arranged on the genomic DNA is presumed to have a target gene function, virtual gene clusters each containing the gene presumed to have a target gene function are picked out from among the virtual gene clusters constructed by the approach A) and only the picked-out virtual gene clusters may be scored. The presumption to have a target gene function or not can be made using all the annotation assigning means described above. According to this approach, the number of virtual gene clusters to be scored can be reduced. Alternatively, the virtual gene clusters selected by this approach may end in the same as the virtual gene clusters constructed by the approach B). In this case, however, once an exhaustive group of virtual gene clusters is constructed by the approach A), the function of a target gene or a gene cluster containing this gene can be changed freely. Thus, this approach is advantageous because function-selective gene analysis can be carried out easily. In addition, this approach can deal flexibly with the large influence of functionally unknown genes because the scores of genes that are not annotated can be taken into consideration.

The method of the present invention involves: combining two or more genes on the genomic DNA to construct virtual gene clusters; individually scoring the virtual gene clusters by summing on a per-cluster basis the respective expression level fold changes of these two or more genes caused under the condition involving a change in the physiological state; and first searching for a target gene cluster on the basis of the obtained scores. A virtual gene cluster given a high score by scoring results from the coordination between or among two or more genes contained therein and accentuates its peculiarity in the overall score distribution, compared with the expression level fold change score of each gene alone. By contrast, in the conventional detection of a useful gene based only on the differential expression level of each individual gene, even a correct gene is absorbed into the overall score distribution. Accordingly, even a high-rank gene requires verifying whether or not this gene is of interest by gene disruption experiments or the like.

In addition, the expression level fold change of the gene weighted as described above is summed with the expression level fold changes of other genes in the scoring of the virtual gene clusters constructed by the approach A). Accordingly, a virtual gene cluster containing the gene presumed to have a target gene function receives a higher score, whereas a virtual gene cluster containing the gene predicted to have a little or no chance of having a target gene function receives a lower score. Such a higher or lower score distinctly diverges from the overall score distribution. As a result, a gene having the target gene function or a gene cluster containing this gene is more efficiently searched for.

4) Calculation of Degree of Divergence from Overall Score Distribution

An index indicating the degree of divergence from the overall score distribution of the virtual gene clusters can be calculated on the basis of the scores calculated by the process 3), for example, according to the following calculation formula b) or c):

### Calculation Formula b)

χ=−M log P [Expression 4]

wherein χ represents the index I indicating the degree of divergence of each virtual gene cluster; M represents the score of each virtual gene cluster; and P represents the frequency of appearance of each score M, wherein the cumulative total frequency of appearance of scores M is defined as 1 in the frequency distribution of the scores of all virtual gene clusters.

In the calculation formula b), the frequency of appearance of the score M is a value determined with the cumulative frequency of appearance (P) of scores defined as 1 in a population comprising all the virtual gene clusters and thus, does not exceed 1. Thus, log P does not take a positive value. Since log P is closer to −∞ with lower frequency of appearance, the absolute value of log P gets larger in a gene cluster having a lower frequent score. Thus, in the calculation formula b), log P is multiplied by the score of each virtual gene cluster and then multiplied by −1. Accordingly, a virtual gene cluster having a higher score with lower frequency has a larger index I (χ).

According to the calculation formula b), a virtual gene cluster that exhibits a high index I (χ) exceeding 0 deviates from the frequency distribution of the scores of the virtual gene clusters. Such a virtual gene cluster that exhibits a high index I can be selected as a target gene cluster or a candidate corresponding to the target gene cluster. The candidate selection is carried out, for example, by selecting a given number of virtual gene clusters in descending order according to the index I or by selecting virtual clusters exhibiting a value equal to or larger than a given index I.

### Calculation Formula c)

υ=(M− M̅)^{d′}/(ασ(M))^{d′} [Expression 5]

wherein υ represents the index II indicating the degree of divergence of each virtual gene cluster; M represents the score of each virtual gene cluster; M̅ represents an average of the scores (M values) of all virtual gene clusters; σ(M) represents a standard deviation of the scores (M values) of all virtual gene clusters; a represents any positive real number; and d′ represents the positive even number of dimensions.

This index II (υ) is determined by dividing a difference of the score of each virtual gene cluster from the average score of all virtual gene clusters by the standard deviation multiplied by a real number and raising the obtained value to the power of the number (d′) of dimensions and takes a large value for a virtual gene cluster having a score diverging from the normal distribution-like frequency distribution of scores. In the expression, d′ represents the positive integral number of dimensions that can be set arbitrarily. A larger value of d′ more emphasizes a deviation from the average score. Since too large a d′ value emphasizes an outlier distant from the average score and relatively decreases the other scores, d′ is usually set to 2 or 4. In the case of more sensitively detecting an outlier, d′ is set to an even of 6 or larger. In the expression, a represents a coefficient indicating a distance. This value can be adjusted to thereby adjust to what extent an adopted score diverges from the normal distribution-like distribution. If a is set to a larger value exceeding 1, υ values other than an outlier distant from the average score are closer to zero. Thus, this a value is usually set to 1 to 2. On the other hand, if this a value is set to smaller than 1, a score less distant from the distribution can be picked out.

According to this calculation formula c) as well, a virtual gene cluster that exhibits a high index II (υ) exceeding 0, as in the index I, can be selected as a target gene cluster or a candidate corresponding to the target gene cluster. The candidate selection is carried out, for example, by selecting a given number of virtual gene clusters in descending order according to the index II or by selecting virtual clusters exhibiting a value equal to or larger than a given index II.

### 5) Narrowing Down of Gene Cluster Candidates

A large number of virtual gene clusters may be selected as target gene cluster candidates based on the index (χ or υ) calculated according to the calculation formula b) or c) and thus have to be further narrowed down. In such a case, on the basis of calculation results according to the following calculation formula d), at least virtual clusters wherein b is less than 100 can be excluded to further narrow down the target gene cluster candidates:

### Calculation Formula d)

χ×υ>b [Expression 10]

wherein χ represents the index I of each virtual gene cluster calculated according to the calculation formula b) described in [Expression 4]; υ represents the index II of each virtual gene cluster calculated according to the calculation formula c) described in [Expression 5]; and b represents any positive real number as a threshold.

In the calculation formula d), b represents a threshold for determining to what extent the gene cluster candidates are narrowed down. A larger b value is more effective for narrowing down the candidates. A smaller b value permits the selection of more candidate gene clusters. The b value is set depending on the organism species under test or culture conditions. Specifically, a system in which candidate gene clusters are strongly expressed in large amounts requires setting b to a high value. On the other hand, a system in which only a small number of candidate gene clusters are expressed with weak intensity requires setting b to a low value; otherwise candidate genes cannot appear. In the former case, b is set to any numerical value that falls within the range of, for example, 5000 to 10000 or 10000 to 30000. In the latter case, b is usually set to any numerical value of 100 or larger, for example, any numerical value that falls within the range of 1000 to 2000 or 2000 to 5000.

### 6) Prediction of Presence or Absence of Target Gene Cluster and Size of Target Gene Cluster if Present

In the present invention, the presence or absence of a preexisting target gene cluster in the genome and the gene size (the number of genes constituting the cluster; ncl) of the target gene cluster if present can be predicted.

This approach involves first individually scoring virtual gene clusters each comprising two or more genes arranged on the genomic DNA, by summing on a per-cluster basis the respective expression level fold changes of genomic genes caused between under a condition involving a change in the physiological state of organism cells and under a control condition. The processes of expression level measurement, the acquisition of expression level fold change data, the construction of virtual gene clusters, and the scoring of the virtual gene clusters can be carried out in the same way as in the processes 1) to 3) in the approach A).

Specifically, in this approach, virtual gene cluster units each comprising two or more genes on the genomic DNA are individually scored by summing the respective expression level fold changes of genomic genes caused between under a condition involving a change in the physiological state of organism cells and under a control condition, wherein the virtual gene clusters comprise, respectively, sets of genes extracted such that the number of genes is increased one by one from two consecutive genes on the genomic DNA until reaching the maximum possible number of genomic genes contained in a gene cluster and such that, with respect to each of the numbers of genes to be extracted, a starting point of the extraction is shifted one by one from a gene at one end of linear genomic DNA or from any gene in circular genomic DNA, in the order in which the genes are arranged on the genomic DNA.

The respective scores of the gene clusters thus constructed are calculated, as in the process 3) in the approach A), according to the following calculation formula a):

### Calculation Formula a)

$$M = Σ \frac{m - \overline{m}}{σ ( m )} \qquad [ Expression 1 ]$$

wherein M represents the score of each virtual gene cluster; m represents the expression level fold change of each gene contained in each virtual gene cluster to be scored; m̅ represents an average of the expression level fold changes (m values) of all genes contained in all virtual gene clusters; and σ(m) represents a standard deviation of the expression level fold changes (m values) of all genes contained in all virtual gene clusters.

Subsequently, the obtained scores are grouped with respect to each of the numbers of genes contained in the virtual gene clusters, and a gene cluster score distribution index (ε) is determined with respect to each of the groups of the numbers of genes according to the following calculation formula e):

### Calculation Formula e)

ε=Σ(M− M̅)^{d}/nσ(M)^{d} [Expression 7]

wherein ε represents a gene cluster score distribution index determined with respect to each of the numbers of genes; M represents the score of each virtual gene cluster contained in each group of the number of genes when all virtual gene clusters are grouped with respect to each of the numbers of genes; M̅ represents an average of the scores of all virtual gene clusters; n represents the total number of virtual gene clusters; σ(M) represents a standard deviation of the scores (M values) of all virtual gene clusters; and d represents the positive even number of dimensions arbitrarily set.

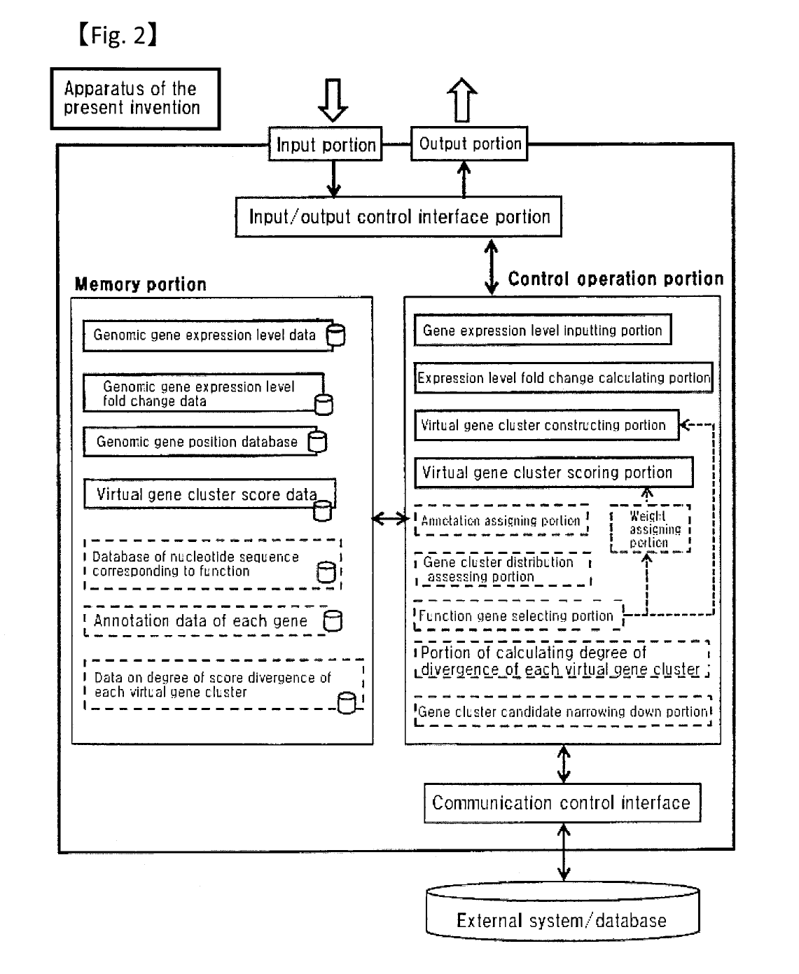

According to this calculation formula e), if a virtual gene cluster is absent in the actual genomic DNA, the score (M) of this virtual gene cluster is influenced by the genes (contained in the virtual gene cluster) that neither participate in the target change in the physiological state nor vary in expression level, and therefore averaged (i.e., closer to the average score) with increase in size (the number of genes; ncl). In this case, the ε value monotonically decreases with increase in size (see the first and third top curves in FIG. 2). However, if a virtual gene cluster with a certain size is actually present, the bias ε increases in the distribution of this size. In this case, the ε value forms a singular point at this size without assuming the monotonically decreasing curve (see the point indicated by arrow in FIG. 2). Thus, the presence of the gene cluster and the size thereof can be predicted on the basis of whether or not the ε value forms a singular point and the size of the gene cluster at which the singular point is formed.

Specifically, the ε value when the number of genes is a certain number (k)(ε(k)) and the ε values when the number of genes is plus one or minus one (ε(k−1) and ε(k+1)) satisfy the following relationship in the grouping of the virtual gene clusters with respect to each of the numbers of genes contained in the clusters, the target gene cluster can be confirmed to be present in the genome and the number of genes contained in the target gene cluster can be estimated as k:

ε(k)>ε(k−1) and ε(k)>ε(k+1) [Expression 8]

This approach is effective as a preliminary approach in performing the method for searching for a target gene cluster according to the present invention, particularly, the approach B). Specifically, if the gene cluster is present and the size thereof can be predicted, only a genomic sequence containing the target genes of enzymes belonging to the enzyme class, (2) transporter genes, and/or (3) transcription factor-encoding genes within the predicted size may be searched as the virtual gene cluster.

Even if not only a causative gene of any change in the physiological state of cells under a certain condition but also a mechanism underlying this change is totally unknown, this approach can easily predict whether or not the change is caused by the linkage between or among genes in a gene cluster and also predict the gene size of the cluster containing the linked genes responsible for the change, as long as a control condition to be compared with the condition involving the change in the physiological state can be established. Specifically, this approach is exceedingly useful because the approach can reveal that, when the physiological change of an organism is attributed to the linkage between or among two or more genes that are exceedingly difficult to search for, the genes in a gene cluster coordinately cause this change, and because the approach can also predict the size thereof.

7) In the Case where No Solution is Obtained by Approach of the Present Invention

If a gene cluster having a score diverging from the overall score distribution of the virtual gene clusters is not found as a result of performing the approach of the present invention, there is an issue with the setting of a search condition such as the established condition involving a change in the physiological state, the selection of genes to be weighted on the genomic DNA, or the selection of genes on the genomic DNA for constructing virtual gene clusters by the approach B). Thus, in such a case, the search condition is re-established, and the method for searching for a gene cluster can be performed repetitively until a gene cluster having a score deviating from the background distribution is found. Specifically, in the present invention, an issue with search condition setting can be grasped from the obtained data alone.

By contrast, in the case of the conventional methods as described above, even a correct gene inherently gets lost in the overall distribution of gene expression levels. Accordingly, from the obtained data, it is uncertain whether or not the solution is correct. As a consequence, a verification experiment that may be meaningless must be repeated.

Next, the gene searching apparatus of the present invention for use in carrying out the process of the present invention will be described.

The gene searching apparatus of the present invention performs mathematical data processing on the basis of expression level data on genes arranged on the genomic DNA. The gene searching apparatus of the present invention allows rapid and efficient search for a useful gene without largely depending on searcher's special knowledge or guesswork and is particularly effective for search for a gene involved in metabolite production, in particular, secondary metabolite production, and a gene cluster containing the gene, which has previously been difficult to achieve.

The gene searching apparatus of the present invention comprises at least the following means a) to f):

a) means for inputting the expression level data set of genes arranged on the genomic DNA, the expression level data being obtained under a condition involving a change in the physiological state of organism cells and under a control condition;
b) means for calculating the ratio between the input expression levels of each gene under these two conditions;
c) means for constructing virtual gene clusters by combining two or more genes arranged on the genomic DNA;
d) means for individually scoring the virtual gene cluster units each comprising two or more genes arranged on the genomic DNA, by summing the respective calculated expression level fold changes of the genes; and
e) means for selecting, on the basis of the obtained scores, a gene cluster containing a target gene which is a causative gene of the change in the physiological state, or
further comprises
f) means for displaying the genes contained in the selected gene cluster.

The apparatus of the present invention comprising such units is summarized in FIG. 2. In FIG. 2, the dotted boxes represent further data preferably stored in the apparatus of the present invention and processing portions associated with the data.

The apparatus of the present invention comprises a data input/output portion (a keyboard, a mouse, a display, etc.), an input/output control interface executing the control of the input/output portion, a memory portion (hard disk), a main memory portion (memory), a control operation portion (CPU), and a communication control interface that is connected to an external network.

The memory portion in this apparatus stores the expression level data set of genes, expression level fold change data, the positional data sets of genomic genes, and the score data set of the virtual gene clusters and further sequentially stores, if necessary, data on the relationship between gene functions and nucleotide sequences, annotation data on each gene, and data indicating the degree of score divergence of each virtual gene cluster.

The control operation portion is provided with at least a portion of calculating the respective expression level fold changes of genomic genes, a virtual gene cluster constructing portion which constructs virtual gene clusters on the basis of the positional information set of the genomic genes, and a virtual gene cluster scoring portion which individually scores the virtual gene clusters by summing the calculated expression level fold changes on a per-cluster basis.

If necessary, this portion may be further provided with: a gene annotation assigning portion; a weight assigning portion which performs weighting for the scoring of virtual gene clusters according to the annotation; a functional gene selecting portion for constructing virtual gene clusters limited to selected functional genes; and a portion of calculating the degree of divergence of each virtual gene cluster, which calculates the degree of divergence from the overall distribution of the virtual gene clusters, and may be further provided with a gene cluster candidate narrowing down portion which narrows down gene cluster candidates when gene cluster candidates cannot be selected sufficiently on the basis of the calculated degree of divergence.

Alternatively, the gene searching apparatus of the present invention may further retain a function of predicting the presence or absence of a target gene cluster and the size of the target gene cluster if present, with apparatus configuration unchanged. In this case, the apparatus is provided with a size scoring portion which scores virtual gene clusters on a size basis, and a virtual gene cluster distribution index (ε) calculating portion.

This apparatus does not require a special computer and can be constructed of a general control operation processing device (CPU), main memory device (memory), memory device (hard disk), and input/output device (a keyboard, a mouse, and a display). Any of Linux, Windows, and Mac can be used as an operating system. In consideration of memory space, a 64-bit system is more desirable. The memory desirably has a capacity of at least 2 GB or more, taking it into consideration that this apparatus is directed to the whole genome of an organism. A memory having a capacity of approximately 1 GB may be used for microbes.

In this context, the positional information set of genomic genes and the database of nucleotide sequences corresponding to functions are available from external databases such as NCBI (http://www.ncbi.nlm.nih.gov/) and InterproScan (http://www.ebi.ac.uk/Tools/InterProScan/).

Hereinafter, the apparatus of the present invention will be described specifically according to its processes.

### A) Gene Searching Apparatus

### 1) Inputting of Expression Level Data Set of Genes Arranged on Genomic DNA and Calculation of Expression Level Fold Change

In the apparatus of the present invention, as a rule, the respective expression levels of all genes arranged on the genomic DNA are measured under a condition involving a change in the physiological state and under a control condition. The obtained expression level data set of genes is input to the input unit in the apparatus of the present invention. On the basis of the input expression level data set of genes, their expression level fold changes are calculated.

The expression level measurement can be performed by a method well known per se using, for example, microarrays having probes specific for the genes arranged on the genomic DNA.

In the case of targeting, for example, a useful gene involved in metabolite production, particularly, secondary metabolite production, cells are cultured under one or more secondary metabolite production inducing condition(s) (or secondary metabolite production inhibiting condition(s)). Genomic RNAs are extracted from the cells and assayed on microarrays using probes specific for the genes on the genomic DNA to measure the respective expression levels of the genes on the genomic DNA. On the other hand, their expression levels are measured under a secondary metabolite production non-inducing condition (or secondary metabolite producing condition) as the control condition. The ratio between the expression levels under these two conditions is determined and used as an expression level fold change.

Each gene expression level is measured, for example, by: extracting mRNAs from the cultured cells; labeling the mRNAs with dyes or the like; hybridizing the labeled mRNAs to oligo DNAs as probes using an array comprising an oligo DNA-immobilized substrate, the oligo DNAs each having a portion of the DNA sequence of each of the genes; and washing the array, followed by measurement of luminescence intensity or the like.

The luminescence intensity of each gene in the microarray is read out using, for example, an image reading unit with a scanning unit in a microarray reader. The read-out luminescence intensity is converted to a numerical value and input to the apparatus of the present invention through the input unit a). A commercially available apparatus can be used as such an image reader. All or some (e.g., a numerical value conversion unit) of the units in such a reader may be incorporated into the apparatus of the present invention. Alternatively, the apparatus of the present invention may be designed so that numerical data output from the reader can be input automatically to the input unit.

The numerical data about the luminescence intensity of each gene under the two conditions input to the apparatus of the present invention is stored in the memory portion of the apparatus of the present invention. This stored numerical data obtained under the conditions is called up for each gene. The expression level fold change (value calculated with the expression level under the condition involving a change in the physiological state as a numerator and the expression level under the control condition as a denominator) of each gene (same gene) is calculated by the expression level fold change calculating means having an expression level fold change calculating program. This calculation also involves, if necessary, correcting a distortion attributed to the expression intensity of each gene. Specifically, the expression level fold change of a gene depends on the intensity of its expression and may be emphasized by the influence of a noise. Accordingly, background correction is performed so that the distribution of expression level fold changes is substantially constant among expression intensities. Such a process of calculating these expression level fold changes can utilize, for example, Lowess algorithm in the free software R. The calculated expression level fold change of each gene is stored in the memory portion of the apparatus of the present invention. Meanwhile, this expression level fold change of each gene is determined in advance from expression level data on the gene under the two conditions, and this differential expression level may be input to this apparatus and stored in the memory device of the apparatus.

### 2) Construction of Virtual Gene Cluster

a) The gene searching apparatus of the present invention stores the positional information set of the genomic genes, including the sequence information set and/or position numbers of the genomic genes, and a virtual gene constructing program which constructs virtual gene clusters, as the virtual gene cluster constructing means.

The virtual gene clusters are constructed by the execution of the virtual gene cluster constructing program based on the positional information set of the genomic genes.

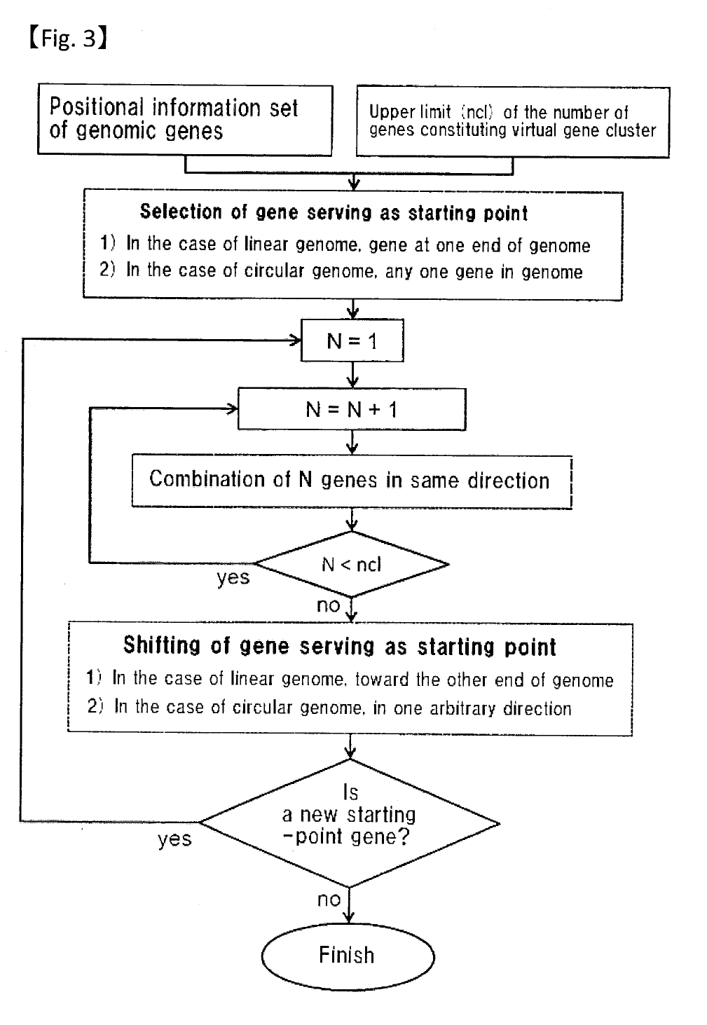

Specifically, the virtual gene clusters comprise, respectively, sets of genes extracted such that the number of genes is increased one by one from two consecutive genes on the genomic DNA in the same direction until reaching the maximum possible number of genes contained in a gene cluster and such that, with respect to each of the numbers of genes to be extracted, a starting point of the extraction is shifted one by one from a gene at one end of linear genomic DNA or from any gene in circular genomic DNA, in the order in which the genes are arranged on the genomic DNA. To construct such virtual gene clusters, the virtual gene cluster constructing program executes a process shown below on the basis of the positional information set of genes on the genomic DNA stored in the memory device of the apparatus of the present invention. The procedures of the process are shown in FIG. 3. In FIG. 3, N represents the number of genes constituting each virtual gene cluster.

### (1) In the Case of Linear Genomic Gene

a) A gene positioned at one end of the genomic DNA is designated as a starting point, and consecutive genes on the genomic DNA are combined such that the number of genes is increased one by one (N+1) in a direction toward the other end from two until reaching the maximum possible number (ncl) of genes contained in a gene cluster, to construct sets of two or more genes that include the gene designated as a starting point and differ in the number of genes.

b) The gene designated as a starting point is shifted one by one in a direction toward the other end (shifting of starting-point gene) while sets of two or more genes that include a new starting-point gene and differ in the number of genes are constructed by the same process as above a), and the constructed sets are combined with the sets of genes of a) to construct virtual gene clusters consisting of sets of two or more combined genes.

### (2) In the Case of Circular Genomic Gene

Any gene on the genomic DNA is designated as a starting point, and the same process as above (1)a) and (1)b) is sequentially performed and terminated when the gene designated as the initial starting point serves as a starting point again (the second virtual gene cluster construction based on the gene designated as the initial starting point is not performed).

The construction of virtual gene clusters described above, each of which comprises two or more genes, adopts the approach wherein the number of genes is increased one by one from two. However, the present invention shall not preclude an approach wherein the number of genes is increased one by one from one. Specifically, in this case, the constructed virtual gene clusters coexist with single genes. In the present invention, virtual gene clusters each comprising the combination of two or more genes including such single genes coexisting therewith are constructed without exception. Furthermore, the score of each virtual gene cluster is determined by summing the respective expression level fold changes of the combined genes on a per-cluster basis. When the genome contains the target gene, the score of a virtual gene cluster containing this target gene is at least equal to or greater than the score of the target gene alone. Accordingly, the coexistence of the single genes is not a substantial problem. Thus, the present invention encompasses even the approach of constructing virtual genes wherein the number of genes is increased one by one from one gene, as long as this approach includes the approach wherein the number of genes is increased one by one from two.

The positional information set of the genomic genes can be used in gene checking in the scoring of the virtual gene clusters as described later by conferring similar positional information to expression level data obtained using microarrays. In addition, this positional information also serves as an identifier for weighting particular genes or selecting virtual gene clusters on the basis of the particular genes.

Alternatively, instead of storing the positional information set of the genomic genes as described above, for example, DNAs may be aligned in advance on microarrays in the order in which they are arranged on the genomic DNA. In this case, the order in which the genes are arranged on the genomic DNA is directly input to the apparatus, and the input order of the genes is stored as gene position numbers. As a result, virtual gene clusters can also be constructed using the position numbers.

This virtual gene cluster constructing program may set the upper limit of the number of genes to be combined according to a command. 30 genes at the maximum suffice in most cases, though the upper limit depends on the gene clusters to be searched.

The virtual gene clusters thus constructed are stored in the memory portion.

In the case of, for example, 10 genes (designated as A to J) arranged on the genomic DNA as shown below, constructed virtual gene clusters comprise the following sets of genes, respectively (Table 1).

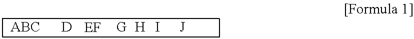

TABLE 1

| | Starting | | | | | | | | |
|---|---|---|---|---|---|---|---|---|---|
| | point | | | | | | | | |
| The number of genes | A | B | C | D | E | F | G | H | I |
| Nine virtual gene | AB | BC | CD | DE | EF | FG | GH | HI | IJ |
| clusters of 2 genes | | | | | | | | | |
| Eight virtual gene | ABC | BCD | CDE | DEF | EFG | FGH | GHI | HIJ | |
| clusters of 3 genes | | | | | | | | | |
| Seven virtual gene | ABCD | BCDE | CDEF | DEFG | EFGH | FGHI | GHIJ | | |
| clusters of 4 genes | | | | | | | | | |
| Six virtual gene | ABCDE | BCDEF | CDEFG | DEFGH | EFGHI | FGHIJ | | | |
| clusters of 5 genes | | | | | | | | | |
| Five virtual gene | ABCDEF | BCDEFG | CDEFGH | DEFGHI | EFGHIJ | | | | |
| clusters of 6 genes | | | | | | | | | |
| Four virtual gene | ABCDEFG | BCDEFGH | CDEFGHI | DEFGHIJ | | | | | |
| clusters of 7 genes | | | | | | | | | |
| Three virtual gene | ABCDEFGH | BCDEFGHI | CDEFGHIJ | | | | | | |
| clusters of 8 genes | | | | | | | | | |
| Two virtual gene | ABCDEFGHI | BCDEFGHIJ | | | | | | | |
| clusters of 9 genes | | | | | | | | | |
| One virtual gene | ABCDEFGHIJ | | | | | | | | |
| cluster of 10 genes | | | | | | | | | |

Thus, in this case, 45 virtual gene clusters are constructed. These gene clusters are merely constructed on the basis of data processing in the apparatus of the present invention and not actually constructed by experiments. In this context, the number of genes on the actual genomic DNA of, for example, Koji mold, is 12084 as recorded in the external database DOGAN (http://www.bio.nite.go.jp/dogan/project/view/AO). Alternatively, 14032 genes including more broadly defined genes were used in the preparation of DNA microarray platforms. The virtual gene clusters are constructed from proven consecutive genomic regions among these genes.

Theoretically, the upper limit of the number of genes to be extracted can be set to the number of genomic genes. The number of genes constituting the maximum possible gene cluster size may be used. In fact, the number of genes constructing each gene cluster is approximately 30 at the maximum and, usually, does not have to exceed this for gene cluster construction.

### 3) Scoring of Virtual Gene Cluster

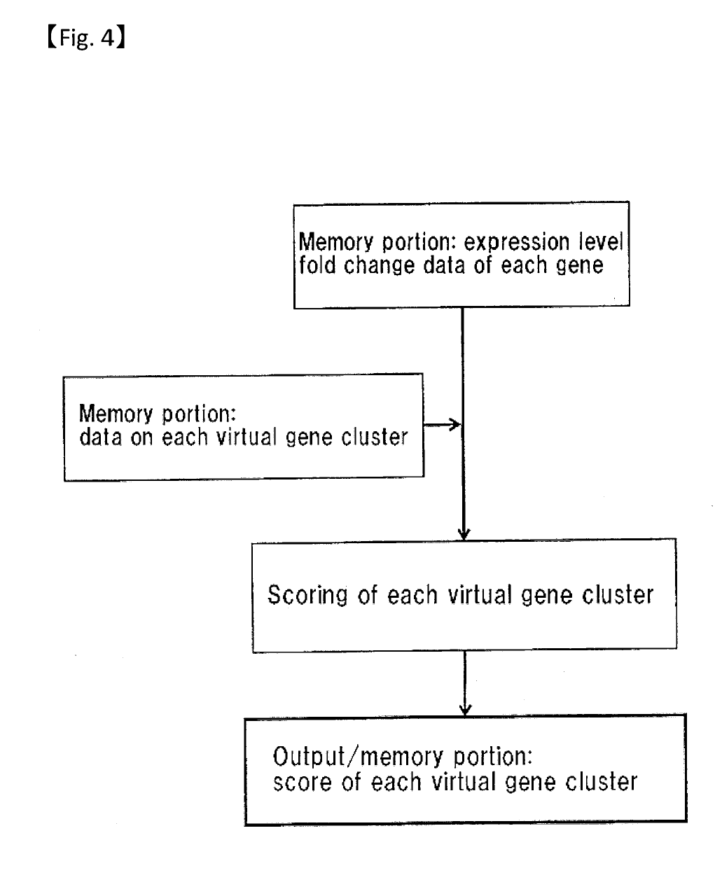

The virtual gene clusters thus constructed are scored by the scoring means of the apparatus of the present invention. The scoring means is executed by a scoring program stored in the process operation portion of this apparatus (FIG. 4).

The program calls up the expression level fold change data on each gene on the genomic DNA and the constructed virtual gene cluster information stored in the memory portion, and checks the genes constituting each virtual gene cluster against genes in the expression level fold change data, to execute the unit of individually calculating the scores of the virtual gene clusters according to the calculation formula a by summing the respective expression level fold changes of the genes on a per-cluster basis. The obtained scores of the virtual gene clusters are output and/or stored in the memory portion.

### Calculation Formula a)

$$M = Σ \frac{m - \overline{m}}{σ ( m )} \qquad [ Expression 1 ]$$

wherein M represents the score of each virtual gene cluster; m represents the expression level fold change of each gene contained in each virtual gene cluster to be scored; m̅ represents an average of the expression level fold changes (m values) of all genes contained in all virtual gene clusters; and σ(m) represents a standard deviation of the expression level fold changes (m values) of all genes contained in all virtual gene clusters.

In the above definitions of the expression, all genes contained in all virtual gene clusters refer to all genes on the genomic DNA extracted in order to construct all virtual gene clusters.

According to the present invention, the frequency distribution of the scores of a group of the virtual gene clusters thus obtained assumes substantially a normal distribution as a whole. If there exists a virtual gene cluster having a score deviating from such an overall score distribution, this virtual gene cluster can be confirmed to at least correspond to the target gene cluster.

Specifically, this virtual gene cluster has a score (which is the total differential expression level) increased as a consequence of coordination between at least two genes in the cluster under the condition involving a change in the physiological state such as the metabolite production inducing condition, and can thus be regarded as the target gene cluster. The genes in this virtual gene cluster can be identified at least as genes that are contained in the actual gene cluster and involved in the change in the physiological state such as metabolite production. Further study on the genes in the virtual gene cluster and, if necessary, on the metabolite production mechanism can be expected to discover not only the target gene involved directly in metabolite production but also a gene having an unknown function, and by extension, to understand the whole picture of the metabolite production mechanism.

### 4) Annotation Assignment

The gene searching apparatus of the present invention can be further provided with means for assigning an annotation to the input genomic genes. The annotation assignment is performed when any of the genomic genes is presumed to have a target gene function or can be presumed to have a little or no chance of having a target gene function.

Such annotation assignment is carried out on the basis of nucleotide sequence information, etc., on each gene on the genome to be mined, and performed for genes included in the positional information set of genomic genes stored in a memory portion.

For this annotation assigning means, an apparatus user may designate every gene included in the stored positional information set of genomic genes, as a result of conducting homology or motif search or the like in advance as to the genes on the genome to be mined or searched, and then assign annotations to the genes thus designated. The genome, however, contains a very large number of genes. Preferably, commercially available software for the motif search is stored, together with its accompanying motif information, in the apparatus of the present invention, or an external computer in which the software is stored together with motif information is rendered accessible. As a result, nucleotide sequence information on each gene on the genome to be mined can be input into the input unit in the apparatus of the present invention or into the external computer to thereby search for a motif corresponding to the expected function and automatically select genes to be annotated. As another annotation-assigning means, annotations may be assigned to all genes on the genome to be mined by the motif search, and genes corresponding to the expected function can then be selected from the type (gene function) of the assigned annotation.

The selected genes are checked against genes included in the positional information set of the genomic genes stored in the memory portion of the apparatus of the present invention.

According to such a system, the annotation assignment can be performed automatically without bothering a searcher. Annotations may be assigned to functionally similar genomic genes or may be assigned to plural types of functionally different genes. When annotations are assigned to plural types of functionally different genomic genes, these annotations are assigned distinguishably with respect to the respective functions of the genomic genes. In the case of targeting, for example, a gene cluster involved in secondary metabolite production or a gene in the cluster, the genes that are subject to annotation-based selection are selected as (1) genes of enzymes belonging to an enzyme class putatively involved in secondary metabolism, (2) transporter genes, and/or (3) transcription factor-encoding genes in the sequence of the genomic DNA.

### 5) Scoring of Virtual Gene Cluster Containing Annotated Gene—1—

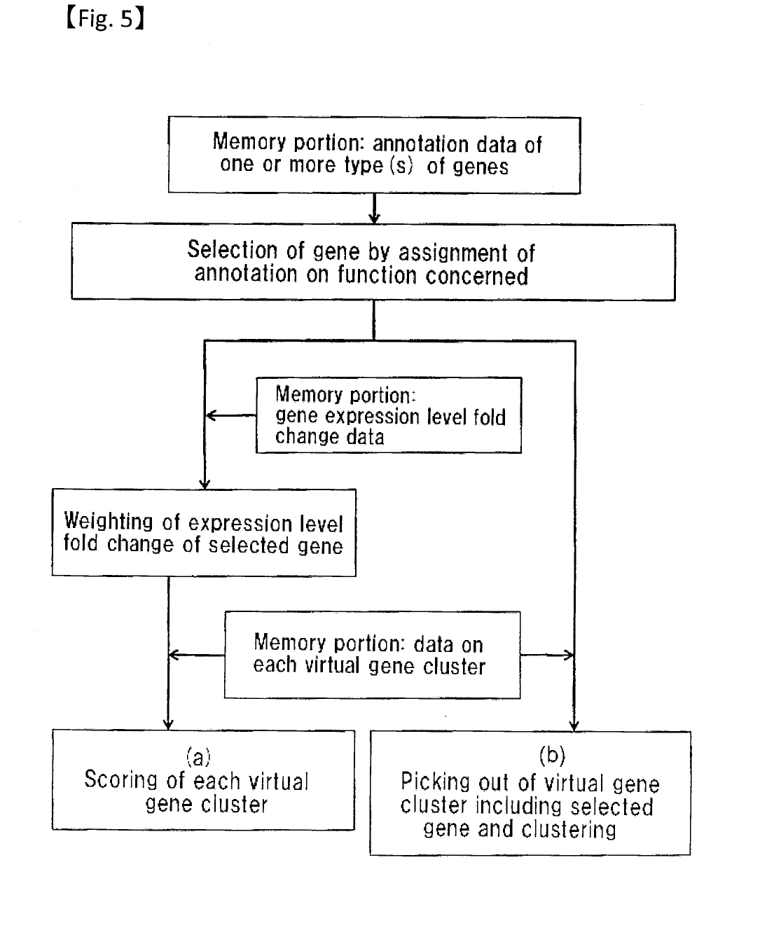

(1) To score each virtual gene cluster containing the gene with an assigned annotation on the function concerned, the gene searching apparatus of the present invention can store a weighted scoring program which weights the expression level fold change of this gene (FIG. 5). As a result, the expression level fold change of each genomic gene selected on the basis of an annotation is weighted, and each virtual gene cluster is scored. This weighted scoring program executes a weighted calculating means according to the following calculation formula on the gene selected on the basis of an annotation for the scoring of each virtual gene cluster and also executes the same units as in the scoring program described in the paragraph 3):

$$w \frac{m - \overline{m}}{σ ( m )} \qquad [ Expression 2 ]$$

wherein m represents the expression level fold change of the gene on the genomic DNA presumed to have a target gene function or presumed to have a little or no chance of having a target gene function; m̅ represents an average of the expression level fold changes (m values) of all genes contained in all virtual gene clusters; σ(m) represents a standard deviation of the expression level fold changes (m values) of all genes contained in all virtual gene clusters; and w represents any real number as a weight.

(1) The weight w is set to larger than 1 for the gene presumed to have a target gene function and set to 0 or larger to smaller than 1 for the gene presumed to have a little or no chance of having a target gene function. The presumption to have a target gene function or to have little chance of having a target gene function can be made, for example, from homology to known genes or from motifs, in the same way as above.

(2) Alternatively, the gene searching apparatus of the present invention may store a program executing the following operation, instead of the weighting: virtual gene clusters each containing a gene selected on the basis of an annotation are picked out from among the constructed virtual gene clusters and only the picked-out virtual gene clusters are scored. Such a unit is effective for the gene presumed to have a target gene function and particularly effective for, for example, search for the functional genes involved in secondary metabolite production. As a result, the number of virtual gene clusters to be scored can be reduced, while the scoring time can be shortened. When, for example, the genes A and C in Table 1 are annotated, a total of mere eight virtual gene clusters each containing both the genes A and C are scored.

Alternatively, the virtual gene clusters selected by this approach may end in the same as the virtual gene clusters constructed from selected functional genes shown in the paragraph 5) Scoring of virtual gene cluster containing gene selected on the basis of annotation—2—described later. In this case, however, once an exhaustive group of virtual gene clusters is constructed by the approach A as described later, the function of a target gene or a gene cluster containing this gene can be changed freely. Thus, this approach is advantageous because function-selective gene analysis can be carried out variously and easily. In addition, this approach can deal flexibly with the large influence of functionally unknown genes because the scores of genes that are not annotated can be taken into consideration.

The apparatus according to the present invention involves: combining two or more genes on the genomic DNA to construct virtual gene clusters; individually scoring the virtual gene clusters by summing on a per-cluster basis the respective expression level fold changes of these two or more genes caused under the condition involving a change in the physiological state; and first searching for a target gene cluster on the basis of the obtained scores. A virtual gene cluster given a high score by scoring results from the coordination between or among two or more genes contained therein and accentuates its peculiarity in the overall score distribution, compared with the expression level fold change score of each gene alone. By contrast, in the conventional detection of a useful gene based only on the differential expression level of each individual gene, even a correct gene is absorbed into the overall score distribution. Accordingly, even a high-rank gene requires verifying whether or not this gene is of interest by gene disruption experiments or the like.

In addition, the expression level fold change of the gene weighted as described above is summed with the expression level fold changes of other genes in the scoring of the virtual gene clusters. Accordingly, a virtual gene cluster containing the gene presumed to have a target gene function receives a higher score, whereas a virtual gene cluster containing the gene predicted to have a little or no chance of having a target gene function receives a lower score. Such a higher or lower score distinctly diverges from the overall score distribution. As a result, a gene having the target gene function or a gene cluster containing this gene is more efficiently searched for.

### 5) Scoring of Virtual Gene Cluster Containing Gene Selected on the Basis of Annotation—2—

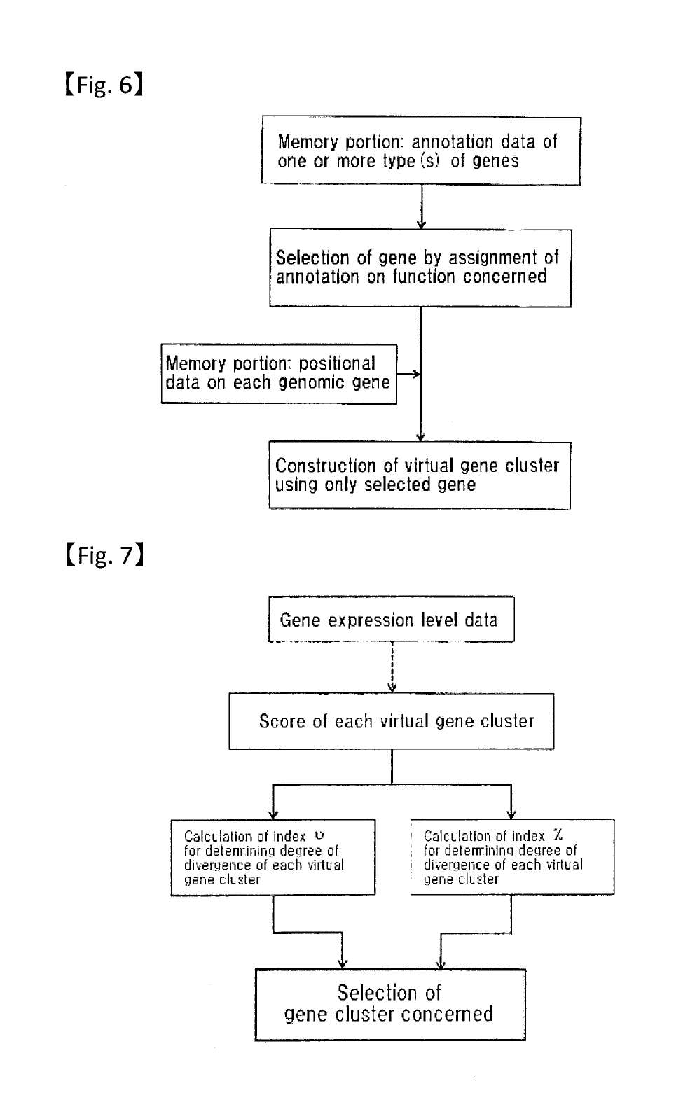

Alternatively, the gene searching apparatus of the present invention can be provided with a virtual gene cluster constructing means which constructs virtual gene clusters by extracting on an annotation basis genomic genes located in the vicinity in one or more group(s), preferably two or more groups, of the functional genes or by extracting genes on the genomic DNA so as to include these genes. As a result, the number of gene clusters to be scored can be decreased drastically, while the volume of data to be processed can be reduced. Accordingly, this approach is convenient and thus particularly suitable for searching for a gene cluster involved in secondary metabolite production and a secondary metabolite production-related gene in the cluster. A program executing such a process (FIG. 6) executes means for extracting genes in one or more group(s), preferably two or more groups, of the genes selected on the basis of an annotation according to the positional information set of the genomic genes stored in the memory portion, and constructing virtual gene clusters from these extracted genes, or means for extracting genomic genes including at least these selected genes to construct virtual gene clusters, on the condition that the genes in each gene cluster are positioned in the vicinity on the genomic DNA.

For example, in the case of constructing these virtual gene clusters from only the functional genes in combination, the genes to be combined reside within approximately 30 genes as the upper limit in terms of the number of genes arranged on the genome. The apparatus of the present invention is provided with means for inputting and setting the range of functional genes to be combined, while the program selects the functional genes to be combined on the basis of this range. The program selects the genes to be combined according to the type of an annotation assigned to the genes and position numbers in the positional information set of the genomic genes stored in the memory portion.

In the case of searching for a gene cluster involved in secondary metabolite production and a secondary metabolite production-related gene in the cluster, the annotation-based selection is directed to, for example, (1) genes of enzymes belonging to an enzyme class putatively involved in secondary metabolism, (2) transporter genes, and/or (3) transcription factor-encoding genes in the sequence of the genomic DNA.

In the case of, for example, 10 genes (designated as A to J) arranged on the genomic DNA as shown below,

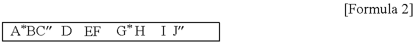

(* represents genes encoding the enzyme class concerned, and ″ represents transporter genes)
virtual gene clusters may comprise sets of AC and GJ, respectively. Alternatively, virtual gene clusters may comprise sets of ABC and GHIJ, respectively, including these genes or may comprise sets of a given number of genes, as in ABCDE or FGHIJ, respectively, by dividing the genome.

The (1) genes of enzymes belonging to an enzyme class putatively involved in secondary metabolism, (2) transporter genes, and (3) transcription factor-encoding genes in the genomic sequence can be determined, for example, from homology to genes of the same known enzyme class thereas or from motifs. For example, the presence or absence of these genes in the gene sequence of each virtual gene cluster can be determined on the basis of whether or not the gene cluster contains a nucleotide sequence encoding a common amino acid sequence for a motif specific for the amino acid sequence of each of the enzymes belonging to the enzyme class, the transporters, or the transcription factors. Different types of annotations are assigned to these different groups of genes, respectively. Such determination and annotation assignment can be performed using the approach described in the paragraph 4) Annotation assignment.

In the determination of the enzyme genes (1), the enzyme class involved in secondary metabolism is deduced by estimating secondary metabolite production reaction from the chemical structure of the secondary metabolite, its precursor, coenzyme that may be involved therein, chemical or physical properties, known enzyme reaction cases, production efficiency or rate, etc. This deduction of the enzyme class does not mean that even particular enzymes that could actually have been involved in the reaction must be deduced. Rather, only more reliable enzyme class involved in the reaction may be deduced. For example, a certain enzyme may be confirmed to belong to the oxygenase family, but its species (subordinate concept) cannot be identified. In such a case, enzyme classes are selected at an oxygenase level. The gene sequence of the genome is mined, and all genomic genes belonging to this category can be used as genes constituting the virtual gene clusters. However, if the enzyme class as a subordinate concept can be identified, a limited range of virtual gene clusters may be mined and search can accordingly be carried out more efficiently.

Alternatively, it may be assumed that a plurality of enzymes are involved in secondary metabolite production reaction. In such a case, a plurality of such enzyme classes may be selected.

In addition, each virtual gene cluster containing such functional genes in combination can be scored merely by using only the expression level fold changes of the selected functional genes in the calculation according to the calculation formula a). The scoring program described in the paragraph 3) Scoring of virtual gene cluster can be used merely by such setting. Specifically, in this case, the definitions in the calculation formula 1a) are as follows “wherein M represents the score of each virtual gene cluster; m represents the expression level fold change of each gene selected by annotation assignment, contained in each virtual gene cluster to be scored; m̅ represents an average of the expression level fold changes (m values) of all genes selected by annotation assignment, contained in all virtual gene clusters; and s(m) represents a standard deviation of the expression level fold changes (m values) of all genes selected by annotation assignment, contained in all virtual gene clusters”.

### 6) Display of Scoring Results

The gene searching apparatus of the present invention can be further provided with means for displaying the scores thus calculated by virtual gene cluster scoring or a processed form thereof on a screen and/or outputting the scores or the processed form thereof to a display medium such as paper. Examples of the displaying unit include the displaying of the virtual gene clusters in descending order according to the scores, and graphs indicating the distribution state of the scores of the virtual gene clusters. The gene searching apparatus of the present invention may be further provided with means for displaying the genes contained in the virtual gene clusters. The virtual gene clusters can be selected by these units.

Meanwhile, a virtual gene cluster having a high score diverging from the overall distribution is likely to be a virtual gene cluster identical or corresponding to the actually existing target gene cluster. A unit 7) or 8) shown below is a unit for selecting target gene cluster candidates or further narrowing down the candidates, by examining the degree of divergence from the overall distribution of scores of the virtual gene clusters. The apparatus of the present invention provided with the unit 7) or 8) can display the indexes I (χ) and II (υ) indicating the degree of divergence or the narrowing down results (b value), together with the selected virtual gene clusters and the genes contained therein. As a result, a target gene cluster and a target gene contained in the gene cluster can be identified.

7) Calculation of Degree of Divergence from Overall Score Distribution

It may be feasible to find a target gene cluster or a target gene therein from the displayed scoring results. To more enhance objectivity and efficiency, the apparatus of the present invention may be further provided with means for selecting, as target gene cluster candidates, virtual gene clusters each having a score diverging from the overall score distribution of the virtual gene clusters. Such procedures of assessing the degree of divergence from the overall score distribution of the virtual gene clusters in the apparatus of the present invention are shown in FIG. 7.

This candidate selecting means stores a divergence degree determining program which calculates an index indicating the degree of divergence from the overall score distribution of the virtual gene clusters. This divergence degree determining program includes two types, each of which executes means for calculating an index I (χ) or an index II (υ) according to, for example, calculation formula b) or c) shown below on the basis of the scores calculated by the process of scoring virtual gene clusters, and selecting, as target gene cluster candidates, virtual clusters exhibiting a value equal to or larger than a predetermined given index I (χ) or II (υ) (FIG. 7). The selection results are output together with the index while an average degree of divergence, etc., may be output at the same time. These two programs may be stored together in the apparatus of the present invention. Alternatively, only one of these programs may be stored therein.

### Calculation Formula b)

χ=−M log P [Expression 4]

wherein χ represents the index I indicating the degree of divergence of each virtual gene cluster; M represents the score of each virtual gene cluster; and P represents the frequency of appearance of each score M, wherein the cumulative total frequency of appearance of scores M is defined as 1 in the frequency distribution of the scores of all virtual gene clusters.

In the calculation formula b), the frequency of appearance of the score M is a value determined with the cumulative frequency of appearance (P) of scores defined as 1 in a population comprising all the virtual gene clusters and thus, does not exceed 1. Thus, log P does not take a positive value. Since log P is closer to −∞ with lower frequency of appearance, the absolute value of log P gets larger in a gene cluster having a lower frequent score. Thus, in the calculation formula b), log P is multiplied by the score of each virtual gene cluster and then multiplied by −1. Accordingly, a virtual gene cluster having a higher score with lower frequency has a larger index I (χ). On the other hand, a virtual gene cluster having a lower score with lower frequency has a smaller negative index I (χ).

According to the calculation formula b), a virtual gene cluster that exhibits a high absolute value of the index I (χ) exceeding 0 deviates from the frequency distribution of the scores of the virtual gene clusters. Such a virtual gene cluster that exhibits a high absolute value of the index I can be selected as a target gene cluster or a candidate corresponding to the target gene cluster.

### Calculation Formula c)

υ=(M− M̅)^{d′}/(ασ(M))^{d′} [Expression 5]

wherein υ represents the index II indicating the degree of divergence of each virtual gene cluster; M represents the score of each virtual gene cluster; M̅ represents an average of the scores (M values) of all virtual gene clusters; σ(M) represents a standard deviation of the scores (M values) of all virtual gene clusters; a represents any positive real number; and d′ represents the positive even number of dimensions.

This index II (υ) is determined by dividing a difference of the score of each virtual gene cluster from the average score of all virtual gene clusters by the standard deviation multiplied by a real number and raising the obtained value to the power of the number (d′) of dimensions and takes a large value for a virtual gene cluster having a score diverging from the normal distribution-like frequency distribution of scores. In the expression, d′ represents the positive even number of dimensions that can be set arbitrarily. A larger value of d′ more emphasizes a deviation from the average score. Since too large a d′ value emphasizes an outlier distant from the average score and relatively decreases the other scores, d′ is usually set to 2 or 4. In the case of more sensitively detecting an outlier, d′ is set to an even of 6 or larger. In the expression, a represents a coefficient indicating a distance. This value can be adjusted to thereby adjust to what extent an adopted score diverges from the normal distribution-like distribution. If a is set to a larger value exceeding 1, υ values other than an outlier distant from the average score are closer to zero. Thus, this a value is usually set to 1 to 2. On the other hand, if this a value is set to smaller than 1, a score less distant from the distribution can be picked out.

According to this calculation formula c) as well, a virtual gene cluster that exhibits a high index II (υ) exceeding 0, as in the index I, can be selected as a target gene cluster or a candidate corresponding to the target gene cluster.

### 8) Narrowing Down of Gene Cluster Candidates

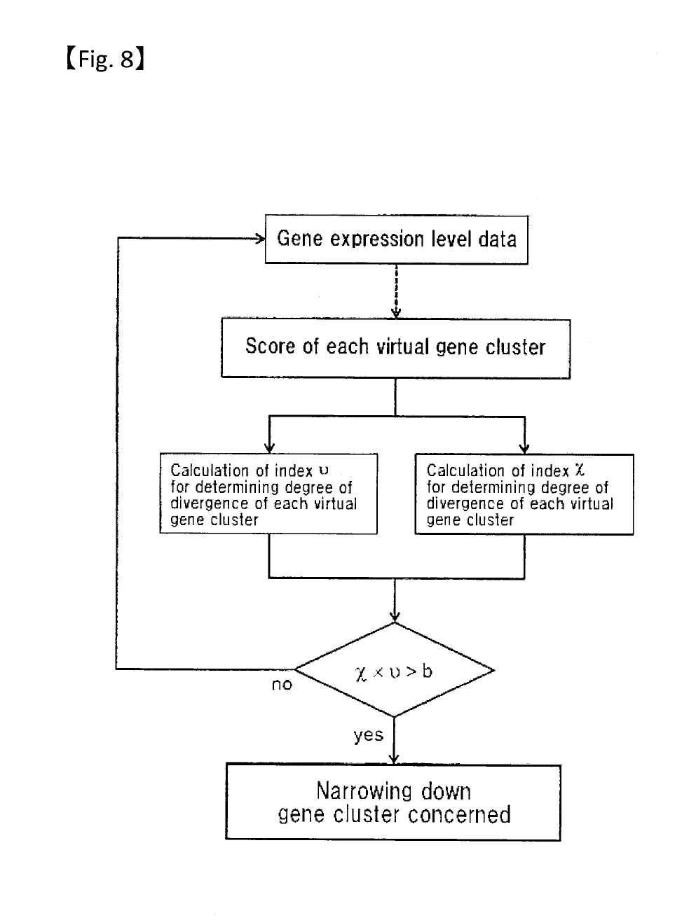

A large number of virtual gene clusters may be selected as target gene cluster candidates based on the index (χ or υ) calculated according to the calculation formula b) or c) and thus have to be further narrowed down. To cope with such a case, the apparatus of the present invention can store a candidate narrowing down program executing calculation according to calculation formula d) below as a gene cluster candidate narrowing down unit (FIG. 8). Specifically, at least virtual clusters wherein b is less than 100 as to the product of indexes I and II of each virtual gene cluster can be excluded to further narrow down the target gene cluster candidates.

### Calculation Formula d)

χ×υ>b [Expression 10]

wherein χ represents the index I of each virtual gene cluster calculated according to the calculation formula b) described in [Expression 4]; υ represents the index II of each virtual gene cluster calculated according to the calculation formula c) described in [Expression 5]; and b represents any positive real number as a threshold.

In the calculation formula d), b represents a threshold for determining to what extent the gene cluster candidates are narrowed down. A larger b value is more effective for narrowing down the candidates. A smaller b value permits the selection of more candidate gene clusters. The b value is set depending on the organism species under test or culture conditions. Specifically, a system in which candidate gene clusters are strongly expressed in large amounts requires setting b to a high value. On the other hand, a system in which only a small number of candidate gene clusters are expressed with weak intensity requires setting b to a low value; otherwise candidate genes cannot appear. In the former case, b is set to any numerical value that falls within the range of, for example, 5000 to 10000 or 10000 to 30000. In the latter case, b is usually set to any numerical value of 100 or larger, for example, any numerical value that falls within the range of 1000 to 2000 or 2000 to 5000.

9) In the Case where No Correct Solution is Obtained Using Apparatus of the Present Invention

If a gene cluster having a score diverging from the overall score distribution of the virtual gene clusters is not found as a result of performing the approach of the present invention, there is an issue with the setting of a search condition such as the established condition involving a change in the physiological state, the selection of genes to be weighted on the genomic DNA, or the selection of genes on the genomic DNA for constructing virtual gene clusters by the approach B). Thus, in such a case, the search condition is re-established, and the method for searching for a gene cluster can be performed repetitively until a gene cluster having a score deviating from the background distribution is found. Specifically, in the present invention, an issue with search condition setting can be grasped from the obtained data alone.

By contrast, in the case of the conventional methods as described above, even a correct gene inherently gets lost in the overall distribution of gene expression levels. Accordingly, from the obtained data, it is uncertain whether or not the solution is correct. As a consequence, a verification experiment that may be meaningless must be repeated.

### B) Gene Cluster Predicting Apparatus

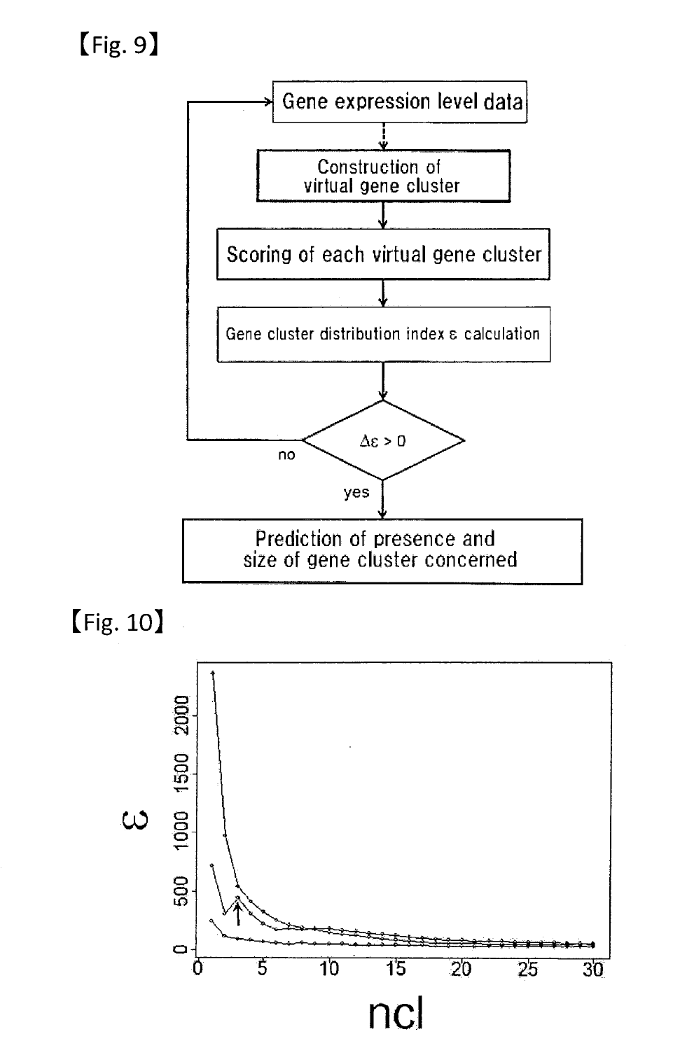

Another aspect using the virtual gene cluster constructing means and the virtual gene cluster scoring means according to the present invention can provide, for example, an apparatus for predicting the presence or absence of a target gene cluster and the size (the number of genes constructing the cluster; ncl) of the target gene cluster if present (hereinafter, this apparatus is referred to as a gene cluster predicting apparatus). This gene cluster predicting apparatus in the apparatus according to the present invention is summarized in FIG. 9.

This gene cluster predicting apparatus involves first individually scoring virtual gene clusters each comprising two or more genes arranged on the genomic DNA, by summing on a per-cluster basis the respective expression level fold changes of genomic genes caused between under a condition involving a change in the physiological state of organism cells and under a control condition. The units of inputting the expression level data set of genes arranged on the genomic DNA, calculating expression level fold changes, constructing virtual gene clusters, and scoring the virtual gene clusters are the same as the units described in the paragraphs 1) to 3).

Specifically, this apparatus comprises, as in the gene searching apparatus of the present invention: a) means for inputting the respective expression levels of genes arranged on the genomic DNA, the expression levels being obtained under a condition involving a change in the physiological state of organism cells and under a control condition; b) an expression level fold change calculating means of calculating the ratio between the input expression levels of each same gene under these two conditions; and c) means for individually scoring virtual gene cluster units each comprising two or more genes arranged on the genomic DNA, by summing the respective expression level fold changes of the genes, wherein: the apparatus further comprises means for constructing virtual gene clusters wherein the virtual gene clusters comprises, respectively, sets of genes extracted such that the number of genes is increased one by one from two consecutive genes on the genomic DNA until reaching the maximum possible number of genomic genes contained in a gene cluster and such that, with respect to each of the numbers of genes to be extracted, a starting point of the extraction is shifted one by one from a gene at one end of linear genomic DNA or from any gene in circular genomic DNA, in the order in which the genes are arranged on the genomic DNA; and a program executing calculation according to calculation formula a) below is stored as the scoring means. The apparatus bears these units in common with the gene searching apparatus of the present invention. A feature of this apparatus is d) means for calculating a gene cluster distribution index (ε) with respect to each of the numbers of genes contained in the gene clusters, from the output scores of the virtual gene clusters after the processes of the units 1 to 3). In this regard, a gene cluster distribution index (ε value) calculating program is stored as a program executing this unit d) (FIG. 9).

### Calculation Formula a)

$$M = Σ \frac{m - \overline{m}}{σ ( m )} \qquad [ Expression 1 ]$$

M=Σ^{m- m̅}/_{σ(m)}

wherein M represents the score of each virtual gene cluster; m represents the expression level fold change of each gene contained in each virtual gene cluster to be scored; m̅ represents an average of the expression level fold changes (m values) of all genes contained in all virtual gene clusters; and σ(m) represents a standard deviation of the expression level fold changes (m values) of all genes contained in all virtual gene clusters.

This gene cluster distribution index (ε) is determined according to the following calculation formula e):

### Calculation Formula e)

ε=Σ(M− M̅)^{d}/nσ(M)^{d} [Expression 7]

wherein ε represents a gene cluster score distribution index determined with respect to each of the numbers of genes; M represents the score of each virtual gene cluster contained in each group of the number of genes when all virtual gene clusters are grouped with respect to each of the numbers of genes; M̅ represents an average of the scores of all virtual gene clusters; n represents the total number of virtual gene clusters; a (M) represents a standard deviation of the scores (M values) of all virtual gene clusters; and d represents the positive even number of dimensions arbitrarily set.

According to this calculation formula e), if a virtual gene cluster is absent in the actual genomic DNA, the score (M) of this virtual gene cluster is influenced by the genes (contained in the virtual gene cluster) that neither participate in the target change in the physiological state nor vary in expression level, and therefore averaged (i.e., closer to the average score) with increase in size (the number of genes; ncl). In this case, the ε value monotonically decreases with increase in size (see the first and third top curves in FIG. 10). However, if a virtual gene cluster with a certain size is actually present, the bias ε increases in the distribution of this size. In this case, the ε value forms a singular point at this size without assuming the monotonically decreasing curve (see the point indicated by arrow in FIG. 10). Thus, the presence of the gene cluster and the size thereof can be predicted on the basis of whether or not the ε value forms a singular point and the size of the gene cluster at which the singular point is formed.

Specifically, when the ε value at a certain number (k) of genes (ε(k)) and the ε values at the number k of genes plus one and minus one (ε(k−1) and ε(k+1)) satisfy the following relationship in the grouping of the virtual gene clusters with respect to each of the numbers of genes contained in the clusters, the target gene cluster can be confirmed to be present in the genome and the number of genes contained in the target gene cluster can be estimated as k:

ε(k)>ε(k−1) and ε(k)>ε(k+1) [Expression 8]

The gene cluster predicting apparatus of the present invention may be constituted as an independent apparatus equipped with the units a) to d). Alternatively, since this apparatus bears the units a) to c) in common with the gene searching apparatus of the present invention, the gene searching apparatus of the present invention may be provided with further the unit of calculating a gene cluster distribution index (ε) with respect to each of the numbers of genes to thereby confer a function of predicting the presence or absence of a target gene cluster and the size of the gene cluster to the gene searching apparatus of the present invention. Such a prediction function is effective as a preliminary approach in constructing virtual gene clusters from plural types of selected functional genes in combination and scoring the virtual gene clusters using the gene searching apparatus of the present invention. Specifically, if the gene cluster is present and the size thereof can be predicted, only a genomic sequence containing the target genes of enzymes belonging to the enzyme class, (2) transporter genes, and/or (3) transcription factor-encoding genes within the predicted size may be searched as the virtual gene cluster.

Even if not only a causative gene of any change in the physiological state of cells under a certain condition but also a mechanism underlying this change is totally unknown, this apparatus for predicting a gene cluster can easily predict whether or not the change is caused by the linkage between or among genes in a gene cluster and also predict the gene size of the cluster containing the linked genes responsible for the change, as long as a control condition to be compared with the condition involving the change in the physiological state can be established. Specifically, this approach is exceedingly useful because the approach can reveal that, when the physiological change of an organism is attributed to the linkage between or among two or more genes that are exceedingly difficult to search for, the genes in a gene cluster coordinately cause this change, and because the approach can also predict the size thereof.

### EXAMPLES

### Reference Example 1

### Identification of Gene Essential for Kojic Acid Production

This Reference Example first shows an approach of searching for or identifying kojic acid production-related genes of Aspergillus oryzae by conventional methods, in order to elucidate the advantages of the gene search or identification according to the present invention.

An Aspergillus oryzae strain RIB40 (hereinafter, the simple term Aspergillus oryzae refers to this strain) is grown under conditions involving 30° C. and 150 rpm in a liquid medium with composition shown below to produce kojic acid into the medium. A 500-mL baffled Erlenmeyer flask is charged with 250 mL of the medium and inoculated with an Aspergillus oryzae spore suspension at a concentration of 10⁵-10⁷ spores/mL.

(Composition of medium; hereinafter, referred to as a kojic acid production medium)

10% (W/V) glucose

0.25% (W/V) yeast extract

0.1% (W/V) K₂HPO₄

0.05% (W/V) MgSO₄.7H₂O

The medium is pH-adjusted to 6.0 and then sterilized by autoclaving.

The kojic acid thus produced by the culture of Aspergillus oryzae can be detected by the development of red color resulting from the formation of a chelate compound between the kojic acid and ferric chloride. Alternatively, a high-concentration ferric chloride solution is added at a final concentration of approximately 10 mM to a sample containing the culture supernatant or the like diluted appropriately, and the absorbance of the resulting solution can be measured at a wavelength of 500 nm to quantitatively determine the amount of kojic acid. This absorbance at a wavelength of 500 nm is proportional to kojic acid concentration within the range of approximately 0.1 to 1.0.

According to such a detection method, the produced kojic acid can be detected on the 3rd or 4th day after inoculation. Kojic acid production is performed at a sufficient rate at least on the 7th day. Also, the kojic acid production is inhibited by the addition of 0.1% (W/V) or more sodium nitrate to the production medium. This inhibition by sodium nitrate is reversible. Hyphae after the inhibition by the addition of sodium nitrate are washed for removal of the medium components and then transferred to a newly prepared medium that satisfies a production condition. As a result, the strain restarts kojic acid production.

The comprehensive expression analysis of substantially all genes encoded in the genome was experimentally compared using DNA microarrays in three systems C1 to C3 placed under the following conditions differing in the kojic acid yield of Aspergillus oryzae:

C1. gene expression was compared between fungal cells grown for 4 days and for 2 days in the kojic acid production medium (day 4/day 2);
C2. gene expression was compared between fungal cells grown for 7 days and for 4 days in the kojic acid production medium (day 7/day 4); and
C3. fungal cells whose kojic acid production was inhibited by the addition of 0.3% (W/V) sodium nitrate to the kojic acid production medium were compared with fungal cells grown in the kojic acid production medium, wherein both the growth conditions involve 4 days, 30° C., and 150 rpm (NO₃⁻ absence/presence).

As a result of analyzing gene expression in the fungal cells in each of the systems using DNA microarrays, values corresponding to the ratio between expression levels and expression intensity of each gene were obtained in two fungal cells cultured under the compared conditions in each of the systems C1 to C3. Candidates were extracted by procedures shown below in order to extract genes more significantly expressed under the condition that made kojic acid production more noticeable between the compared conditions in each system.

The values corresponding to the ratio between expression levels and expression intensity exhibit their respective distributions close to normal distribution, but largely differ in absolute value. The values of the ratio between expression levels and expression intensity were separately normalized and then compared in order to extract candidates by the integration of both the values. The product of the respective normalized values corresponding to the ratio between expression levels and expression intensity was created. A gene with the higher product was considered more likely to be related to kojic acid production. Top five genes having the higher product were selected in each experiment (Table 2).

TABLE 2

| | | | Expression | Expression | | |
|---|---|---|---|---|---|---|
| | | | ratio | level | | |
| System | Rank | Gene ID | *1 | *2 | Product | Predicted function |
| C1 | 1 | AO090005000812 | 4.08 | 1.98 | 8.05 | 1,4-benzoquinone reductase- |
| | | | | | | like; Trp repressor binding |
| | | | | | | protein-like/protoplast |
| | | | | | | secreted protein |
| | 2 | AO090010000541 | 2.59 | 2.65 | 6.86 | Putative oxidoreductase |
| | | | | | | related to nitroreductase |
| | 3 | AO090003001096 | 2.86 | 2.00 | 5.73 | Putative carbonic anhydrase |
| | | | | | | involved in defense against |
| | | | | | | oxidative injury |
| | 4 | AO090001000310 | 5.28 | 1.07 | 5.66 | Phenylcoumaran benzylic |
| | | | | | | ether reductase [Populus |
| | | | | | | balsamifera subsp. |
| | | | | | | trichocarpa] |
| | 5 | AO090026000137 | 2.53 | 2.05 | 5.18 | Drosophila melanogaster |
| | | | | | | LD33051p [Plasmodium yoelii |
| | | | | | | yoelii] |
| C2 | 1 | AO090113000136 | 5.36 | 2.81 | 15.03 | Functionally unpredictable |
| | 2 | AO090113000138 | 5.63 | 1.34 | 7.54 | Synaptic vesicle |
| | | | | | | transporter SVOP and |
| | | | | | | related transporter |
| | 3 | AO090103000020 | 2.40 | 1.40 | 3.35 | Glucosamine-6-phosphate |
| | | | | | | isomerase |
| | 4 | AO090120000112 | 1.00 | 3.22 | 3.24 | Peroxiredoxin |
| | 5 | AO090003000895 | 1.22 | 2.57 | 3.13 | 60s ribosomal protein L15 |
| C3 | 1 | AO090011000010 | 2.49 | 1.50 | 3.74 | Functionally unknown |
| | | | | | | protein [Neurospora crassa] |
| | 2 | AO090010000227 | 3.78 | 0.54 | 2.05 | Unidentified conserved |
| | | | | | | protein |
| | 3 | AO090010000776 | 1.23 | 1.20 | 1.48 | Vacuolar sorting protein |
| | | | | | | VPS1 dynamin and related |
| | | | | | | protein |
| | 4 | AO090011000414 | 0.27 | 4.09 | 1.09 | Glyceraldehyde-3-phosphate |
| | | | | | | dehydrogenase |
| | 5 | AO090003000873 | 0.55 | 1.79 | 0.97 | NADH-cytochrome b-5 |
| | | | | | | reductase |

*1: Expression ratio is represented by a larger positive number for a gene more highly expressed under the condition that made kojic acid production more noticeable.
*2: Expression level is related to the sum of logarithmic values of signals under two compared conditions. A higher expression level is indicated by a larger positive number.

Genes having top scores which are product of expression ratio and expression level in DNA microarray of Aspergillus oryzae

The genes shown in Table 2 are genes more significantly expressed under the kojic acid production condition between under two compared conditions in each system. This means that these genes are likely to be essential for kojic acid production. These genes were subjected to a gene deletion-disruption experiment in descending order according to the ranks.

In this context, the three systems C1 to C3 are all intended to compare two conditions significantly differing in the yield of kojic acid. Thus, ideally, gene(s) essential for kojic acid production was presumed to appear at the top in all of the systems. In actuality, however, a gene that appeared at the top in all of these three systems was absent. Thus, the genes coming to the top places in any of the systems involve both the possibilities of being essential for kojic acid production and being specifically induced under each condition. In order to select gene(s) essential for kojic acid production from among these genes, any of candidate genes coming to the top places in each system was disrupted to create a variant, which was then analyzed for its ability to produce kojic acid.

As a result, the disruption of two genes AO090113000136 and AO090113000138 was confirmed to markedly reduce kojic acid production. These two genes had no orthologous relationship with functionally known genes located in the genomes of other organism species and therefore failed to be functionally identified from genomic information. However, amino acid sequences encoded by the genes sporadically contained known sequence motifs. Accordingly, their functions were roughly predictable. The gene AO090113000136 carries an FAD-dependent oxidoreductase motif. Taking it into consideration that the process of the conversion of glucose into kojic acid is presumably related to a plurality of oxidation-reduction reactions, it is strongly suggested that this gene encodes an enzyme that catalyzes kojic acid biosynthesis. By contrast, the gene AO090113000138 carries a sequence motif associated with membrane transport. The protein encoded by this gene is classified into the major facilitator superfamily. As is evident, kojic acid produced by kojic acid biosynthesis is secreted into the medium. Thus, it is suggested that this gene is essential for kojic acid production.

These two genes are positioned in the vicinity on the genome. Only one gene resides therebetween. An amino acid sequence encoded by this gene AO090113000137 was confirmed to carry a transcription factor motif. The disruption of this gene was also confirmed to markedly reduce kojic acid production.

As a result of these analyses, three genes, i.e., AO090113000136, AO090113000137, and AO090113000138, were identified as genes essential for kojic acid production. This identification process required a period of approximately one year except for study on culture conditions, etc.

The ranks of the thus-identified three genes essential for kojic acid production in terms of their expression level fold change m values in the results of DNA microarray analyses in the systems C1 to C3 are summarized in Table 3.

TABLE 3

| System | AO090113000136 | AO090113000137 | AO090113000138 | Minimum | Maximum |
|---|---|---|---|---|---|
| C1 | 0.96 | 0.45 | 0.92 | −9.23 | 6.59 |
| Among | 1427th | 2311th | 1489th | | |
| 6692 | | | | | |
| genes*¹ | | | | | |
| C2 | 8.16 | 3.24 | 6.97 | −10.84 | 8.16 |
| Among | 1st | 71st | 6th | | |
| 5595 | | | | | |
| genes*¹ | | | | | |
| C3 | 0.15 | 0.31 | −0.2 | −20.32 | 18.52 |
| 6488 | | | | | |
| Among | 3070th | 2658th | 3945th | | |
| 6488 | | | | | |
| genes*¹ | | | | | |

*¹of 14032 genes, the number of genes having signals (about half of the genes are rejected due to a lack of signals) are shown.

Score m values of three genes essential for Aspergillus oryzae kojic acid production and their ranks

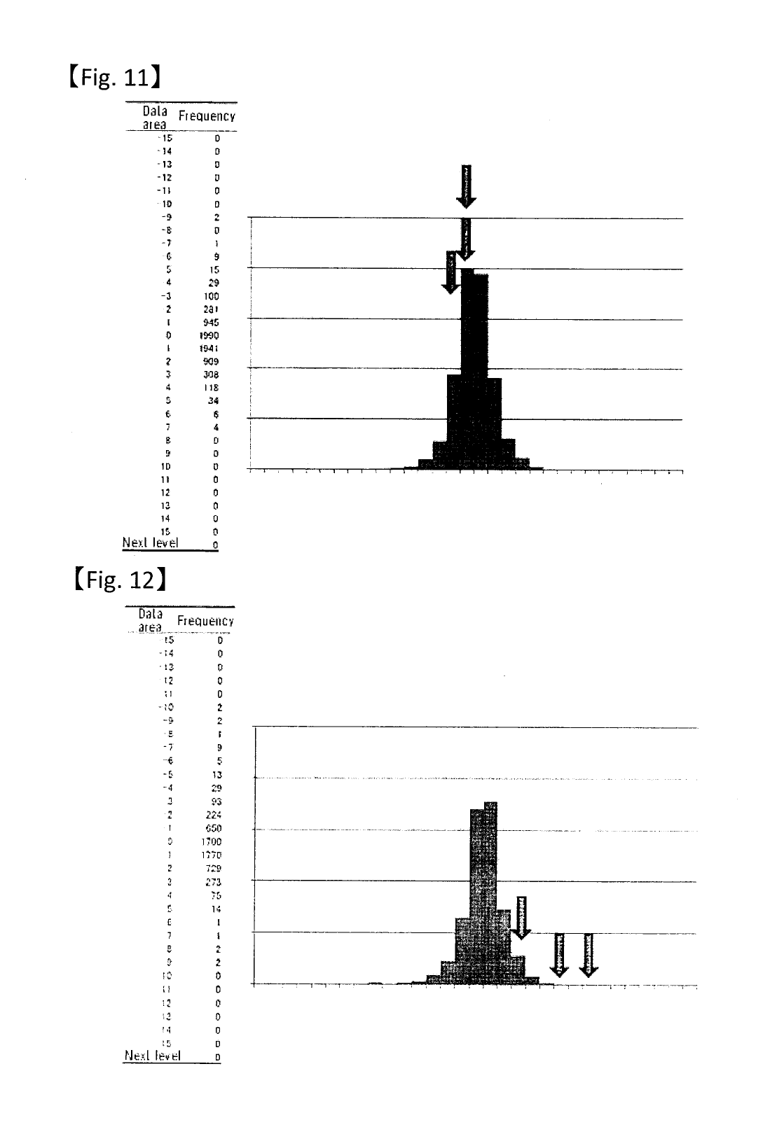

Also, distributions for the systems C1 to C3 are shown in FIGS. 11 to 13, respectively. As shown in Table 3, the three genes concerned were given high rankings (1st, 6th, and 71st places) in the system C2. Accordingly, the array of this system relatively easily identifies the essential genes. By contrast, in the system C3, the essential genes were not highly ranked (the 2658th place was the highest), though kojic acid production was significantly observed. It is practically impossible to identify the genes by conventional methods based on this array. In addition, it is difficult even to determine which array can give a correct solution under the circumstance where essential genes are unknown. The successful identification of these three genes essential for kojic acid production using only the three array data sets shown here was achieved by the method shown above, albeit mostly by blind luck, and is less generalized. Even in the case of prediction based on functional annotations, a gene concerned may not be identified unless 100 or more genes are disrupted. In this case, verification usually requires approximately 3 years or longer.

### Example 1

Identification of kojic acid biosynthetic gene in Aspergillus oryzae by gene cluster scoring

According to the approach of identifying the genes concerned according to the present patent filing, the apparatus of the present invention was used to identify a gene cluster consisting of the kojic acid production-related genes of Aspergillus oryzae.

The apparatus used in this experiment comprises a data input/output device, an input/output interface, a memory device, and a control operation device (CPU). The control operation device has an expression level fold change calculating portion, a virtual gene cluster constructing portion, a virtual gene cluster scoring portion, portions of calculating indexes for the degree of divergence of each virtual gene cluster, a gene cluster candidate narrowing down portion, and a gene cluster predicting portion. These portions store, respectively, an expression level fold change calculating program, a virtual gene cluster constructing program, a virtual gene cluster scoring program, programs of calculating indexes (χ) and (υ) for the degree of divergence, a candidate narrowing down program, and a gene cluster distribution index (ε) calculating program.

Calculation in each of these portions was performed using the free software R and the program language Perl on the Linux operating system.

The same DNA microarray data sets as in Reference Example 1 were used. Specifically, the data sets were obtained by a two-color assay method in the following systems C1 to C3 and determined with a culture condition for kojic acid production as a numerator and a control culture condition as a denominator:

C1. day 4/day 2,

C2. day 7/day 4, and

C3. NO₃⁻ absence/presence

mRNAs were isolated from fungal cells grown under the producing condition and under the non-producing condition in each of these systems, distinguishably labeled with dyes, and then hybridized to oligo DNAs on arrays to obtain data, from which the expression level fold change (m value) of each gene was then obtained.

Specifically, mRNAs were isolated from fungal cells grown under the producing condition and under the non-producing condition in each of the systems C1 to C3. The isolated mRNAs based on the producing condition and the non-producing condition were labeled with different fluorescence dyes, respectively, and then hybridized to oligo DNAs on arrays. Their detection wavelength intensity information set was input to the apparatus. The expression level fold change calculating program stored in the expression level fold change calculating portion was applied to the obtained data to obtain the expression level fold change (m value) of each gene.

This DNA microarray experiment employed a platform consisting of 14032 probes. This does not mean that all genes corresponding to these probes are expressed to give values. Thus, in this Example, the expression intensity information set used was obtained from 5179 genes which were confirmed to be universally expressed in these three systems.

### (A) Cluster Scoring

On the basis of the positional information set of genes on the genomic DNA of Aspergillus oryzae stored in the memory portion, virtual gene clusters with a gene size set to 1 to 30 were constructed by the application of the virtual gene cluster constructing program stored in the virtual gene cluster constructing portion. In this Example and subsequent Examples, the virtual gene clusters were constructed with their gene sizes set to 1 to 30 and the number of genes increased one by one from one gene to 30 genes, in order to verify the advantages of the searching method of the present invention over the conventional methods for searching for individual genes. The virtual gene clusters each comprising two or more genes in combination were scored, while scoring was also performed at the number of genes of 1.

The respective expression level fold changes of 5179 genes confirmed to be universally expressed in the systems C1 to C3 were checked against the genes contained in the virtual gene clusters thus constructed. The constructed virtual gene clusters were individually scored according to the calculation formula a) by the application of the scoring program in the virtual gene cluster scoring portion to obtain their scores (M values). Although genes that were neither confirmed to be universally expressed in the systems C1 to C3 nor had a detectable signal were counted as virtual gene cluster components, their values were not adopted in the calculation. Genes positioned at genomic terminus were not able to be combined as the predetermined numbers (1 to 30) of genes. In this case, scoring was performed using the maximum possible number of genes to be combined. This does not influence the essence of the prediction of the gene cluster.

The score (M value) of each virtual gene cluster was obtained according to the calculation formula a) by cluster scoring in each of the systems C1 to C3. The obtained score was stored in the memory portion as to each of the systems C1 to C3.

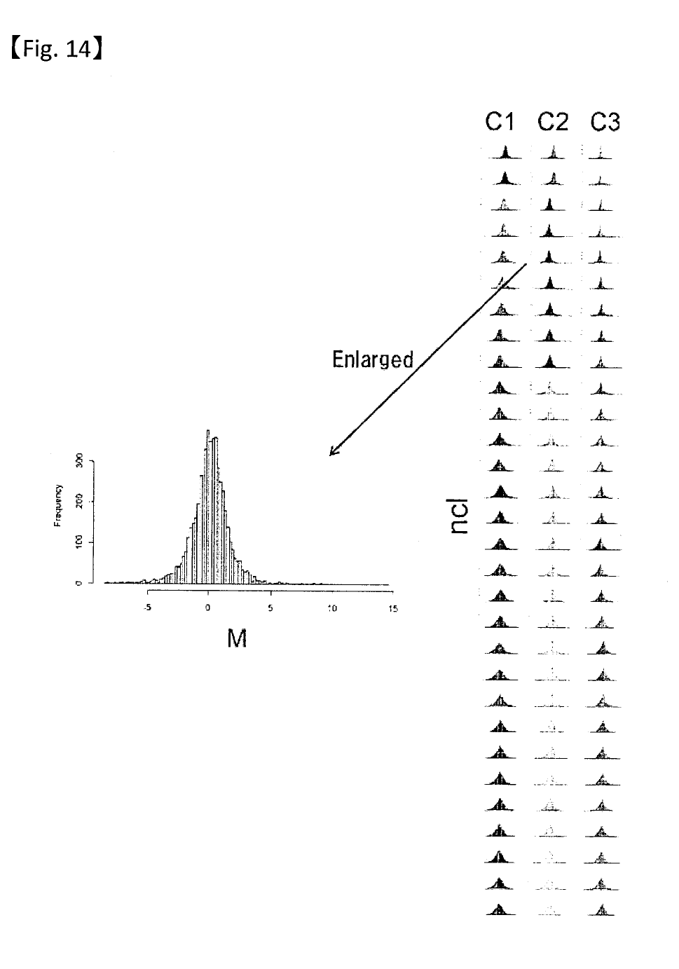

FIG. 14 shows the histogram thereof. As seen from the left enlarged view, the top of the overall distribution in the histogram is shifted to the left in the presence of a virtual gene cluster having a high M value distant from the zero-centered unimodal normal distribution-like population.

### (B) Data Assessment

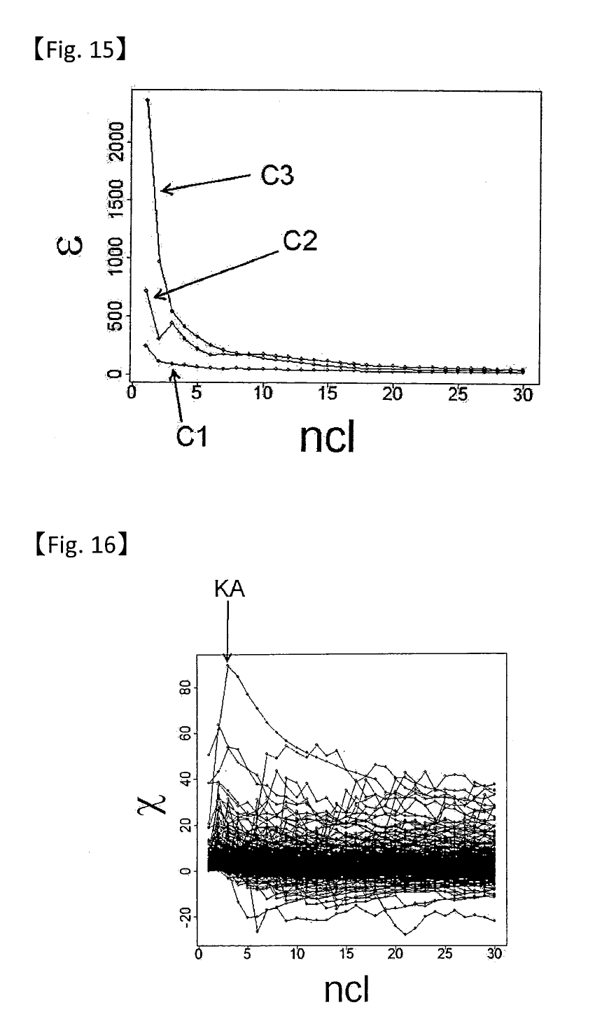

A gene cluster score distribution index ε for each of the systems C1 to C3 was calculated according to the calculation formula e) (FIG. 15).

Specifically, the score of each virtual gene cluster stored in the apparatus of the present invention was called up, and a gene cluster score distribution index ε for each of the systems C1 to C3 was calculated according to the calculation formula e) by the application of the gene cluster distribution index (ε) calculating program stored in the gene cluster predicting portion (FIG. 15). For the calculation, the total number n of virtual gene clusters applied to the calculation formula e) was set to 5179. A virtual gene cluster that did not contain any gene derived from the 5179 genes included in the expression level data set was excluded. Also, 6 was adopted as the number d of dimensions.

As shown in the drawing, basically, the ε value monotonically decreased in all of the systems C1 to C3, indicating the influence of averaging attributed to cluster scoring. However, in the system C2, the ε value exhibited a transient increase at ncl=3 and decreased again at next ncl=4. In other words, the ε value at this point was larger than the values at its adjacent two points. Thus, according to [Expression 6], the genome of the system C2 was presumed to contain the targeted gene cluster, and the number of genes contained in this gene cluster was estimated at 3.

In light of these results, the following verification and identification experiments were conducted using the DNA microarray data set of the system C2.

### (C) Gene Cluster Determination

On the basis of the score (M value) of each virtual gene cluster calculated according to the DNA microarray data of the system C2, the index χ of the gene cluster was calculated according to the calculation formula b) (FIG. 16).

Specifically, the χ value calculating program stored as a virtual gene divergence degree determining program in the portion of calculating the degree of divergence of each virtual gene cluster was applied to the score of each virtual gene cluster of the system C2 stored in the apparatus of the present invention to calculate the index χ for each virtual gene cluster according to the calculation formula b).

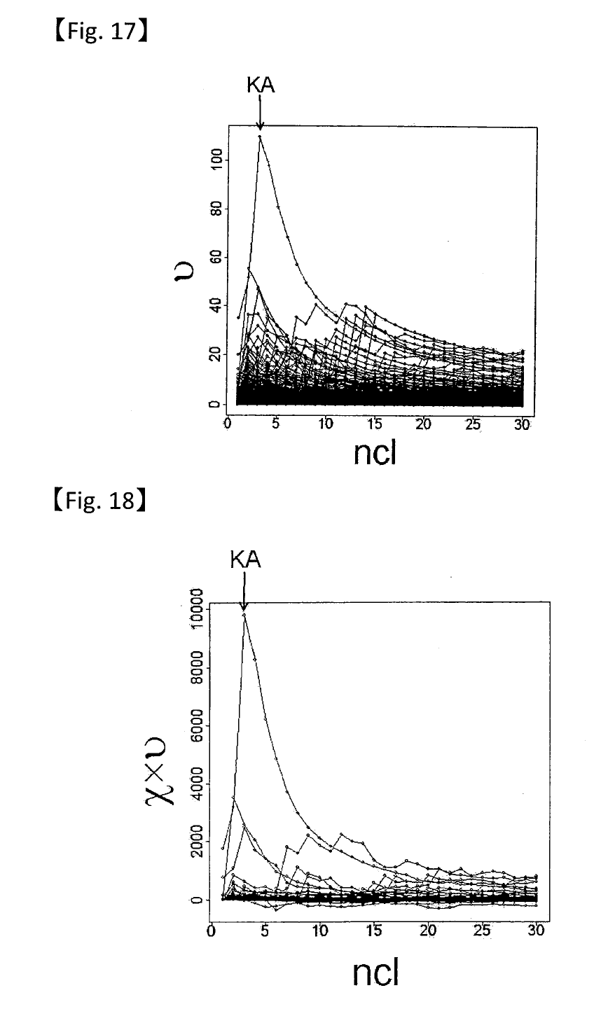

In FIG. 16, each polygonal line links the respective indexes of virtual gene clusters with gene sizes of 1 to 30 that shared the common gene designated as a starting point in the virtual gene cluster construction (the same holds true for FIGS. 17, 18, 21, 23, 30 to 32, and 35 to 37).

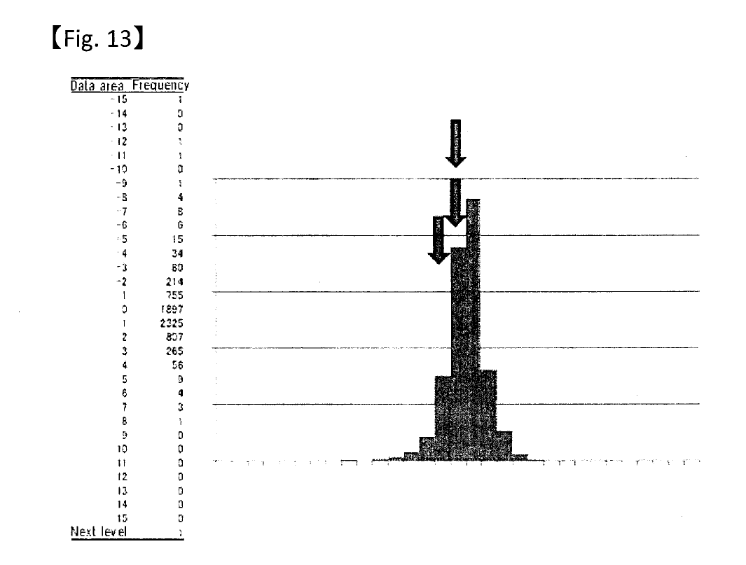

In this context, a virtual gene cluster having a value at ncl=1 larger than a value at ncl=2 is not applicable because its score is not attributed to cluster scoring in the present approach. In addition, a virtual gene cluster having a negative value at ncl=1 is not applicable because this cluster makes no contribution to an increase in the score in cluster scoring in the present approach. Thus, these virtual gene clusters were excluded from FIG. 13.

As is evident from FIG. 16, one virtual gene cluster took a local and global maximum at ncl=3. This virtual gene cluster consisted only of the three genes AO090113000136, AO090113000137, and AO090113000138 essential for kojic acid production.

This result is consistent with the result of Reference Example, demonstrating that the prediction results by the gene cluster distribution index (ε) calculation are correct. Also, the index χ was shown to allow identification of a targeted gene cluster and genes contained in the cluster.

Subsequently, another index for assessing each gene cluster, i.e., the υ value, was calculated for each virtual gene cluster according to the calculation formula c) using the same scores of the virtual gene clusters as above by the application of the υ value calculating program as a gene divergence degree determining program stored in the portion of calculating the degree of divergence of each virtual gene cluster (FIG. 17). Again, a virtual gene cluster having a value at ncl=1 larger than a value at ncl=2 was excluded, as in the χ value. In this context, 2 was adopted as the number d′ of dimensions, while 1 was adopted as a coefficient a. As shown in the drawing, one virtual gene cluster took a local and global maximum at ncl=3. This gene cluster consisted only of the three genes essential for kojic acid production, as in the χ value. Thus, the index υ was also shown to allow identification of a targeted gene cluster and genes contained in the cluster.

The candidate narrowing down program stored in the gene cluster narrowing down portion was applied to the χ and ε values thus obtained to calculate an estimate for assessing each gene cluster according to the calculation formula d) from the product of these two values (FIG. 18). As is evident from FIG. 18, one very distinctive virtual gene cluster took a global maximum of 5000 or larger and had a local maximum at ncl=3. This cluster consisted only of the three genes AO090113000136, AO090113000137, and AO090113000138 essential for kojic acid production. In this way, use of the approach and apparatus of the present invention was able to identify the targeted biosynthetic genes. If the threshold b in the calculation formula d) is defined as, for example, 2000, only four gene clusters were applicable. At this numerical value, verification can be performed easily using the experimental system. The multiplication of the χ value (FIG. 16) and the υ value (FIG. 17) cancels many peaks present in each graph and gives only applicable gene clusters to be mined a high value.

These results demonstrated that the approach and apparatus of the present invention are capable of effectively searching for and identifying the biosynthetic genes that function as an assembly on the genome, using DNA microarray data alone.

### Example 2

### Search for Kojic Acid Biosynthetic Gene in Aspergillus oryzae by Virtual Gene Cluster Scoring after Annotation (Functional Annotation)-Based Weighting

For the purpose of identifying a gene cluster consisting of the kojic acid production-related genes of Aspergillus oryzae, the m values of genes annotated in relation to putative functions were weighted, and the genes concerned were then identified.

The apparatus used in this experiment is basically the same as the apparatus described above in Example 1, but differs therefrom in that the apparatus of Example 2 has a portion of selecting genes on the basis of an annotation and a portion of assigning a weight to the expression level fold changes of the selected genes.

The following three functions were picked out as functions necessary for kojic acid production:

membrane transporter: transporter or major facilitator,

transcriptional regulator: transcription, and

oxidoreductase: oxidoreductase or dehydrogenase.

In this context, the English words described on the right are keywords used in annotation-based gene selection.

These functions were picked out on the grounds that: kojic acid is presumably biosynthesized by conversion from glucose through oxidation; the membrane transport-mediated secretion of produced kojic acid into a medium presumably requires a membrane transporter; and a transcription factor is presumably necessary for the transcriptional regulation of the genes involved in the biosynthesis.

### (A) Annotation (Functional Annotation)-Based Weighting and Cluster Scoring

Annotations were assigned to genes on the genomic DNA of Aspergillus oryzae using Interproscan (http://www.ebi.ac.uk/Tools/InterProScan/), a generally available annotation prediction software system. Genes corresponding to the three functions described above were selected on the basis of the assigned annotations. Specifically, the annotation data set of the genes was input to the input device of the present apparatus and stored in the memory device. Each data in the stored annotation data set was called up, and genes having the three types of functions, respectively, were selected by the application of the selecting program in the functional gene selecting portion. This selection was carried out on the basis of whether or not the annotation assigned to each gene contains any of the English words corresponding to the three functional groups. As a result, 709 out of the 5179 genes were selected

Subsequently, the respective expression level fold changes (m values) of these genes with the annotations concerned were normalized as to each of three array assay systems C1 to C3 described in Example 1 and then summed with weight w=2.0, followed by cluster scoring at ncl=1 to 30 according to the calculation formula a) to obtain the M value of each virtual gene cluster.

Specifically, the expression level fold changes of the genes thus selected were weighted by the weight assigning portion (see [Expression 2]). These weighted expression level fold changes were used to calculate the score of each virtual gene cluster. The virtual gene cluster constructing and scoring programs themselves were executed in the same way as in Example 1 except that the expression level fold changes of the genes selected on the basis of the annotations were weighted. In this experiment, the expression level fold changes (m values) of the genes selected on the basis of the annotations were normalized and then summed with weight w=2.0. Then, cluster scoring was performed at ncl=1 to 30 according to the calculation formula a) by the application of the scoring program stored in the virtual gene cluster scoring portion to obtain the score (M value) of each virtual gene cluster. This calculated score of each virtual gene cluster was stored in the memory device of the apparatus of the present invention.

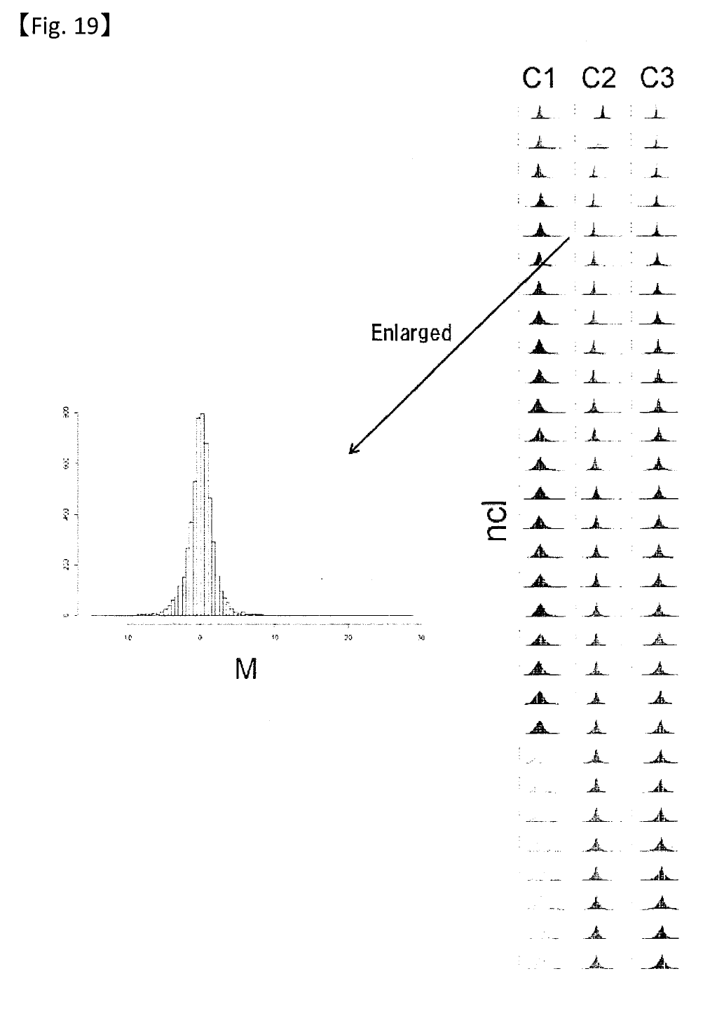

FIG. 19 shows the histogram of the virtual gene cluster scores thus calculated. As is evident from the left enlarged view compared with FIG. 14, a zero-centered unimodal distribution was relatively sharper and the top of the distribution was further shifted to the left, due to the emergence of a higher score as a result of weighting.

### (B) Data Assessment

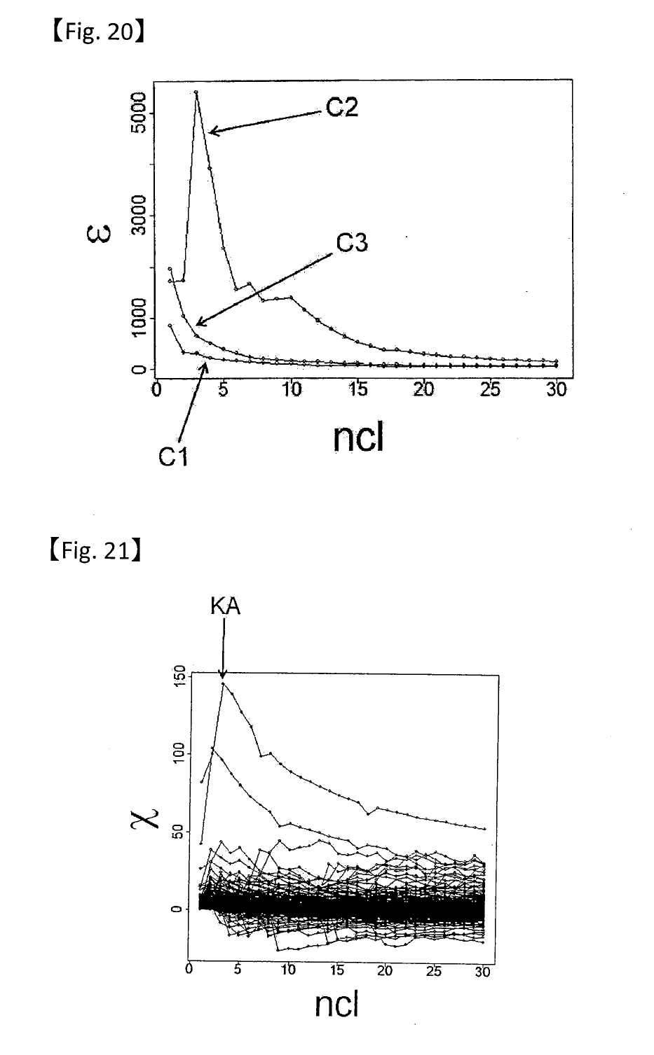

Subsequently, a score distribution index ε was calculated according to the calculation formula e) as to each of the systems C1 to C3 (FIG. 20). Specifically, the score of each virtual gene cluster calculated and stored in the step (A) was called up, and the ε value was calculated by the application of the gene cluster distribution index (ε) calculating program stored in the gene cluster predicting portion. In this context, as in Example 1, 5179 was adopted as the number n of virtual gene clusters, while 6 was adopted as the number d of dimensions. As shown in FIG. 20, basically, the ε value monotonically decreases in the systems C1 and C3, whereas the ε value largely increases at ncl=3 in the system C2 and exhibits a local maximum. This value was 10 or more times that in Example 1 (FIG. 15). These results show that functional annotation-based weighting allows highly accurate prediction of the presence of the gene cluster concerned and the number of genes therein in a manner limited by functions.

This experiment strongly suggested that the microarray data set of the system C2 contained data presumed to result from the targeted gene cluster. Thus, the following verification and identification experiments were conducted using the DNA microarray data set of C2.

### (C) Gene Cluster Determination

The index χ of each gene cluster was calculated according to the calculation formula b) from the score (M value) of each virtual gene cluster after annotation-based weighting in the system C2 obtained in the step (A) (FIG. 21).

Specifically, the stored score of each virtual gene cluster in the system C2 was called up, and the index χ of each virtual gene cluster was calculated according to the calculation formula b) by the application of the χ value calculating program stored as a virtual gene divergence degree determining program in the portion of calculating the degree of divergence of each virtual gene cluster. As in FIG. 16 of Example 1, a virtual gene cluster having a value at ncl=1 larger than a value at ncl=2 and a virtual gene cluster having a negative value at ncl=1 were excluded from FIG. 21.

As seen from the results of FIG. 21, one virtual gene cluster exhibited a local and global maximum at ncl=3, as in Example 1. This cluster consisted only of the three genes AO090113000136, AO090113000137, and AO090113000138 essential for kojic acid production, as in Example 1 (FIG. 16). Here, as a result of weighting, the top χ value was about 2 times higher than that in FIG. 16 and more greatly differed from the other values. This means that annotation-based weighting improves the detection accuracy of the gene cluster concerned appropriate for the functions.

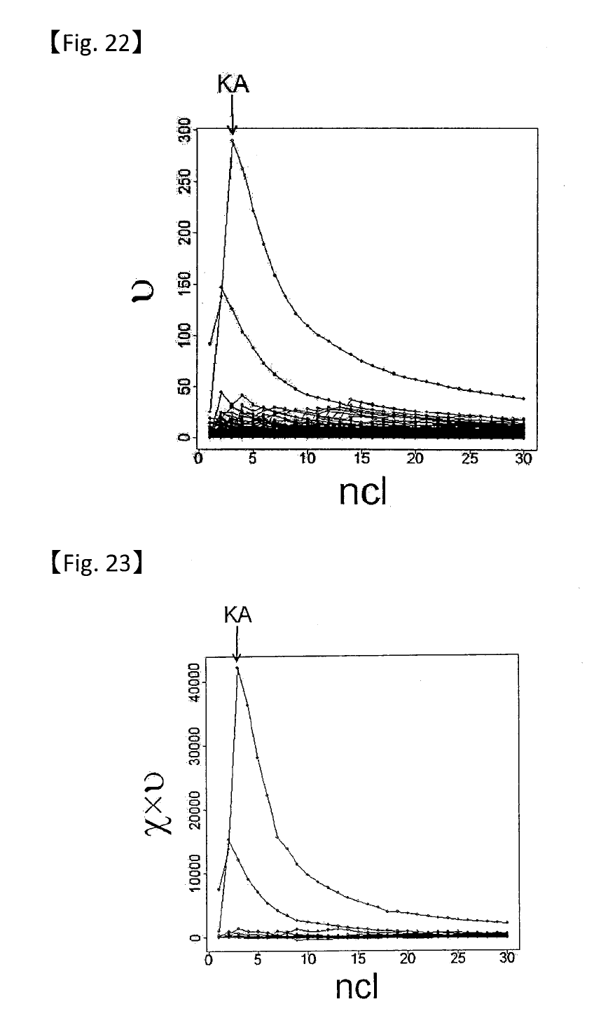

Subsequently, the index υ of each virtual gene cluster was calculated according to the calculation formula c). Specifically, the index υ of each virtual gene cluster was calculated according to the calculation formula c) by the application of the υ value calculating program stored in the portion of calculating the degree of divergence of each virtual gene cluster. As in Example 1, 2 and 1 were adopted as the number d′ of dimensions and a coefficient a, respectively. The results are shown in FIG. 22. As in FIG. 17 of Example 1, a virtual gene cluster having a value at ncl=1 larger than a value at ncl=2 was excluded from FIG. 22. The results are shown in FIG. 22.

As in Example 1, one virtual gene cluster took a local and global maximum at ncl=3. This gene cluster consisted only of the three genes essential for kojic acid production. In addition, one gene cluster having a small peak at ncl=2 was observed. This cluster consisted of two (AO090113000137 and AO090113000138) out of the three kojic acid production-related genes. As is evident from FIG. 22 compared with FIG. 17, the weighting of the expression level fold change of each gene having the function selected by annotation assignment inflates the score of the targeted gene cluster and highlights this score in bold relief. As a result, the target gene cluster can be detected with higher accuracy.

Subsequently, an estimate for assessing each gene cluster was calculated from the product of the χ and υ values according to the calculation formula d) (FIG. 23). Specifically, for the calculation, the candidate narrowing down program stored in the gene cluster narrowing down portion was applied to the χ and υ values thus obtained to calculate the estimate for assessing each gene cluster. As is evident from FIG. 23, two virtual gene clusters took an outstandingly high value beyond 10000. By contrast, the other cluster merely exhibited a relatively very small peak. Of these two clusters, the virtual gene cluster having a local and global maximum at ncl=3 consisted only of the three genes AO090113000136, AO090113000137, and AO090113000138 essential for kojic acid production, as in Example 1. Another distinctive gene cluster having a local maximum at ncl=2 consisted of two (AO090113000137 and AO090113000138) out of the three genes essential for kojic acid production. The values of the other virtual gene clusters can be regarded relatively as substantially zero. As is evident from this result, the weighting of the expression level fold change of each gene selected on the basis of an annotation more significantly increases the score of a virtual gene cluster corresponding to the targeted gene cluster, compared with a lack of weighting (FIG. 18).

These results demonstrated that the weighting of the expression level fold change of each gene selected on the basis of the annotation concerned allows more highly accurate detection or identification of the gene cluster concerned appropriate for the functions.

### Example 3

### Search for Kojic Acid Biosynthetic Gene by Scoring of Virtual Gene Cluster Constructed from Genomic Gene Having Particular Function in Aspergillus oryzae

In this Example, an experiment was conducted to verify that the genes essential for kojic acid production were successfully searched for by constructing virtual gene clusters from genes having particular functions, respectively, in the genomic genes of Aspergillus oryzae, and analyzing the scores of the virtual gene clusters.

In this Example, 14032 virtual gene clusters were prepared with their sizes (ncl) set to 5 from the genomic sequence of Aspergillus oryzae. As in Example 1, virtual gene clusters each containing a missing gene or a gene positioned at genomic terminus were constructed as those of size smaller than ncl.

This experiment employed the apparatus of Example 2 except that three array data sets of the experimental systems C1 to C3 in Example 2 were combined and integrated into one expression level fold change (m value) data set. Also, the system of the apparatus was changed so that the following operation, instead of weighting, was performed: on the condition that each virtual gene cluster contained plural types of functional genes selected on the basis of annotations, virtual gene clusters were picked out from among the virtual gene clusters constructed with a size (the number of genes) set to 5 and only the picked-out virtual gene clusters were scored. The other procedures were performed in the same way as in Example 2.

Specifically, 14032 virtual gene clusters were prepared with their sizes (ncl) set to 5 on the basis of genomic positional information on Aspergillus oryzae stored in the memory device, on the condition that the genes contained in each gene cluster were positioned in the vicinity on the genome. In this case, as in Example 1, virtual gene clusters each containing a missing gene or a gene positioned at genomic terminus were constructed as those of size smaller than ncl.

Of these virtual gene clusters, those containing genes having particular functions, respectively, were picked out in the same way as in Example 2 by sequence homology to motifs appropriate for the functions. Specifically, the particular functions are the following three:

membrane transporter: transporter or major facilitator,

transcriptional regulator: transcription, and

oxidoreductase: oxidoreductase or dehydrogenase.

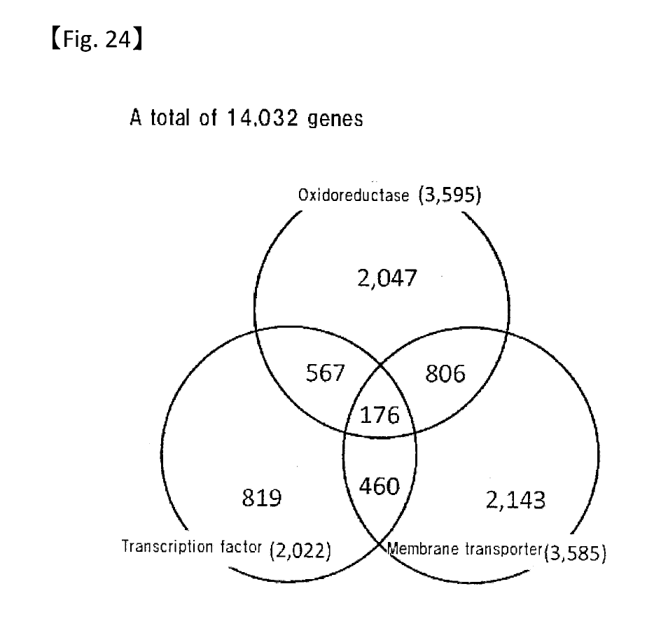

Subsequently, virtual gene clusters each containing genes with the functional annotations concerned were picked out from among a total of 14032 virtual gene clusters. A Venn diagram indicating the numbers of picked-out clusters is shown in FIG. 24. 176 out of the 14032 virtual gene clusters had all of the genes of the three factors (membrane transporter, transcriptional regulator, and oxidoreductase). Also, 636 virtual gene clusters had two components (membrane transporter and transcriptional regulator genes) except for the oxidoreductase gene.

Specifically, these procedures were performed in the same way as in Example 2 by: selecting genes having, respectively, three functions described above from among the genes included in the annotation data set stored in the memory device by the application of the selecting program in the functional gene selecting portion; and picking out those containing the selected functional genes from among a total of 14032 constructed virtual gene clusters.

Subsequently, the picked-out virtual gene clusters were individually scored.

The array data sets were the same as those described in Reference Example 1 and Examples 1 and 2 and obtained by a two-color assay method in the systems C1 to C3. mRNAs were isolated from fungal cells grown under the producing condition and under the non-producing condition in each of these systems, distinguishably labeled with dyes, and then hybridized to oligo DNAs on an array to obtain data, from which the expression level fold change (m) of each gene was then obtained.

In order to obtain one score per virtual gene cluster, the m values of each gene obtained from the three systems C1 to C3 were unified by summation. Subsequently, of the picked-out virtual gene clusters each containing the genes with the functional annotations concerned, 176 clusters, which contained all of the three genes (membrane transporter, transcriptional regulator, and oxidoreductase genes), were subjected to score (M value) calculation according to the calculation formula a).

Specifically, the expression level fold change (based on the experiments in the systems C1 to C3) of each functional gene contained in each of the virtual gene clusters picked out according to the procedures was called up from the memory portion, and virtual gene cluster scoring was performed according to the calculation formula a) by the application of the scoring program in the virtual gene cluster scoring potion.

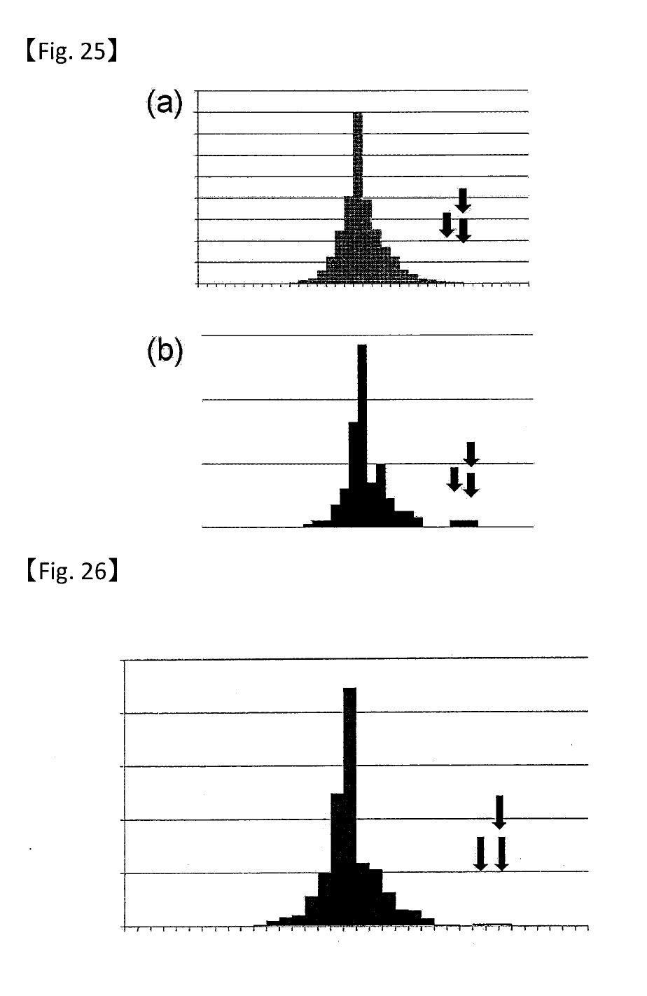

FIG. 25(a) shows the distribution of score M values of a total of 14032 virtual gene clusters. Also, FIG. 25(b) shows the distribution of scores of 176 virtual gene clusters having all of the genes encoding the three putative kojic acid production-related factors (membrane transporter, transcriptional regulator, and oxidoreductase). Both the diagrams show the positions of scores of virtual gene clusters each containing the three genes essential for production. Since the size of each virtual gene cluster was set to five consecutive genes in this Example, there exist three clusters (AO090113000134-AO090113000138, AO090113000135-AO090113000139, and AO090113000136-AO090113000140) each containing the three essential genes (AO090113000136-AO090113000138). Accordingly, their positions were indicated by three arrows.

These clusters were ranked Nos. 24, 58, and 59 among a total of 14032 virtual gene clusters. The analysis of individual genes gave these clusters the 3000th or lower ranks, indicating that the accuracy rate can be improved sufficiently by the present approach. However, the further application of the process of selecting virtual gene clusters on the basis of the functions of the genes contained therein was shown to place the ranks of the cluster scores at the 2nd, 5th, and 6th positions, which were evidently high in rank.

In this context, the shape of the distribution must be noted. The score distribution of a total of 14032 virtual gene clusters is close to a unimodal distribution as a whole. Due to the large total number and a wide base (FIG. 25(a)), some clusters are given higher scores than that of the virtual gene cluster essential for kojic acid production. In this regard, genes presumably associated with a hypothesized kojic acid biosynthesis pathway were identified from motifs, and virtual gene clusters deeply involved in kojic acid production were selected and analyzed. As a result, the pattern of the distribution was changed (FIG. 25(b)). Such reduction in the total number rendered the shape of the unimodal background virtual gene cluster distribution smaller, albeit analogous, resulting in a narrower base and the absence of clusters given a high score by chance. By contrast, virtual gene clusters highly related to kojic acid production are positioned independently of background. Eventually, another distribution (different from the unimodal background distribution) in which the peak of the histogram was centered is located on the high-score side. Thus, from not only high scores but also the presence of virtual gene clusters having a high score distant from the background distribution, it can be predicted that this analysis contains a correct solution.

### Example 4

### Study on Condition for Picking Out Gene Cluster Essential for Aspergillus oryzae Kojic Acid Production by Virtual Gene Cluster Scoring

Methodology was studied by analyzing whether or not the results obtained in Example 3 were changed under varying conditions for picking out virtual gene clusters on the basis of functional annotations.

In Example 3, the gene clusters to be mined were limited to virtual gene clusters each containing the genes of three putative kojic acid production-related factors (membrane transporter, transcriptional regulator, and oxidoreductase) to confirm that virtual gene clusters each containing the three genes essential for production were highly ranked. In this Example, the influence of decrease of these three factors to two was studied. The functional annotation-based selection of virtual gene clusters and cluster scoring were carried out by the same procedures as in Example 3.

This experiment employed the apparatus of Example 3 and was conducted by changing only the functional gene selection command to the functional gene selecting portion.

As shown in FIG. 26, the overall score distribution of 636 virtual gene clusters each containing the genes corresponding to two annotations (membrane transporter and transcriptional regulator) revealed that, as in Example 3, the score M values of gene clusters each containing the three genes essential for kojic acid production were ranked Nos. 2, 5, and 6, which were high in rank. As for the shape of the score distribution, the related gene clusters are located on the high-score side as a distribution different from the unimodal distribution likely to be background. In this regard, the same results as in Example 3 were also obtained. More conditions for functional annotation-based selection are more likely to contribute to reduction in background and give the gene clusters concerned high rankings. Nevertheless, the present method was confirmed to sufficiently function even under two annotation-based constraints rather than three.

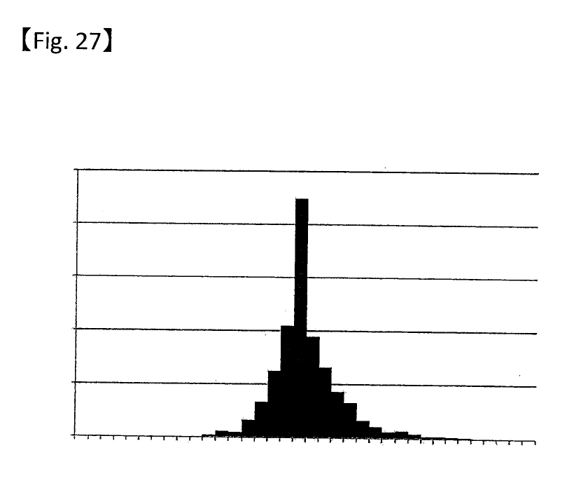

FIG. 27 shows the score distribution of 2949 virtual gene clusters each containing a membrane transporter gene but no transcriptional regulator gene. The transcriptional regulator gene was the middle gene in the sequence of the three genes essential for kojic acid production. In the case of this experiment, virtual gene clusters were picked out on the condition of 5 consecutive genes. Accordingly, on the condition that the transcriptional regulator gene is excluded, a virtual gene cluster containing the three genes essential for kojic acid production is not constructed. Thus, the score distribution of the virtual gene clusters shown here corresponds to a distribution consisting only of background. In this context, the increased total number of scores is distributed with a wide base spanning high scores, whereas a unimodal distribution in which the peak of the histogram is centered is observed. This distribution was free from virtual gene clusters located as another distribution on the high-score side, indicating that no correct solution was contained therein.

### Example 5

### Identification of Biosynthetic Gene in Aspergillus flavus by Virtual Gene Cluster Scoring

In order to demonstrate that the method for searching for or identifying a gene according to the present invention is also adaptable to gene clusters other than the gene cluster essential for Aspergillus oryzae kojic acid production, a target secondary metabolite biosynthetic gene cluster was identified with Aspergillus flavus as a subject. Aspergillus flavus is known to strongly produce a secondary metabolite aflatoxin, which is a mycotoxin. The optimum temperature for its production is around 25° C. The same apparatus as in Example 1 was used in this experiment.

A portion of DNA microarray data registered under ID GSE15435 in the public gene expression analysis database NCBI GEO (http://www.ncbi.nlm.nih.gov/geo/) was used (Reference 1). Specifically, this data was stored in the memory portion through the gene expression level input portion. Unlike Examples 1 to 4, this array data was obtained by a one-color assay method. Thus, in order to obtain the expression level fold change m value of each genomic gene, a secondary metabolite production inducing condition and a non-inducing condition were compared as shown below. The m value was calculated with the expression level under the former condition as a numerator and the expression level under the latter condition as a denominator. A total of two systems were studied.

C1: 96 hours into culture/18 hours into culture
C2: growth temperature of 28° C. during culture/growth temperature of 37° C. during culture

Hereinafter, these two systems are referred to as systems C1 and C2, respectively. These two systems each contain 12955 genes.

### (A) Cluster Scoring

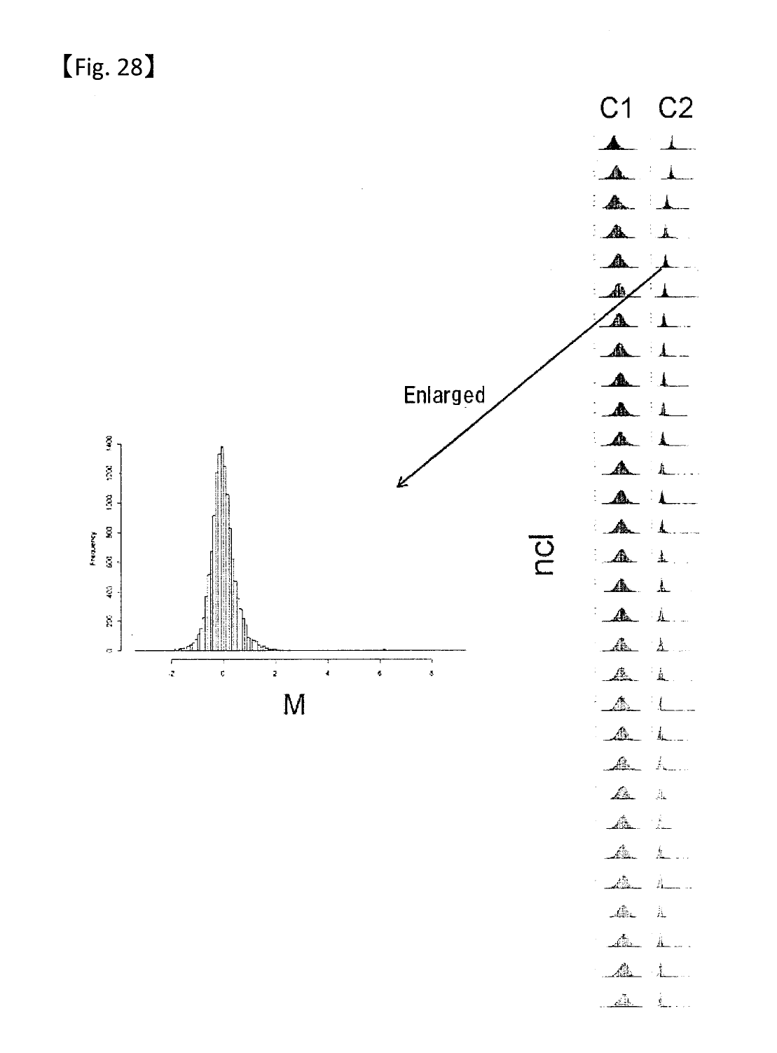

As in Example 1, virtual gene clusters with sizes of ncl=1 to 30 were individually scored according to the calculation formula a) as to each of the systems C1 and C2 to obtain their respective scores (M values). The right view of FIG. 28 is a histogram showing the distribution state of scores of the virtual gene clusters on a size basis. The left graph of FIG. 28 is an enlarged view of one of the histograms. As is evident from this graph, the top of the overall distribution in the histogram is shifted to the left in the presence of a virtual gene cluster having a high score (M value) distant from the zero-centered unimodal normal distribution-like population. It is very obvious that the top of the distribution is shifted to the left with increase in ncl in the system C2.

### (B) Data Assessment

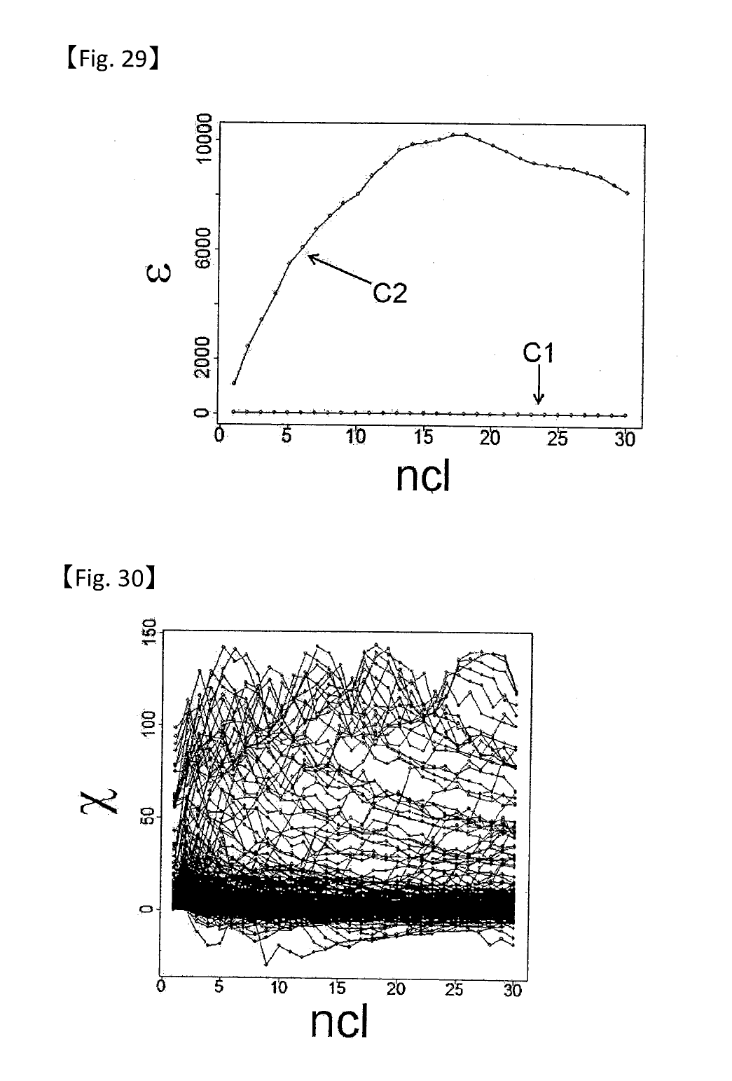

As in Example 1, a score distribution index ε was calculated according to the calculation formula e) as to each of the systems C1 and C2 (FIG. 29). In this context, the number n of virtual gene clusters was set to 12955 at each cluster size, while 6 was adopted as the number d of dimensions. As in Examples 1 and 2, virtual gene clusters that were not applicable were excluded according to values at ncl=1. As shown in FIG. 29, the ε value was substantially zero in the system C1, whereas the system C2 exhibited a local and global maximum at ncl=18. This reflects the fact that since the optimum temperature for aflatoxin production is 25° C., the condition involving a change in the physiological state in the system C2 as to temperature was properly established whereas the setting of the condition involving such a change in the system C1 was not proper.

By this cluster scoring using the expression level fold change data based on the system C2, it was successfully predicted that the target gene cluster that increased the ε value was present and its cluster size was around 20. The aflatoxin is a secondary metabolite most strongly produced by Aspergillus flavus. Its biosynthetic genes are known to form a gene cluster consisting of 29 genes (AFLA_{—}139100-AFLA_{—}139440) (Reference 2). This does not mean that all of these genes are expressed at the same time. Their expression intensities vary depending on an environment, etc. The presence of a peak at the position of a cluster size as large as ncl=approximately 20 obtained as a result of this experiment probably corresponds to the expression of the aflatoxin biosynthetic gene cluster. In the present diagram, the index ε exhibits a value in the order of 10⁴. By contrast, the index ε of Aspergillus oryzae, which is a species with weak expression of secondary metabolites, was a value in the order of 10³, as shown in FIG. 15. This is consistent with the fact that Aspergillus flavus expresses secondary metabolites much more strongly than A. oryzae.

As is evident from these results, the virtual gene cluster scoring using the expression level fold change data of the system C2 was able to predict that the targeted gene cluster was included in the constructed virtual gene clusters. Thus, the following experiment was conducted using the DNA microarray data set of the system C2.

### (C) Gene Cluster Determination

As in Example 1, the index χ of each virtual gene cluster was calculated according to the calculation formula b) using the respective scores (M values) of the virtual gene clusters based on the system C2. As in Examples 1 and 2, virtual gene clusters that were not applicable were excluded from this calculation according to values at ncl=1. The results are shown in FIG. 30. As described in Example 1(C), each polygonal line in this line graph links the respective indexes of virtual gene clusters with gene sizes of 1 to 30 that shared the common gene designated as a starting point in the virtual gene cluster construction.

As is evident from the results of FIG. 30, each polygonal line of the virtual gene clusters that shared the common starting point takes the local maximum of the χ value at a certain size in the line graph. This line graph showing each polygonal line of the virtual gene clusters that shared the common starting point depicts approximately 4 size groups at which the local maximum of the χ value was as high as approximately 150. The size (ncl) around 20, among these 4 sizes, contained the largest number of peaks of the local maximum. The gene cluster involved in Aspergillus flavus aflatoxin synthesis has already been known. Referring to the functional annotations on the genes in the top 10 virtual gene clusters having a high peak at this size around 20, all of these gene clusters were shown to contain the genes involved in synthesis aflatoxin. This result is consistent with the prediction results of the step (B), demonstrating that this χ value calculation was capable of identifying, to some extent, the gene cluster involved in Aspergillus flavus aflatoxin biosynthesis and the aflatoxin biosynthetic genes contained therein. In FIG. 30, a plurality of other virtual gene clusters took a large value. These clusters are likely to be unknown gene clusters involved in secondary metabolite synthesis, also in light of their putative-function annotations.

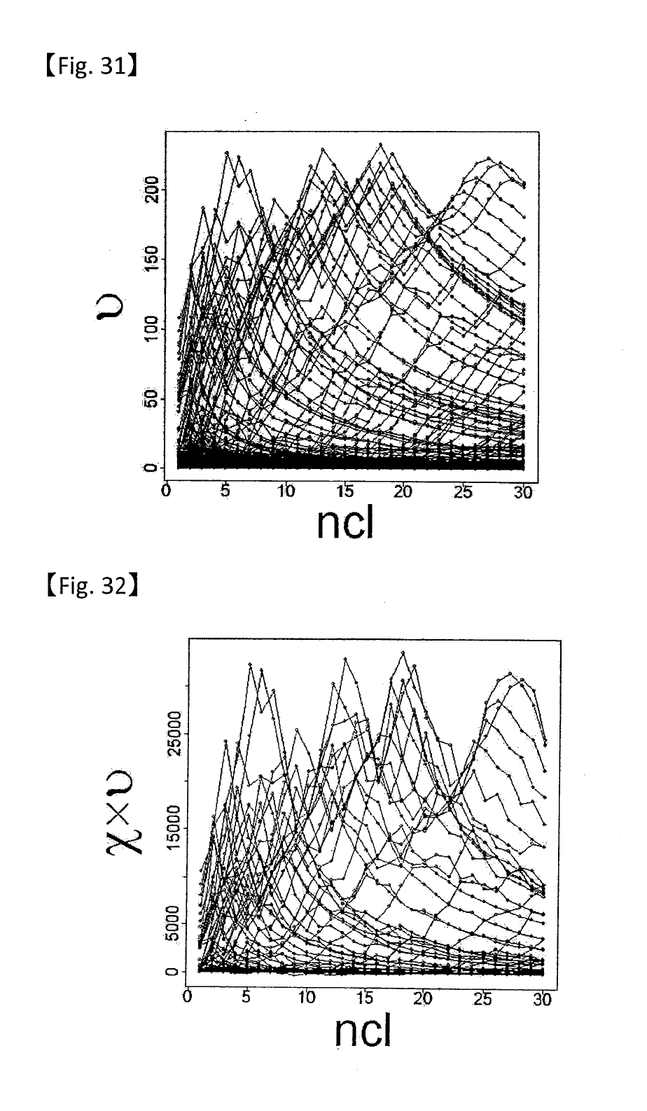

Next, as in Example 1, the index υ of each virtual gene cluster in the system C2 was calculated according to the calculation formula c). In this context, 2 was adopted as the number d′ of dimensions, while 1 was adopted as a coefficient a. As in Examples 1 and 2, virtual gene clusters that were not applicable were excluded according to values at ncl=1. The results are shown in FIG. 31. As in FIG. 31, each polygonal line in this line graph in FIG. 31 links the respective indexes of virtual gene clusters with gene sizes of 1 to 30 that shared the common gene designated as a starting point in the virtual gene cluster construction.

As shown in FIG. 31, many virtual gene clusters exhibited a local maximum. Of these clusters, virtual gene clusters exhibited a υ value around 200 at 4 sizes. The size around 20, among these 4 sizes, contained the largest number of peaks of the local maximum, as in the χ value. All of the top 10 virtual gene clusters having a peak at this size contained the aflatoxin biosynthetic genes. Some of these clusters contained the whole aflatoxin biosynthetic gene cluster. These results demonstrated that this υ value calculation was also capable of identifying, to some extent, the gene cluster involved in aflatoxin biosynthesis and the aflatoxin biosynthetic genes contained therein

In order to further narrow down the gene cluster candidates on the basis of the χ and υ values thus obtained, an estimate for assessing each gene cluster was calculated, as in Example 1, according to the calculation formula d) from the product of these two values. FIG. 32 shows, in a graph form, the relationship between the virtual gene cluster size and the χ×υ value based on this calculation result. As is evident from FIG. 32, many virtual gene clusters exhibited a local maximum at particular ncl. Of these clusters, virtual gene clusters having a global maximum at ncl=18 consisted of AFLA_{—}139150-AFLA_{—}139220, AFLA_{—}139240-AFLA_{—}139280, or AFLA_{—}139300-AFLA_{—}139320, all of which are genes contained in the known aflatoxin biosynthetic gene cluster. The functional annotations on other virtual gene clusters that exhibit a value of 25000 or larger indicate typical secondary metabolite-related gene functions NRPS and P450. These gene clusters are also likely to be unknown secondary metabolite biosynthetic gene clusters. As a result of comparing these values with those of Aspergillus oryzae (FIG. 18) in Example 1, A. flavus was shown to have about 3 times higher the value of A. oryzae. This is consistent with the fact that Aspergillus flavus is a species producing secondary metabolites very actively.

These results demonstrated that the present invention is effective for identifying the biosynthetic genes that function as an assembly on the genome, using DNA microarray data.

### (Reference 1)

Beyond aflatoxin:four distinct expression patterns and functional roles associated with Aspergillus flavus secondary metabolism gene clusters
D. RYAN GEORGIANNA et al., MOLECULAR PLANT PATHOLOGY (2010) 11(2), 213-226

### (Reference 2)

Genetic regulation of aflatoxin biosynthesis:from gene to genome
D. RYAN GEORGIANNA et al., Fungal Genetics and Biology (2009) 46(2), 113-125

### Example 6

### Prediction of Biosynthetic Gene in Aspergillus niger by Gene Cluster Scoring

The secondary metabolite biosynthetic gene cluster of Aspergillus niger was predicted according to the identifying approach of the present invention. The same apparatus as in Example 1 was used in this experiment.

A portion of DNA microarray data registered under ID GSE17329 in the public gene expression analysis database NCBI GEO (http://www.ncbi.nlm.nih.gov/geo/) was used. Specifically, this data was stored as the expression level data sets of genomic genes in the memory portion through the gene expression level data input portion. Unlike the Aspergillus oryzae-derived data used in Examples 1 to 4, this array data was obtained by a one-color assay method. Thus, in order to obtain the expression level fold change m value of each genomic gene, each condition shown below was established as a condition involving a change in the physiological state in the gene expression level fold change calculating portion. The m value was calculated with the expression level under this condition as a numerator and the expression level under its control condition as a denominator. A total of two systems shown below were studied. These systems expect the involvement of a certain secondary metabolism-related gene cluster under a carbon source-deficient condition and do not target a particular function, for example, the kojic acid or aflatoxin production described above.

C1: 55.55 hours after carbon source depletion during culture/5 hours after carbon source depletion during culture
C2: 24 hours after carbon source depletion during culture/3.5 hours before carbon source depletion

Hereinafter, these two systems each based on the condition involving a change in the physiological state are referred to as systems C1 and C2, respectively. In this context, the expression level fold change was calculated for 14509 genes in each of these two systems.

### (A) Cluster Scoring

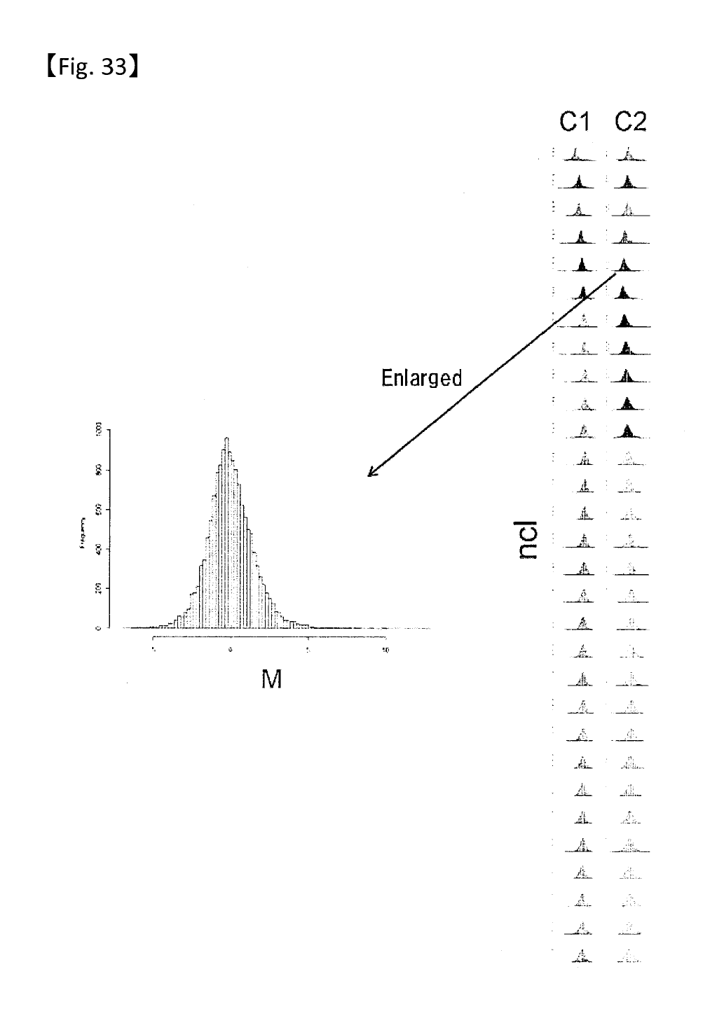

As in Example 1, virtual gene clusters with sizes of ncl=1 to 30 were individually scored according to the calculation formula a) as to each of the systems C1 and C2 to obtain their respective M values. The right view of FIG. 33 is a histogram showing the distribution state of scores of the virtual gene clusters on a size basis. The left graph of FIG. 33 is an enlarged view of one of the histograms. As is evident from the left enlarged view of FIG. 33, the top of the overall distribution in the histogram is shifted to the left in the presence of a virtual gene cluster having a high M value distant from the near-zero value-centered unimodal normal distribution-like population. It is obvious that the top of the distribution is shifted to the left around ncl=5 in the system C2.

### (B) Data Assessment

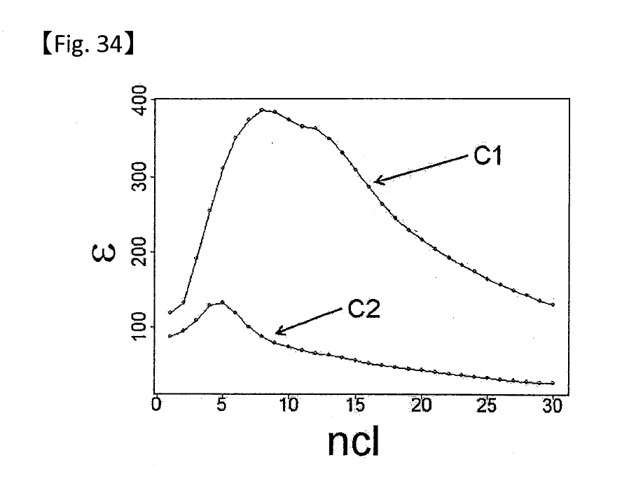

As in Examples 1, 2, and 5, a score distribution index ε was calculated according to the calculation formula e) as to each of the systems C1 and C2 (FIG. 34). In this context, the number n of virtual gene clusters was set to 14509, while 6 was adopted as the number d of dimensions. As shown in FIG. 34, the systems C1 and C2 exhibited a local maximum at ncl=8 and ncl=5, respectively. This means that these two systems both contained a virtual gene cluster that increased a value, despite averaging attributed to cluster scoring. By this virtual gene cluster scoring using the expression level fold change data based on these two systems (C1 and C2), it was successfully predicted that the gene cluster that increased the ε value was present and its gene cluster size was around 8 or around 5. In this experiment, however, the carbon source-deficient condition was established, as described above, as the condition involving a change in the physiological state and does not target a particular gene cluster. Accordingly, a very large number of gene clusters are presumably involved in this change, and the size prediction based on the ε value is not definitive.

In light of this, the following experiment was further conducted.

### (C) Gene Cluster Determination

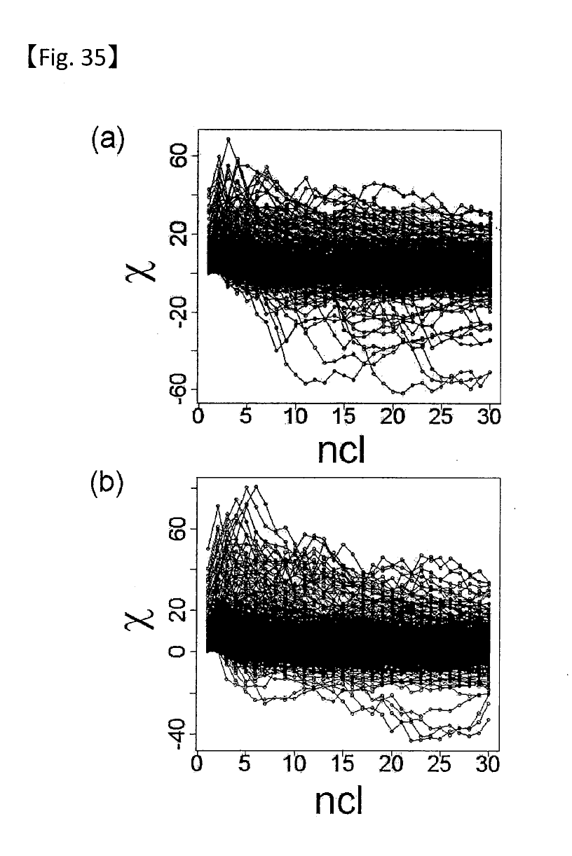

As in Example 1, the index χ of each virtual gene cluster was calculated as to each of the systems C1 and C2 according to the calculation formula b) from the DNA microarray data sets of the systems C1 and C2 (FIG. 35(a): C1, FIG. 35(b): C2). As in Examples 1, 2, and 5, virtual gene clusters that were not applicable were excluded according to values at ncl=1.

As is evident from the results of FIG. 35, many virtual gene clusters exhibited a local maximum in both the systems C1 and C2. This result suggests that Aspergillus niger has a gene cluster that varies under the conditions involving a change in the physiological state in the systems C2 and C3. This is consistent with the existing fact (Reference 3).

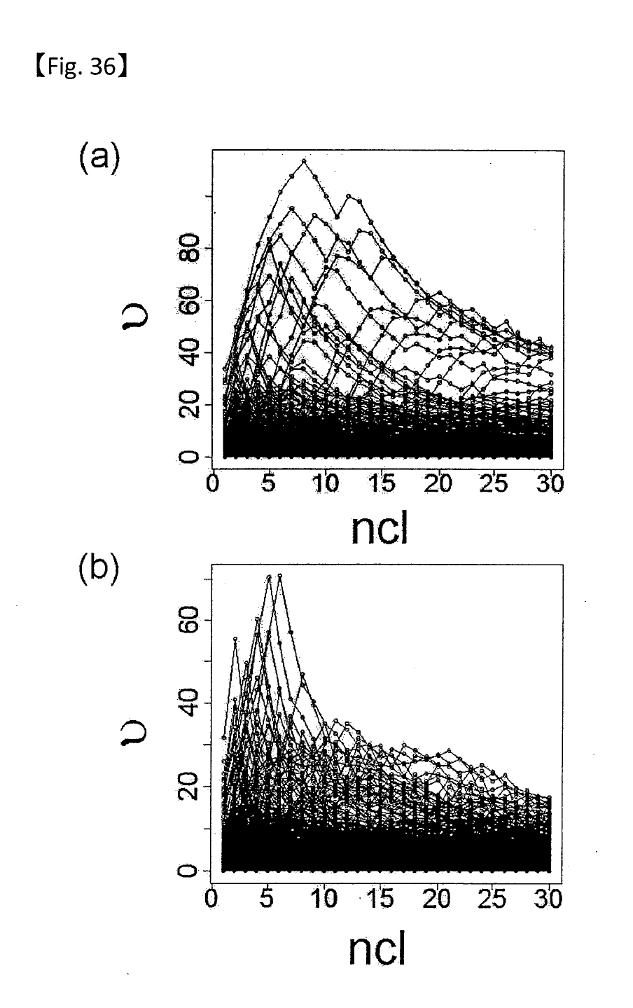

Next, as in Example 1, the index υ of each virtual gene cluster was calculated according to the calculation formula c) as to each of the systems C1 and C2 (FIG. 36(a): C1, FIG. 36(b): C2). In this context, 2 was adopted as the number d′ of dimensions, while 1 was adopted as a coefficient a. Again, as in Examples 1, 2, and 5, virtual gene clusters that were not applicable were excluded according to values at ncl=1. As shown in the results of FIG. 36, a plurality of virtual gene clusters exhibited a local maximum in both the systems C1 and C2. Since the difference between the high and low ranks of the υ value is larger than that of the χ value (FIG. 35), the υ value is more advantageous for extracting a small number of virtual gene clusters in this experiment. For example, in the system C1, only one virtual gene cluster has a υ value of 100 or larger. In the system C2, only three virtual gene clusters have υ value of 60 or larger.

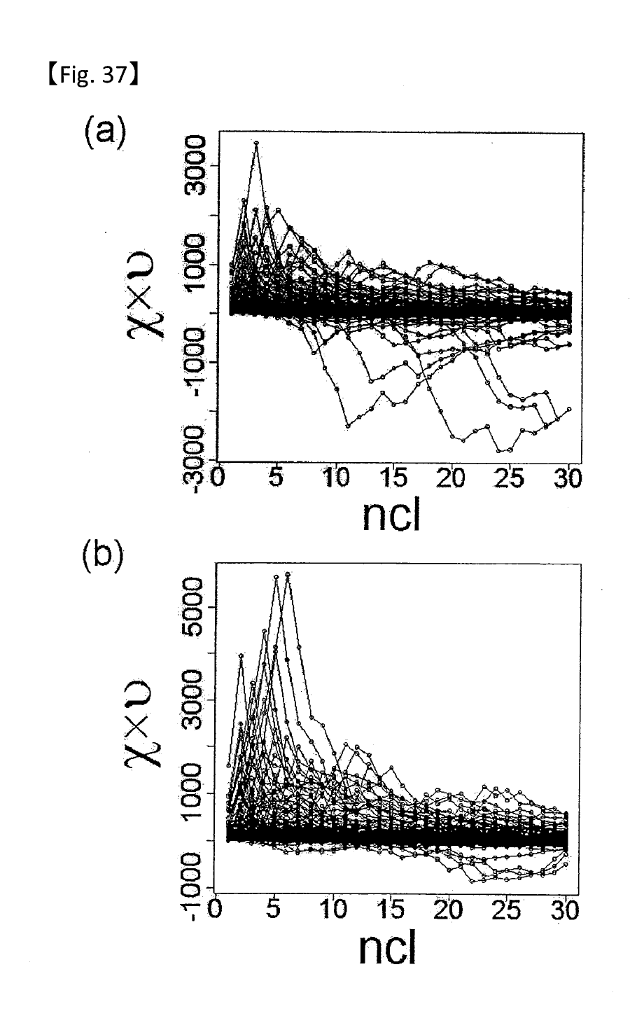

On the basis of the χ and υ values thus obtained, as in Example 1, an estimate for assessing each gene cluster was calculated according to the calculation formula d) from the product of these two values (FIG. 37(a): C1, FIG. 37(b): C2). As is evident from the results of FIG. 37, one virtual gene cluster took a local and global maximum at ncl=3 in the system C1. Some distinctive peaks were also observed in the system C2. For example, four virtual gene clusters took a value of 4000 or larger. As a result of examining the functional annotations on the genes constituting these virtual gene clusters by motif search based on their sequences, most of these genes were functionally unidentified, and functional genes corresponding to them were not found. In consideration of their high values of this estimate, however, these gene clusters are likely to be unknown gene clusters.

### (Reference 3)

Review of secondary metabolites and mycotoxins from the Aspergillus niger group
K. FOG NIELSEN et al., Analytical and Bioanalytical Chemistry (2009) 395(5), 1225-1242

### Example 7

### Search for Kojic Acid Biosynthetic Gene by Virtual Gene Cluster Construction on Condition that Each Gene Cluster Contains One or More Gene(s) Selected on Basis of Annotation (Functional Annotation)

For the purpose of identifying a gene cluster consisting of the kojic acid production-related genes of Aspergillus oryzae, genes annotated in relation to putative functions were selected, and virtual gene clusters each containing one or more of the genes were then constructed and individually scored to identify the genes concerned.

The approach used in this experiment is basically the same as in Example 1. In Example 1, virtual gene clusters were constructed with their sizes set to 1 to 30 to cover all genomic genes in the order in which they were arranged. This Example differs therefrom in that: virtual gene cluster construction was changed so that a functional gene selected by annotation assignment was designated as a starting point when appearing in genomic positional information (sequence information); and in the scoring of the constructed virtual gene clusters, only the expression level fold changes of the selected functional genes were instead used by the neglect of the expression level fold changes (m values) of genes other than the selected functional genes. As in Example 1, the gene sizes of these virtual gene clusters were set to 1 to 30 in the order in which the genomic genes were arranged.

Specifically, the apparatus used in this experiment is basically the same as in Example 1 except that: virtual gene cluster construction executed by the virtual gene cluster constructing program was changed so that a functional gene selected by the gene selecting portion based on annotation assignment was designated as a starting point when appearing in genomic positional information (sequence information); and in the scoring of the constructed virtual gene clusters, only the expression level fold changes of the selected functional genes were instead used by the neglect of the expression level fold changes (m values) of genes other than the selected functional genes. As in Example 1, the gene sizes of these virtual gene clusters were set to 1 to 30 in the order in which the genomic genes were arranged.

In this Example, the experiment was conducted using only the array data of the system C2 (day 7/day 4) presumed as a result of data assessment in Example 1 to contain the gene cluster concerned. As in Example 2, the following three functions were picked out as functions necessary for kojic acid production:

membrane transporter: transporter or major facilitator,

transcriptional regulator: transcription,

oxidoreductase: oxidoreductase or dehydrogenase.

These functions were picked out on the grounds that: kojic acid is presumably biosynthesized by conversion from glucose through oxidation; the membrane transport-mediated secretion of produced kojic acid into a medium presumably requires a membrane transporter; and a transcription factor is presumably necessary for the transcriptional regulation of the genes involved in the biosynthesis. The English words described above were keywords used in annotation-based gene selection.

### Annotation (Functional Annotation)-Based Gene Selection and Construction and Scoring of Virtual Gene Cluster

Annotations were assigned to genes on the genomic DNA of Aspergillus oryzae using Interproscan (http://www.ebi.ac.uk/Tools/InterProScan/), a generally available annotation prediction program. Genes corresponding to the three functions described above were selected. Specifically, the annotation data set of the genes was input to the input device of the present apparatus and stored in the memory device. Each data in the stored annotation data set was called up, and genes having the three types of functions, respectively, were selected by the application of the selecting program in the functional gene selecting portion. This selection was carried out on the basis of whether or not the annotation assigned to each gene contained any of the English words corresponding to the three functional groups. As a result, 796 out of the 5595 genes whose effective gene expression data was successfully acquired in the system C2 were selected.

The program changed as described above was applied to virtual gene cluster construction. On the basis of the positional information set of genomic genes, a selected functional gene was designated as a starting-point gene when appearing in the gene sequence of the genome. Virtual gene clusters were constructed at varying cluster sizes from 1 to 30 in the order in which the genomic genes were arranged. As a result, each virtual gene size thus constructed contains, without exception, one or more gene(s) selected on the basis of the assigned annotation, and a virtual gene cluster containing no selected functional gene is not constructed. The constructed gene cluster also contains gene(s) other than the selected functional gene(s). The reason for this design is the smallest possible change made to the virtual gene constructing program stored in the apparatus of Example 1. In the scoring of the constructed virtual gene clusters, however, calculation was carried out according to the calculation formula a) using only the expression level fold changes of the selected functional genes by the neglect of the expression level fold changes of genes other than the selected functional genes. The resulting scores of the virtual gene clusters are totally the same as the scores of virtual gene clusters constructed from only the selected functional genes. The respective scores of the virtual gene clusters thus obtained were stored in the memory portion of the apparatus of the present invention.

In this Example, some constructed virtual gene clusters contained only one gene. As in Examples 1 to 4, the virtual gene cluster construction of this Example involved genes positioned at genomic terminus and, in this case, was performed using the maximum possible number of genes to be combined. This does not influence the present gene cluster search, in terms of the properties of cluster scoring. The number of the virtual gene clusters thus constructed is 796 at each cluster size.

Subsequently, the constructed virtual gene clusters were individually scored at ncl=1 to 30 according to the calculation formula a) to obtain their respective scores (M values).

### Gene Cluster Determination

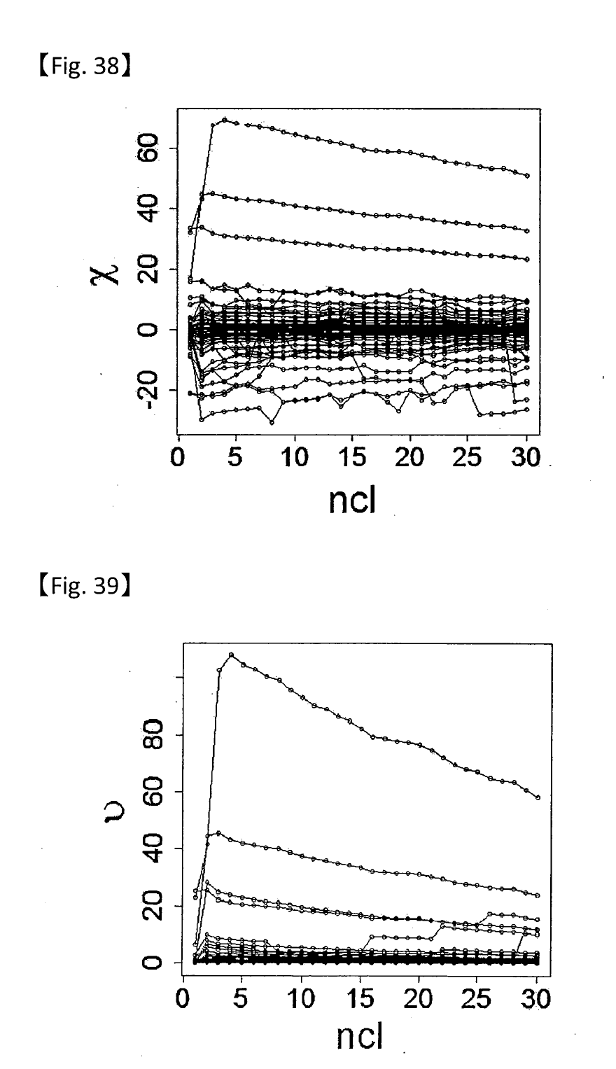

The index χ of each virtual gene cluster was calculated according to the calculation formula b) on the basis of the respective calculated scores (M values) of the virtual gene clusters. Specifically, the stored score of each virtual gene cluster was called up, and the index χ of each virtual gene cluster was calculated according to the calculation formula b) by the application of the χ value calculating program stored as a virtual gene divergence degree determining program in the portion of calculating the degree of divergence of each virtual gene cluster. In FIG. 38, each polygonal line links the respective indexes χ of virtual gene clusters with cluster sizes on the abscissa that shared the common starting-point gene. In this context, since a virtual gene cluster that did not increase the absolute value by cluster scoring was not the target, a virtual gene cluster having an absolute value at ncl=1 larger than an absolute value at ncl=2 was excluded.

As is evident from the drawing, the indexes χ of many virtual gene clusters were positioned at near-zero values, whereas three assemblies of the virtual gene clusters that shared the common starting point took a large value. Among them, the most highly ranked assembly took a local and global maximum at ncl=4. This cluster comprised the three genes AO090113000136, AO090113000137, and AO090113000138 essential for kojic acid production as well as the adjacent gene AO090113000139 having the annotation “major facilitator” (membrane transporter) on which the gene selection of this Example was based. Since the virtual gene clusters are scored in this Example using only the expression level fold changes of the annotated genes to be selected, components unnecessary for the scoring can be trimmed as much as possible. As a result, when a gene selected on the basis of an annotation is located in the vicinity to the gene cluster concerned, a gene cluster comprising this gene and the gene cluster concerned can take a high value. This virtual gene cluster that exhibits a global maximum contains the three genes essential for kojic acid production. Accordingly, the present approach is effective for searching for the gene cluster. In actuality, in this assembly that exhibited a global maximum in FIG. 38, the virtual gene clusters that shared the common starting-point gene did not largely differ in their values between ncl=3 (consisting only of the three genes essential for kojic acid production) and ncl=4 (further comprising the adjacent gene AO090113000139).

The other two assemblies of the virtual gene clusters having a large value distant from zero contained the genes essential for kojic acid production except for AO090113000136.

Similarly, the index υ of each virtual gene cluster was calculated according to the calculation formula c). Specifically, the index υ of each virtual gene cluster was calculated according to the calculation formula c) by the application of the υ value calculating program stored in the portion of calculating the degree of divergence of each virtual gene cluster. As in Example 1, 2 and 1 were adopted as the number d′ of dimensions and a coefficient a, respectively. FIG. 39 shows results of linking the respective indexes u of virtual gene clusters that shared the common starting-point gene at ncl=1 to 30. In FIG. 39 as well, a virtual gene cluster having a value at ncl=1 larger than a value at ncl=2 was excluded.

As in the index χ, one virtual gene cluster took a local and global maximum at ncl=4. This gene cluster comprised the three genes essential for kojic acid production as well as another gene AO090113000139. As is evident from FIG. 39 compared with FIG. 17, annotation-based gene selection largely decreases the number of virtual gene cluster candidates and renders the gene cluster concerned more distinct from other clusters having a near-zero value.

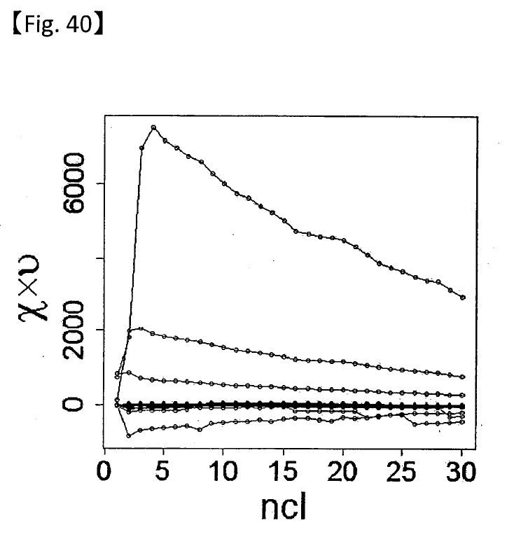

The candidate narrowing down program stored in the gene cluster narrowing down portion was applied to the χ and υ values thus obtained to calculate an estimate for assessing each gene cluster according to the calculation formula d) from the product of these two values (FIG. 40). As is evident from the drawing, one virtual gene cluster took a large value beyond 6000 at ncl=4. This cluster comprised the three genes essential for kojic acid production. In addition, two virtual gene clusters exhibited a relatively large value deviating from the near-zero value population. These clusters comprised the genes essential for kojic acid production except for AO090113000136. As is evident from FIG. 40 compared with FIGS. 38 and 39, the multiplication of these two indexes allows the gene cluster concerned to have a more distinctively large value and improves the prediction accuracy of the gene cluster concerned.

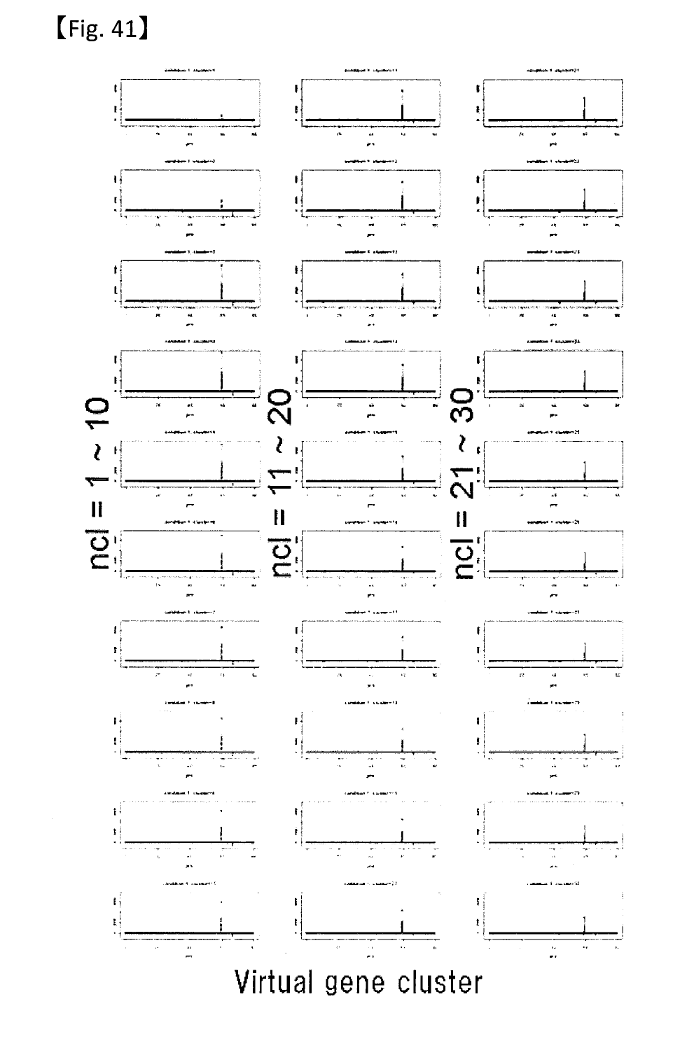

FIG. 41 is a plot of the estimate for assessing each gene cluster against each cluster size as virtual gene cluster numbers on the abscissa. Scales on the ordinates of diagrams corresponding to the cluster sizes, respectively, were equalized. In this diagram, gene clusters each containing three or two of the three genes essential for kojic acid production took a global maximum at ncl=4 and exhibited an outstandingly high value at any cluster size. This shows that the kojic acid production-related gene cluster to be predicted in this Example was sensitively detected by the present approach.

These experimental results demonstrated that a gene cluster of interest and genes contained therein can be searched for highly sensitively by constructing virtual gene clusters each containing one or more gene(s) selected on the basis of an annotation and performing cluster scoring using the expression level fold changes of the selected genes. From these experimental results, it is also obvious that similar results can be obtained by constructing virtual gene clusters from only combinations of one or more type(s) of genes selected on the basis of an annotation, followed by scoring.

The present approach involves strong filtering operation and may excessively reflect the m value of each gene having the annotation concerned. However, in the case of a relatively small differential expression ratio between genes, this approach can rather predict the gene cluster of interest with high sensitivity.

### Example 8

### Prediction of Secondary Metabolite Biosynthetic Gene in Fusarium verticillioides by Gene Cluster Scoring and its Verification

The secondary metabolite biosynthetic gene cluster of Fusarium verticillioides, a species of the fungal genus Fusarium, was predicted according to the identifying approach of the present invention. The fungal genus Fusarium is phylogenetically distant from the fungal genus Aspergillus used in Examples 1 to 6 (Reference 4). Also, the fungi of this genus are known to produce mycotoxins including fumonisin and considered to have many other secondary metabolite biosynthetic gene clusters (Reference 5).

A portion of DNA microarray data registered under ID GSE16900 in the public gene expression analysis database GEO (http://www.ncbi.nlm.nih.gov/geo/) provided by the National Center for Biotechnology Information (NCBI) (USA) was used. This array data contains gene expression levels determined by a one-color assay method under each of culture conditions involving culture times of 24, 48, 72, and 96 hours in a fumonisin production medium. Thus, in order to obtain expression level fold change m values, a secondary metabolite production inducing condition and a non-inducing condition were compared as shown below. The m value was calculated with the expression level under the former condition as a numerator and the expression level under the latter condition as a denominator. The following two systems were studied:

C1: 72-hour culture time/24-hour culture time
C2: 96-hour culture time/48-hour culture time

Hereinafter, these two systems are referred to as systems C1 and C2, respectively. The expression information set of each system contains 12230 genes for use in constituting gene clusters. Since the original array data provides three data sets per culture time, the expression level of each gene was averaged among these three sets. Subsequently, the following procedures were performed.

### (A) Cluster Scoring

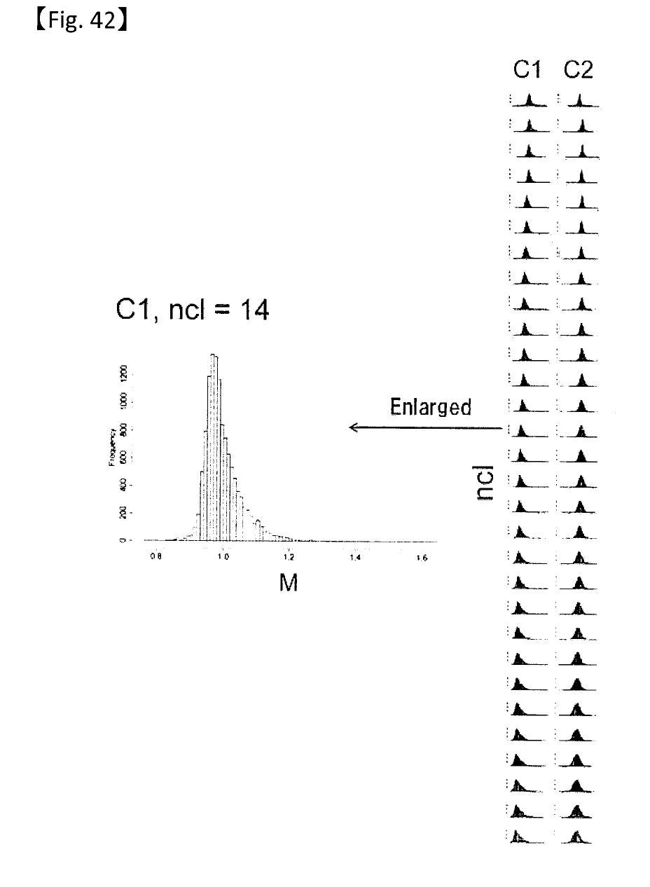

Cluster scoring was performed at ncl=1 to 30 according to the calculation formula a) as to each of the systems C1 and C2 to obtain the M value of each virtual gene cluster. FIG. 42 shows the histogram thereof. As seen from the left enlarged view, the top of the overall distribution in the histogram of M values at each ncl is shifted to the left in the presence of a virtual gene cluster having a high M value distant from the zero-centered unimodal normal distribution-like population. Referring to the histograms at varying ncl values shown on the right from top to bottom, it is obvious that the top of the distribution is shifted to the left with increase in ncl. The sequence information set of genomic genes required for cluster scoring was acquired from fusarium_verticillioides_{—}3_genome_summary_per_gene.txt in the database “Fusarium Comparative Sequencing Project, Broad Institute of Harvard and MIT (http://www.broadinstitute.org/)” published on the website by the US research institute Broad Institute.

### (B) Data Assessment

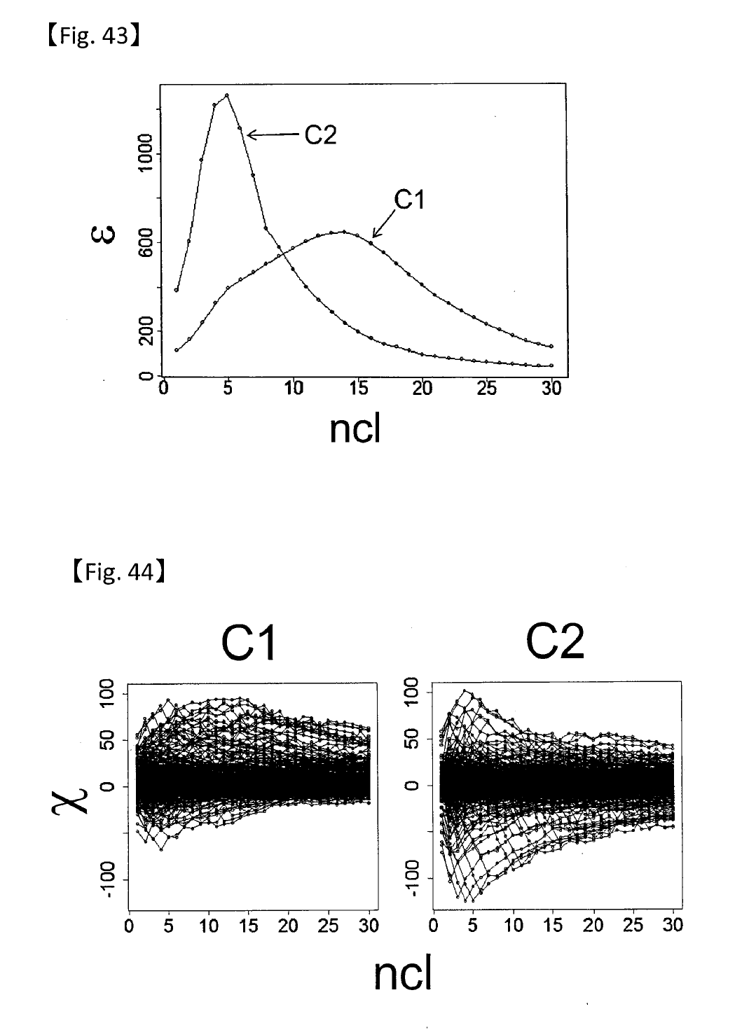

A score distribution index ε for each of the systems C1 and C2 was calculated according to the calculation formula e) (FIG. 43). In this context, the number n of virtual gene clusters was set to 12230 at each ncl, while 6 was adopted as the number d of dimensions. As shown in the drawing, the systems C1 and C2 exhibited a local maximum at ncl=14 and ncl=5, respectively. This means that these two systems both contained a virtual gene cluster that increased a value, despite averaging attributed to cluster scoring. By this cluster scoring using these two systems (C1 and C2), the gene cluster that increases the ε value and corresponds to the target gene cluster to be identified as proposed by the present invention can be confirmed to be present.

Thus, the following identification process was conducted using these gene expression information sets of the systems C1 and C2.

### (C) Gene Cluster Determination

The index c of each virtual gene cluster was calculated according to the calculation formula b) from the DNA microarray data sets of the systems C1 and C2 (FIG. 44). In consideration of the purpose of detecting a target gene cluster, a virtual gene cluster having an absolute value at ncl=1 larger than an absolute value at ncl=2 was excluded. As a result, a plurality of virtual gene clusters, as shown in the drawing, exhibited a local maximum and a local minimum at sizes other than ncl=1 in both the systems C1 and C2. This suggest that Fusarium verticillioides has a plurality of secondary metabolism-related gene clusters. This is consistent with the existing fact (Reference 5).

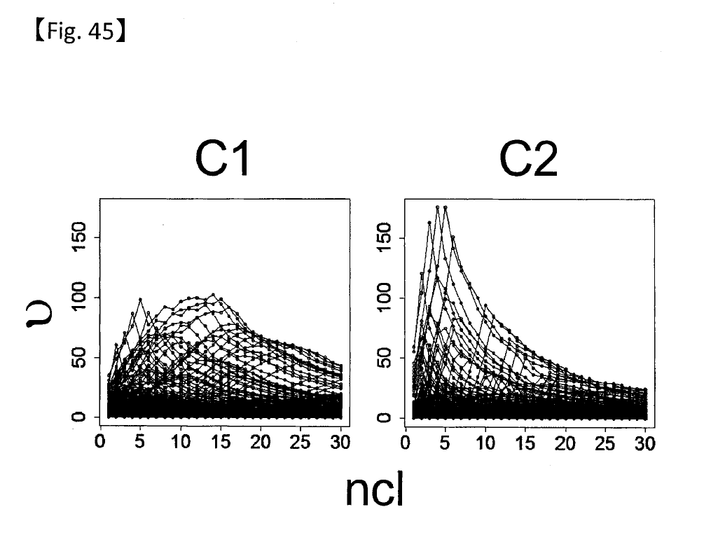

Next, the index u of each virtual gene cluster was calculated according to the calculation formula c) as to each of the systems C1 and C2 (FIG. 45). In this context, 2 was adopted as the number d′ of dimensions, while 1 was adopted as a coefficient a. In this context, a virtual gene cluster having a value at ncl=1 larger than a value at ncl=2 was excluded, as in the c value. As a result, a plurality of virtual gene clusters, as shown in the drawing, exhibited a local maximum in both the systems C1 and C2. Since the difference between the high and low ranks of the local maximum of the u value is larger than that of the c value (FIG. 44), a small number of top virtual gene clusters can be extracted more easily using the u value than the c value. For example, in the system C1, only one virtual gene cluster has a u value of 100 or larger. In the system C2, only three virtual gene clusters have u value of 150 or larger. This suggests that the gene cluster concerned can be ranked highly using the index u.

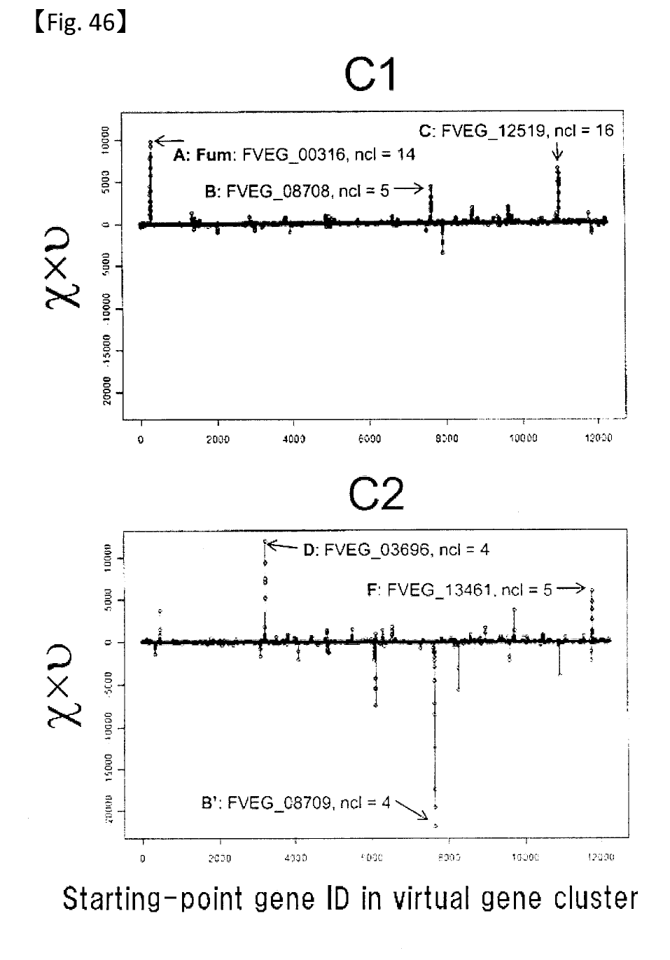

On the basis of the c and u values thus obtained, an estimate for assessing each gene cluster was calculated according to the calculation formula d) from the product of these two values. FIG. 46 is a diagram showing starting-point genomic gene numbers on the abscissa plotted against the largest estimate among 30 virtual gene clusters with ncl=1 to 30 at each ID, wherein 12230 Fusarium verticillioides genes contained in each array data set were individually designated as a starting point. In this drawing, scales on the ordinates of diagrams of the systems C1 and C2 were equalized. Three virtual gene clusters took an outstandingly high value in the system C1. These clusters had cluster sizes of 14, 5, and 16 with the genes FVEG_{—}00316, FVEG_{—}08708, and FVEG_{—}12519, respectively, designated as starting points. Results of subjecting the genes constituting these virtual gene clusters to sequence homology search (BLAST) are shown in Table 3. The database used was NR (Non-Redundant, http://www.ncbi.nlm.nih.gov/staff/tao/URLAPI/blastdb.html) provided by NCBI, which stores the gene sequences of many organism species including microbes. The table shows an excerpta of the best hit from those having an E value (value for evaluating high homology) of 10⁻¹⁰⁰ or less. Analysis using Gibberella moniliformis, a teleomorph of Fusarium verticillioides, has reported that the biosynthetic genes of the known secondary metabolite fumonisin form a cluster consisting of 15 genes (References 6, 7, and 8). In Fusarium verticillioides, five fumonisin biosynthetic genes have been identified so far: FUM1(5), FUM6, FUM7, FUM8, and FUM9 (Reference 9). As is evident from the table, 14 gene cluster component genes marked with A are 14 out of the 15 fumonisin biosynthetic genes (the term “Fum” is also described next to the mark A). These results demonstrated that the secondary metabolite fumonisin biosynthetic gene cluster can be predicted with substantial accuracy by the approach of the present invention. The remaining one fumonisin biosynthetic gene that was not included in the results of this experiment was confirmed as FVEG_{—}00315 immediately before FVEG_{—}00316 as a result of gene homology search. Referring to the estimate for assessing each virtual gene cluster, a gene cluster having FVEG_{—}00315 as a starting point at a cluster size of 15 has a value of 9242, whereas a gene cluster having FVEG_{—}00316 as a starting point at a cluster size of 14 has a value of 9763. As seen from the drawing, these two points were in close proximity to each other (two points at the peak of gene cluster A in C1 of FIG. 46), showing that FVEG_{—}00315 was not included by narrow margin. Thus, it is conceivable that, when the global maxima of estimates of clusters presumed to each contain the same gene are in close proximity to each other, the most accurate prediction results can be obtained by selecting the cluster having the largest virtual cluster size.

A plurality of distinctive peaks were also observed in the system C2 (FIG. 46). In particular, a virtual gene cluster with a cluster size of 4 having FVEG_{—}03696 as a starting point exhibited the largest positive peak with a value exceeding 10000. This peak was not seen in the system C1 in which 72 hours into culture were compared with 24 hours thereinto, suggesting the presence of a gene cluster that is expressed only after 96 hours into culture. Also, a virtual gene cluster with a cluster size of 4 having FVEG_{—}08709 as a starting point took a large negative value in the system C2. This gene cluster (indicated by B′ in FIG. 46) is equivalent to a gene cluster (indicated by B in FIG. 46) having a positive value in the system C1, though their starting points differ by one gene. This is presumably a gene cluster that has already been expressed when the 72-hour culture time has passed, but stops its expression after 96 hours. Thus, different gene clusters can be detected even in one organism species by selecting systems to be compared according to the purpose for use of the present approach. Although the functions of these candidates of the gene cluster concerned are not clearly definable even from the results of BLAST search (Table 4), FVEG_{—}12523 contained in the virtual gene cluster C exhibited high sequence homology to a polyketide synthase gene, which is a secondary metabolite biosynthetic gene. This detected gene cluster can be expected to be a previously unknown novel secondary metabolite biosynthetic gene.

These results demonstrated that the method proposed by the present invention is effective for identifying the biosynthetic genes that function as an assembly on the genome of the fungus Fusarium verticillioides, which is phylogenetically distant from the genus Aspergillus, from the expression information set of all genes, as in the genus Aspergillus.

### (Reference 4)

Evolution of the Fot1 transposons in the genus Fusarium: discontinuous distribution and epigenetic inactivation
M.-J. Daboussi et al., Molecular Biology and Evolution (2002) 19 (4), 510-520

### (Reference 5)

Biochemistry and genetics of Fusarium toxins
A. E. Desjardins et al., Fusarium: Paul E. Nelson Symposium, APS Press (1999)

### (Reference 6)

Linkage among genes responsible for fumonisin biosynthesis in Gibberella fujikuroi mating population A Desjardins et al., Applied and Environmental Microbiology (1996) 62, 2571-2576

### (Reference 7)

A polyketide synthase gene required for biosynthesis of fumonisin mycotoxins in Gibberella fujikuroi mating population A
R. H. Proctor et al., Fungal Genetics and Biology (1999) 27, 100-112

### (Reference 8)

Co-expression of 15 contiguous genes delineates a fumonisin biosynthetic gene cluster in Gibberella moniliformis
R. H. Proctor et al., Fungal Genetics and Biology (2003) 38, 237-249

### (Reference 9)

Characterization of four clustered and coregulated genes associated with Fumonisin biosynthesis in Fusarium verticillioides
J.-A. Seo et al., Fungal Genetics and Biology (2001) 34, 155-165

TABLE 4
Results of homology search of gene cluster component gene of
Fusarium verticillioides detected by approach of the present
invention (Best hit, E-value <1e−100)

| Gene | | | | |
|---|---|---|---|---|
| cluster | | | | |
| (described | | | | |
| in drawing) | Gene name | Description | Score | E-value |
| A: Fum | FVEG_00316 | Fum1p [Gibberella | 1539 | 0.0 |
| | | moniliformis] | | |
| A: Fum | FVEG_00317 | Fum6p [Gibberella | 2047 | 0.0 |
| | | moniliformis] | | |
| A.: Fum | FVEG_00318 | Fum7p [Gibberella | 860 | 0.0 |
| | | moniliformis] | | |
| A: Fum | FVEG_00319 | Fum7p [Gibberella | 860 | 0.0 |
| | | moniliformis] | | |
| A: Fum | FVEG_00320 | Fum3p [Gibberella | 624 | 1e−176 |
| | | moniliformis] | | |
| A: Fum | FVEG_00321 | Fum10p [Gibberella | 566 | 2e−163 |
| | | moniliformis] | | |
| A: Fum | FVEG_00322 | Fum11p [Gibberella | 333 | 3e−139 |
| | | moniliformis] | | |
| A: Fum | FVEG_00323 | Fum2p [Gibberella | 805 | 0.0 |
| | | moniliformis] | | |
| A: Fum | FVEG_00324 | Fum13p [Gibberella | 678 | 0.0 |
| | | moniliformis] | | |
| A: Fum | FVEG_00325 | Fum14 [Fusarium | 800 | 0.0 |
| | | oxysporum] | | |
| A: Fum | FVEG_00326 | Fum16p [Gibberella | 798 | 0.0 |
| | | moniliformis] | | |
| A: Fum | FVEG_00327 | Fum17p [Gibberella | 731 | 0.0 |
| | | moniliformis] | | |
| A: Fum | FVEG_00328 | Fum18p [Gibberella | 592 | 8e−167 |
| | | moniliformis] | | |
| A: Fum | FVEG_00329 | Fum19p [Gibberella | 2075 | 0.0 |
| | | moniliformis] | | |
| B | FVEG_08708 | no hits found | — | — |
| B | FVEG_08709 | hypothetical protein | 577 | 2e−162 |
| | | [Gibberella zeae] | | |
| B | FVEG_08710 | hypothetical protein | 392 | 6e−149 |
| | | [Gibberella zeae] | | |
| B | FVEG_08711 | hypothetical protein | 1367 | 0.0 |
| | | [Gibberella zeae] | | |
| B | FVEG_08712 | hypothetical protein | 877 | 0.0 |
| | | (Gibberella zeae] | | |
| C | FVEG_12519 | hypothetical protein | 306 | 4e−128 |
| | | [Gibberella zeae] | | |
| C | FVEG_12520 | no hits found | — | — |
| C | FVEG_12521 | asparatate kinase | 480 | 4e−143 |
| | | [Glomerella | | |
| | | graminicola] | | |
| C | FVEG_12522 | no hits found | — | — |
| C | FVEG_12523 | polyketide synthase | 2841 | 0.0 |
| | | [Gibberella | | |
| | | moniliformis] | | |
| C | FVEG_12524 | hypothetical protein | 483 | 5e−179 |
| | | [Gibberella zeae] | | |
| C | FVEG_12525 | unnamed protein product | 440 | 4e−126 |
| | | [Aspergillus oryzae] | | |
| C | FVEG_12526 | hypothetical protein | 407 | 1e−111 |
| | | [Aspergillus oryzae] | | |
| C | FVEG_12527 | unnamed protein product | 316 | 3e−115 |
| | | [Aspergillus oryzae] | | |
| C | FVEG_12528 | no hits found | — | — |
| C | FVEG_12529 | 0-acetylhomoserine | 375 | 4e−151 |
| | | (thiol)-Iyase-like | | |
| | | protein [Chaetomium | | |
| | | thermophilum] | | |
| C | FVEG_12530 | hypothetical protein | 272 | 5e−143 |
| | | [Botryotinia | | |
| | | fuckeliana] | | |
| C | FVEG_12531 | no hits found | — | — |
| C | FVEG_12532 | no hits found | — | — |
| C | FVEG_12533 | hypothetical protein | 332 | 2e−149 |
| | | [Gibberella zeae] | | |
| C | FVEG_12534 | predicted protein | 224 | 2e−115 |
| | | [Aspergillus terreus] | | |
| D | FVEG_03696 | hypothetical protein | 318 | 7e−157 |
| | | [Gibberella zeae] | | |
| D | FVEG_03697 | predicted protein | 481 | 0.0 |
| | | [Nectria haematococca] | | |
| D | FVEG_03698 | hypothetical protein | 256 | 1e−116 |
| | | [Nectria haematococca] | | |
| D | FVEG_03699 | no hits found | — | — |
| F | FVEG_13461 | hypothetical protein | 1531 | 0.0 |
| | | [Gibberella zeae] | | |
| F | FVEG_13462 | hypothetical protein | 441 | 1e−121 |
| | | [Gibberella zeae] | | |
| F | FVEG_13463 | no hits found | — | — |
| F | FVEG_13464 | hypothetical protein | 383 | 2e−104 |
| | | [Gibberella zeae] | | |
| F | FVEG_13465 | no hits found | — | — |

### Example 9

### Detection of Lactose Operon in E. Coli by Gene Cluster Scoring and its Verification

The lactose operon of E. coli was detected according to the identifying approach of the present invention. E. coli, which is a prokaryote, largely differs in biological classification from the eukaryotes used in the verification of the approach of the present invention in Examples 1 to 8.

E. coli was the first organism from which the presence of operon was demonstrated. This operon is a control unit that functions as an assembly on the genome. The genes in the operon are clustered on the genome and highly expressed for their functions. In light of these properties, the operon can be targeted by the identification of the present invention.

Here, lactose operon demonstrated in this Example will be described. The lactose operon is composed of lad encoding a repressor protein, followed by a promoter sequence lacP, an operator sequence lacO, and three genes lacZ, lacY, and lacA (lacZYA) involved in lactose metabolism. Since lad is constantly expressed and binds strongly to the lacO region, the downstream lacZYA is not translated in a normal state. In the presence of an inducer such as isomerized lactose, however, the repressor protein translated from lad changes its conformation and is thereby liberated from the lacO region. As a result, the lactose metabolic system lacZYA is translated to elicit lactose metabolism (Reference 10).

DNA microarray data registered under ID GSE7265 in the public gene expression analysis database GEO (http://www.ncbi.nlm.nih.gov/geo/) provided by the National Center for Biotechnology Information (NCBI) (USA) was used (References 11 and 12). This array data shows minute-to-minute changes in the gene expression of an E. coli MG1655 strain and its variant during culture on a medium containing two nutrients (glucose and lactose). On the medium containing these two nutrients, E. coli first metabolizes glucose and then metabolizes lactose after depletion of glucose. Specifically, the lactose operon, which is the first operon demonstrated, is expressed when the nutrient is changed from glucose to lactose. Of these data sets, the data sets of the wild-type strain were used in this experiment. These data sets of the wild-type strain were obtained at 17 stages after the start of culture, i.e., after 780, 830, 861, 869, 878, 888, 898, 908, 919, 929, 939, 969, 999, 1035, 1049, 1070, and 1089 minutes, respectively, into culture. Each data set is described in the form of an expression induction ratio with a value at the early log phase (after 780 minutes) as a denominator and can thus be applied directly to the present approach. Since three or four data sets were collected per assay stage, the expression level of each gene was averaged among these three or four sets. Subsequently, the following procedures were performed. The number of genes contained in the data set was 4102.

### (A) Cluster Scoring

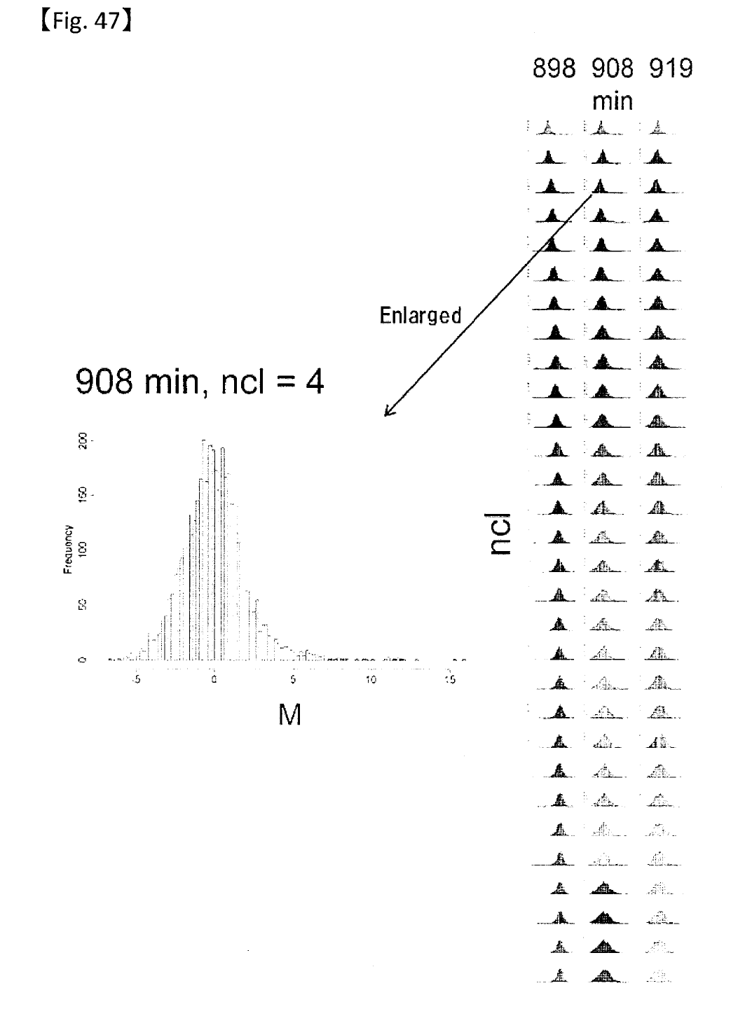

Cluster scoring was performed at ncl=1 to 30 according to the calculation formula a) as to each of the systems of 17 assay stages to obtain the M value of each virtual gene cluster. The sequence information set of genomic genes required for cluster scoring was acquired from genomic information on the E. coli MG1655 strain (ID: NC_{—}000913; http://www.ncbi.nlm.nih.gov/nuccore/NC_{—}000913) registered in the public scientific database NCBI. In this context, since E. coli has a circular genome, the gene named as b0001 in the genomic information was designated as a starting point and all genes were regarded as being consecutive. Four genes, lacI, lacZ, lacY, and lacA, constituting the lactose operon, are inversely oriented in the present genomic information and arranged in the order of lacA, lacY, lacZ, and lacI. Their gene IDs are b0342, b0343, b0344, and b0345, respectively. FIG. 47 shows a portion of histograms of M values of virtual gene clusters. As seen from the left enlarged view, the top of the overall distribution in the histogram of M values at each ncl is shifted to the left in the presence of a virtual gene cluster having a high M value distant from the zero-centered unimodal normal distribution-like population. Referring to the histograms at varying ncl values shown on the right from top to bottom, it is obvious that the top of the distribution is shifted to the left or right with increase in ncl. This indicates the presence of a virtual gene cluster having a high (low) value distant from the normal distribution.

### (B) Data Assessment

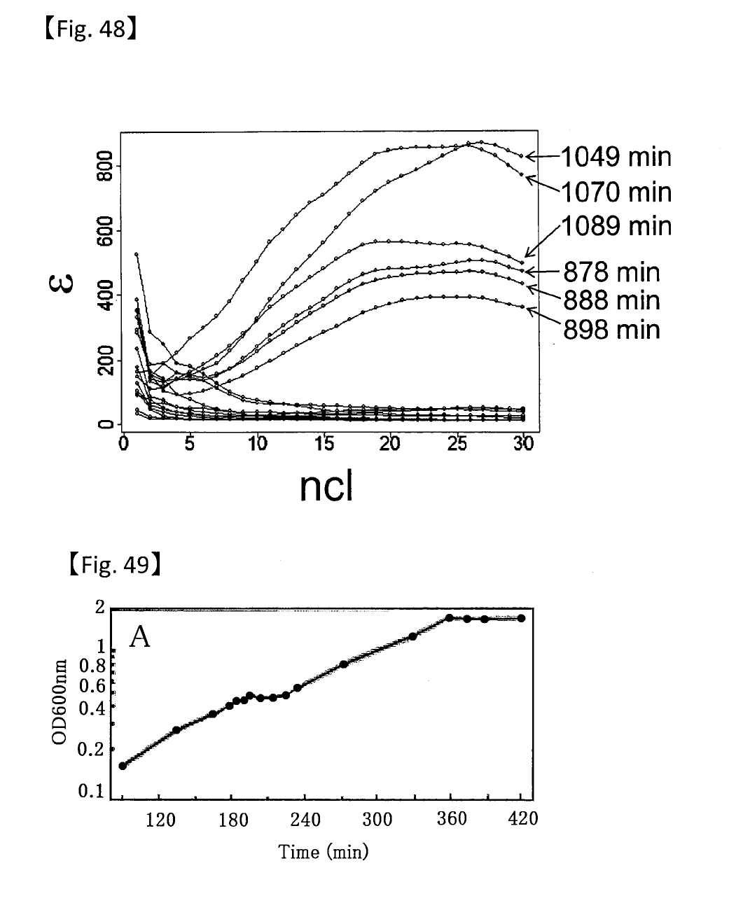

A score distribution index e for each of the 17 systems was calculated according to the calculation formula e) (FIG. 48). In this context, the number n of virtual gene clusters was set to 4102 at each ncl, while 6 was adopted as the number d of dimensions. As shown in the drawing, the e value exhibited a large local maximum in 6 systems (878, 888, 898, 1049, 1070, and 1089 minutes into culture). This result was checked against the growth rate of E. coli. FIG. 49 shows time-series data on turbidity indicating E. coli growth after the start of culture described in the literature relating to the present array data (Reference 11). Although the time scale of FIG. 49 differs from the array data due to undefined preculture time, the starting point in FIG. 49 corresponds to 780 minutes in the array data and the subsequent points sequentially corresponds to the 17 stages of the array data. As shown in the drawing, all the pieces of data (878, 888, 898, 1049, 1070, and 1089 minutes (7th, 8th, 9th, 15th, 16th, and 17th points, respectively)) having the large local maximum of the score distribution index e correspond to sites with a sluggish rise in turbidity in FIG. 49, i.e., plateaus in growth. Of them, the first plateau in growth occurs at a stage where the nutrient is changed to lactose after complete consumption of glucose. At this stage, the growth is suspended. Accordingly, a set of ribosomal genes essential for growth, which are clustered on the genome, is strongly inhibited, whereas the lactose operon is expressed for lactose consumption. Thus, the large local maximum of the e value exhibited at this stage is consistent with the inhibition of the set of ribosomal genes and the expression of the lactose operon. The second plateau in growth occurs at a stage where lactose is also depleted. Since the growth itself stops, the ribosomal genes essential for growth are strongly inhibited (Reference 13). The large local maximum of the e value at this stage suggests that this inhibition of the ribosomal genes is detected.

These results demonstrated that the e value was capable of sensitively determining the presence of a set of genes that function as an assembly on the genome as a result of expression (inhibition). This Example is aimed at demonstrating that the already identified lactose operon can be detected by the present approach. Thus, the following procedures were subsequently performed using the data sets of the 17 stages.

### (C) Gene Cluster Determination

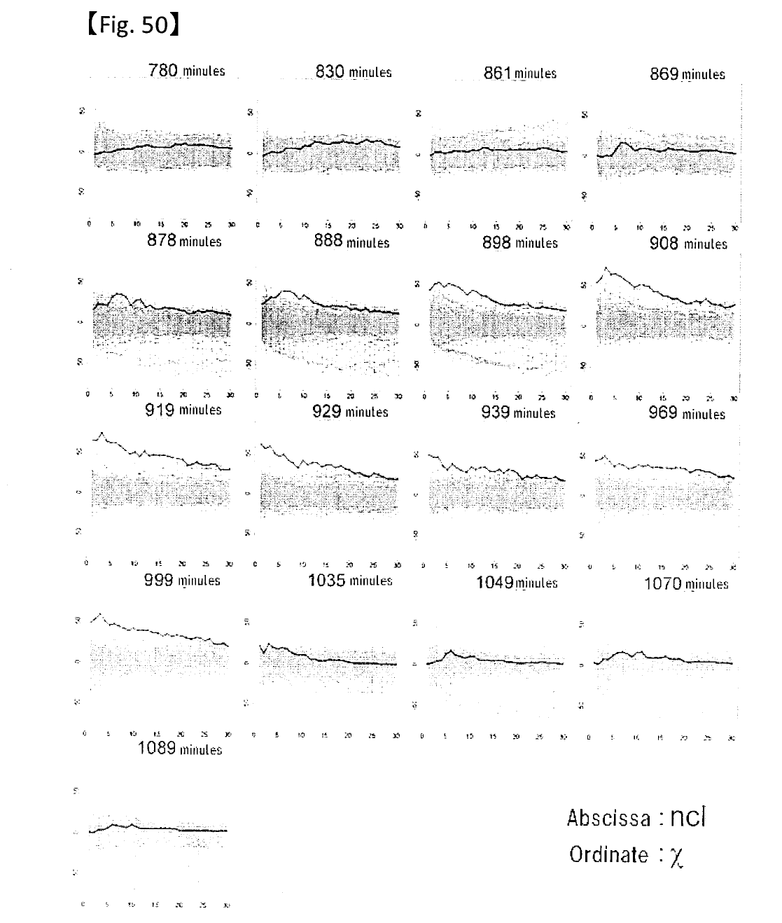

The index c of each virtual gene cluster was calculated according to the calculation formula b) from the DNA microarray data sets of 17 stages after the start of culture of the E. coli MG1655 strain (FIG. 50). In this drawing, one gray line is drawn per group of the virtual gene clusters, and each heavy black line represents a gene cluster group having, as a starting point, the first gene lacA (b0342) on the genomic information on the four genes constituting the lactose operon. This gene cluster group exhibited a gradual rise in value with increase in culture time from the system of 869 minutes and exhibited a global maximum in the systems of 908 and 919 minutes, among the virtual gene clusters having a local maximum. The local maximum was exhibited at a cluster size of 3 consisting of lacZYA. This gene cluster contained no lacI. This is consistent with the fact that lad is constantly expressed, regardless of lactose operon expression.

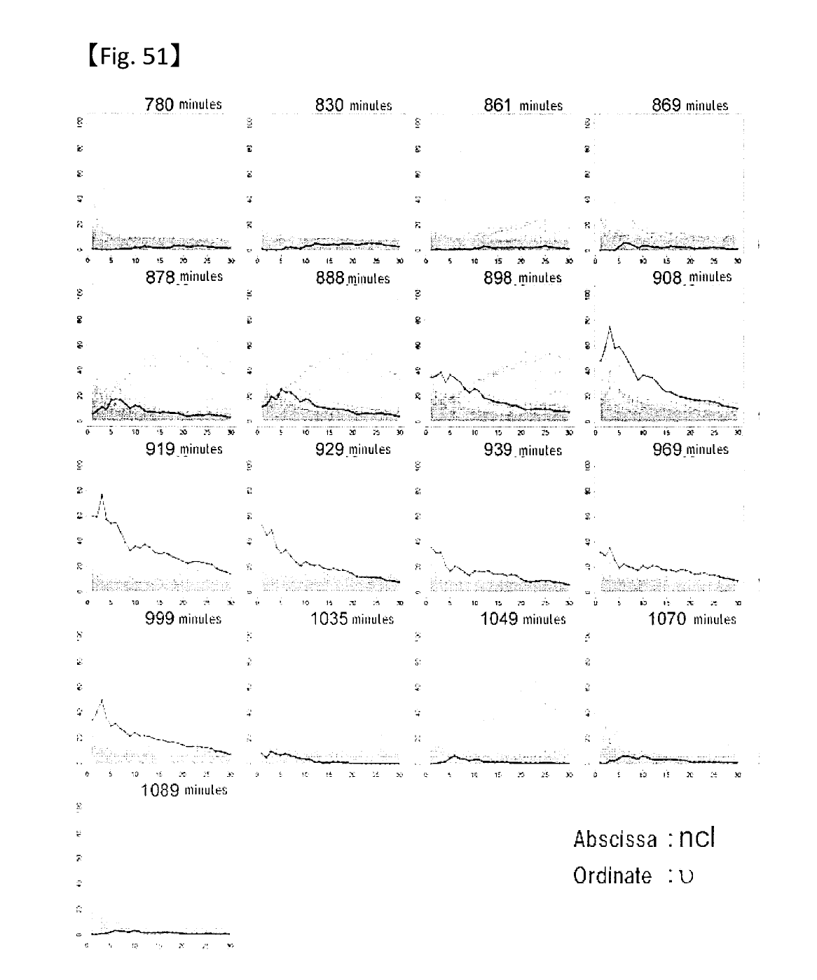

Next, similarly, the index u of each virtual gene cluster was calculated according to the calculation formula c) as to each of the 17 systems (FIG. 51). In this context, 2 was adopted as the number d′ of dimensions, while 1 was adopted as a coefficient a. In this drawing, each group of gene clusters indicated by heavy black line, which had lacA (b0342) as a starting point, exhibited a gradual rise in value with increase in culture time from the system of 869 minutes and exhibited a global maximum at a cluster size of 3 in the systems of 908 and 919 minutes, among the virtual gene clusters having a local maximum, as in the c value. This is consistent with the fact that the set of genes lacZYA involved in lactose metabolism is expressed when the lactose metabolic system starts to work after depletion of glucose. At this stage, the difference of the heavy black line from other gray lines is greater than that of FIG. 50. These results demonstrated that the gene cluster concerned can be ranked more highly using the index u than the index c.

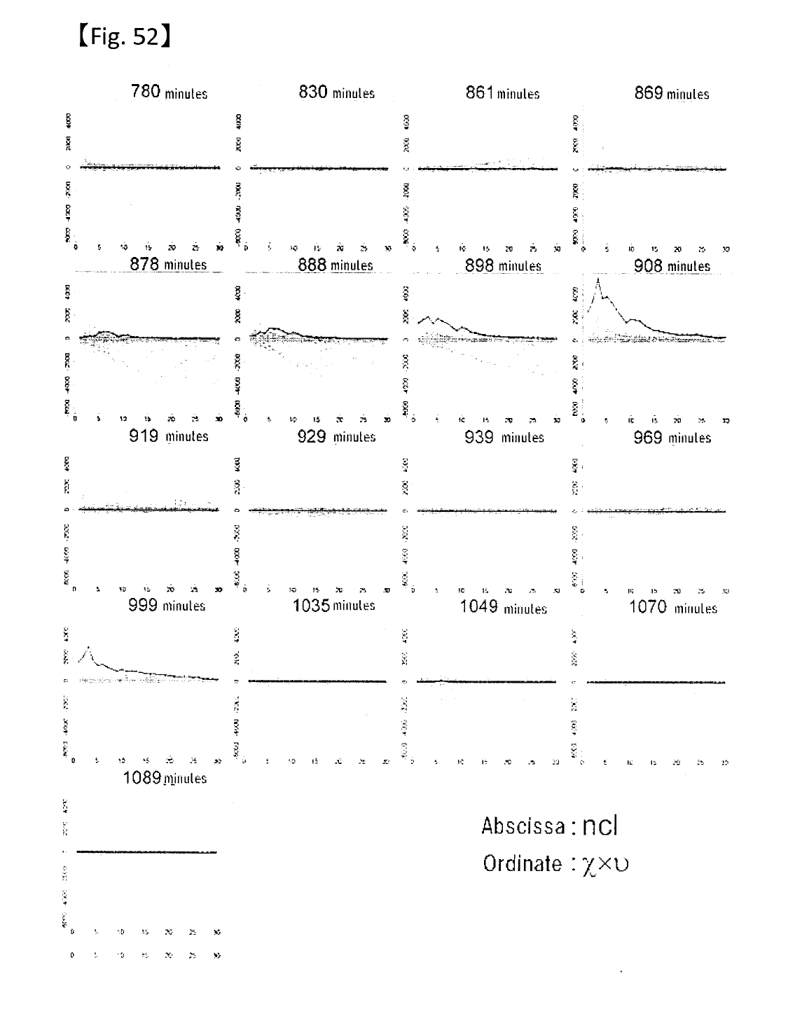

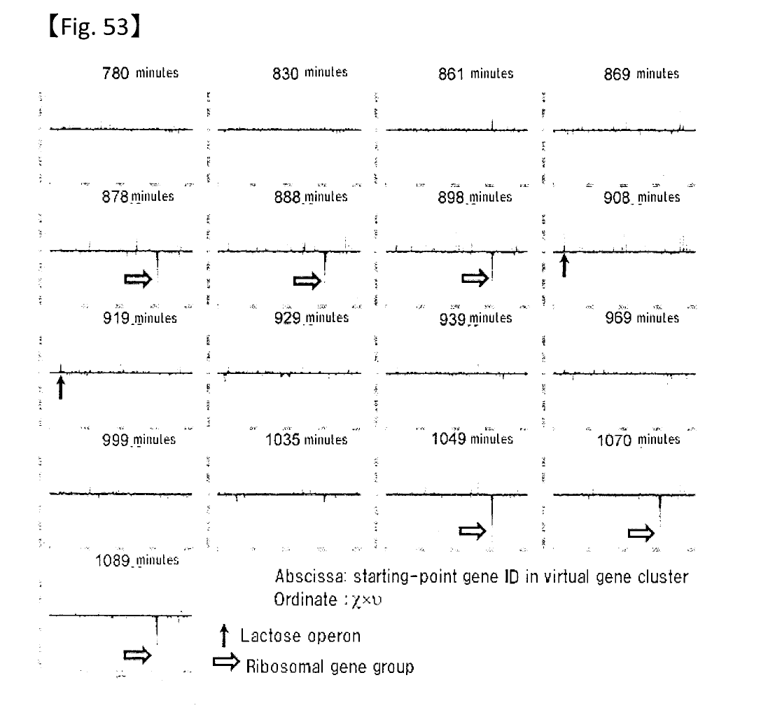

On the basis of the c and u values thus obtained, an estimate c′u for assessing each gene cluster was calculated according to the calculation formula d) from the product of these two values (FIG. 52). In the system of 908 minutes, this estimate was shown to more sensitively detect lacZYA indicated by heavy black line than the c or u value alone (FIG. 50 or 51). FIG. 53 is a diagram showing starting-point gene ID on the abscissa plotted against the largest estimate c′u among 30 virtual gene clusters with ncl=1 to 30 at each starting-point gene ID. Scales on the ordinates of diagrams were equalized among the 17 systems. The lactose operon indicated by filled arrow exhibited the largest value in the system of 908 minutes. The set of ribosomal genes indicated by open arrow strongly exhibited a negative value in the systems of 878, 888, 898, 1049, 1070, and 1089 minutes at which a plateau in growth occurred. These results demonstrated that the present estimate was capable of accurately detecting, according to the state of cells, a set of genes that function as an assembly on the genome.

The results described above demonstrated that the method proposed by the present invention is effective for detecting a set of genes that function as an assembly on the genome, using not only in eukaryotes but also in prokaryotes.

### (Reference 10)

The lactose repressor system: paradigms for regulation, allosteric behavior and protein folding
C. J. Wilson et al., Cellular and Molecular Life Sciences (2007) 64, 3-16

### (Reference 11)

Gene expression profiling of Escherichia coli growth transitions: an expanded stringent response model
Dong-Eun Chang et al., Molecular Microbiology (2002) 45 (2), 289-306

### (Reference 12)

Guanosine 3′,5′-bispyrophosphate coordinates global gene expression during glucose-lactose diauxie in Escherichia coli
Matthew F. Traxler et al., Proceedings of the National Academy of Sciences (2006) 103 (7), 2374-2379

### (Reference 13)

Control of protein synthesis in Escherichia coli. II. Translation and degradation of lactose operon messenger ribonucleic acid after energy source shift-down
K. C. Westover et al., Journal of Biological Chemistry (1974) 249 (19), 6280-6287

1. A method of searching for a gene cluster containing a target gene and/or the target gene in the gene cluster in the genome of an organism, the method comprising:
individually scoring virtual gene cluster units, each comprising two or more genes arranged on the genomic DNA, by summing respective expression level fold changes of genomic genes caused between, under a condition involving a change in physiological state of organism cells and under a control condition; and
on the basis of obtained scores, searching for a gene cluster comprising a target gene, which is a causative gene of the change in the physiological state, and/or the target gene in the gene cluster.

2. The method according to claim 1, wherein one or more comparison condition sets is established, each of which involves the condition involving a change in the physiological state of organism cells and the control condition.

3. The method according to claim 2, wherein a comparison condition set involves at least a metabolite production inducing condition and a non-inducing condition or a metabolite production inhibiting condition and a non-inhibiting condition as the condition involving a change in the physiological state and the control condition, respectively.

4. The method according to claim 3, wherein the gene involved in metabolite production is a gene involved in secondary metabolite production.

5. The method according to claim 1, wherein the virtual gene clusters comprise, respectively, sets of genes extracted such that the number of genes is increased one by one from two consecutive genes on the genomic DNA until reaching the maximum possible number of genomic genes contained in a gene cluster and such that, with respect to each of the numbers of genes to be extracted, a starting point of the extraction is shifted one by one from a gene at one end of linear genomic DNA or from any gene in circular genomic DNA, in the order in which the genes are arranged on the genomic DNA.

6. The method according to claim 1, wherein an assembly of the virtual gene clusters to be scored comprises virtual gene clusters comprising, respectively, sets of genes extracted such that the number of genes is increased one by one from two consecutive genes on the genomic DNA until reaching the maximum possible number of genomic genes contained in a gene cluster and such that, with respect to each of the numbers of genes to be extracted, a starting point of the extraction is shifted one by one from a gene at one end of linear genomic DNA or from any gene in circular genomic DNA, in the order in which the genes are arranged on the genomic DNA, wherein the virtual gene cluster assembly comprises all gene clusters present on the genome.

7. The method according to claim 1, wherein the scoring of the virtual gene clusters is according to the following calculation formula a):
Calculation formula a)
$$M = Σ \frac{m - \overline{m}}{σ ( m )}$$
wherein M represents the score of each virtual gene cluster; m represents the expression level fold change of each gene contained in each virtual gene cluster to be scored; m̅ represents an average of the expression level fold changes (m values) of all genes contained in all virtual gene clusters; and σ(m) represents a standard deviation of the expression level fold changes (m values) of all genes contained in all virtual gene clusters.

8. The method according to claim 7, wherein when any of the genes arranged on the genomic DNA is presumed to have a target gene function or presumed to have a little or no chance of having a target gene function, the following weighted calculation is applied to the gene concerned:
$$w \frac{m - \overline{m}}{σ ( m )}$$
wherein m represents the expression level fold change of the gene on the genomic DNA presumed to have a target gene function or presumed to have a little or no chance of having a target gene function; m̅ represents an average of the expression level fold changes (m values) of all genes contained in all virtual gene clusters; σ(m) represents a standard deviation of the expression level fold changes (m values) of all genes contained in all virtual gene clusters; and w represents any real number as a weight.

9. The method according to claim 8, wherein when any of the genes arranged on the genomic DNA is presumed to have a target gene function, virtual gene clusters each containing the gene presumed to have a target gene function are picked out and only the picked-out virtual gene clusters are scored.

10. The method according to claim 9, wherein the virtual gene clusters are constructed from only genes in one or more of the following groups 1) to 3) or from one or more type of genes including at least the genes, on the condition that the genes in each gene cluster reside in the vicinity on the genome:
1) genes of enzymes belonging to an enzyme class putatively involved in secondary metabolite production;
2) transporter genes; and
3) transcription factor-encoding genes.

11. The method according to claim 10, wherein the scoring of the virtual gene clusters is performed according to the following calculation formula a):
Calculation formula a)
$$M = Σ \frac{m - \overline{m}}{σ ( m )}$$
wherein M represents the score of each virtual gene cluster; m represents the expression level fold change of each gene selected by annotation assignment, contained in each virtual gene cluster to be scored; m̅ represents an average of the expression level fold changes (m values) of all genes selected by annotation assignment, contained in all virtual gene clusters; and σ(m) represents a standard deviation of the expression level fold changes (m values) of all genes selected by annotation assignment, contained in all virtual gene clusters.

12. The method according to claim 1, wherein virtual gene clusters each having a score diverging from the overall score distribution of the virtual gene clusters are selected as target gene cluster candidates.

13. The method according to claim 12, wherein an index I (χ) indicating the degree of divergence from the overall score distribution of the virtual gene clusters is calculated according to the following calculation formula b), and on the basis of the calculated index I (χ), virtual gene clusters are selected as target gene cluster candidates:
χ=−M log P Calculation formula b)
wherein χ represents the index I indicating the degree of divergence of each virtual gene cluster; M represents the score of each virtual gene cluster; and P represents the frequency of appearance of each score M, wherein the cumulative total frequency of appearance of scores M is defined as 1 in the frequency distribution of the scores of all virtual gene clusters.

14. The method according to claim 12, wherein an index II (υ) indicating the degree of divergence from the overall score distribution of the virtual gene clusters is calculated according to the following calculation formula c), and on the basis of the calculated index II (υ), virtual gene clusters are selected as target gene cluster candidates:
υ=(M− M̅)^{d′}/(ασ(M))^{d′} Calculation formula c)
wherein υ represents the index II indicating the degree of divergence of each virtual gene cluster; M represents the score of each virtual gene cluster; M̅ represents an average of the scores (M values) of all virtual gene clusters; σ(M) represents a standard deviation of the scores (M values) of all virtual gene clusters; a represents any positive real number; and d′ represents the positive even number of dimensions.

15. The method according to claim 13, wherein on the basis of calculation results according to the following calculation formula d), at least virtual clusters wherein b is less than 100 are excluded to further narrow down the target gene cluster candidates:
χ×υ>b Calculation formula d)
wherein χ represents the index I of each virtual gene cluster calculated according to the calculation formula b) described in claim 13; υ represents the index II of each virtual gene cluster calculated according to the calculation formula c) described in claim 14; and b represents any positive real number as a threshold.

16. A method comprising:
individually scoring virtual gene cluster units each comprising two or more genes arranged on a genomic DNA, by summing the respective expression level fold changes of genomic genes caused between under a condition involving a change in the physiological state of organism cells and under a control condition; and
on the basis of obtained scores, predicting the presence or absence of a target gene cluster in the genome or the gene size of the target gene cluster if present,
wherein:
the virtual gene clusters are scored according to the following calculation formula a), the virtual gene clusters comprising, respectively, sets of genes extracted such that the number of genes is increased one by one from two consecutive genes on the genomic DNA until reaching the maximum possible number of genomic genes contained in a gene cluster and such that, with respect to each of the numbers of genes to be extracted, a starting point of the extraction is shifted one by one from a gene at one end of linear genomic DNA or from any gene in circular genomic DNA, in the order in which the genes are arranged on the genomic DNA;
the respective scores of the virtual gene clusters thus obtained are grouped with respect to each of the numbers of genes contained in the gene clusters; a gene cluster score distribution index (ε) is determined with respect to each of the groups of the numbers of genes according to the following calculation formula e); and
the presence or absence of a preexisting target gene cluster in the genome or the gene size of the target cluster if present is predicted on the basis of the index:
Calculation formula a)
$$M = Σ \frac{m - \overline{m}}{σ ( m )}$$
wherein M represents the score of each virtual gene cluster; m represents the expression level fold change of each gene contained in each virtual gene cluster to be scored; m̅ represents an average of the expression level fold changes (m values) of all genes contained in all virtual gene clusters; and σ(m) represents a standard deviation of the expression level fold changes (m values) of all genes contained in all virtual gene clusters, and
ε=Σ(M− M̅)^{d}/nσ(M)^{d} Calculation formula e)
wherein ε represents a gene cluster score distribution index determined with respect to each of the numbers of genes; M represents the score of each virtual gene cluster contained in each group of the number of genes when all virtual gene clusters are grouped with respect to each of the numbers of genes; M̅ represents an average of the scores of all virtual gene clusters; n represents the total number of virtual gene clusters; σ(M) represents a standard deviation of the scores (M values) of all virtual gene clusters; and d represents the positive even number of dimensions arbitrarily set.

17. The method according to claim 16, wherein the E value when the number of genes is k (ε(k)) and the ε values when the number of genes is k plus one or minus one (ε(k−1) and ε(k+1)) satisfy the following relationship, the target gene cluster is confirmed to be present in the genome and the number of genes contained in the target gene cluster is estimated as k:
ε(k)>ε(k−1) and ε(k)>ε(k+1).

18. An apparatus for searching for a gene cluster containing a target gene and/or the target gene in the gene cluster in the genome of an organism, the apparatus comprising:
a) means for storing the respective expression level fold changes of genes arranged on the genomic DNA between under a condition involving a change in the physiological state of organism cells and under a control condition, the expression level fold changes being calculated on the basis of the expression level data set of the genes under these two conditions;
b) means for constructing virtual gene clusters by combining two or more genes arranged on the genomic DNA;
c) means for individually scoring the virtual gene cluster units each comprising two or more genes arranged on the genomic DNA, by summing the respective stored calculated expression level fold changes of the genes, and storing the respective scores of the virtual gene clusters; and
d) means for selecting, on the basis of the obtained scores, a gene cluster containing a target gene which is a causative gene of the change in the physiological state, or further comprising e) means for displaying the genes contained in the selected gene cluster.

19. The apparatus according to claim 18, wherein the expression level data is fluorescence intensity information obtained using a DNA microarray for gene expression level measurement.

20. The apparatus according to claim 19, wherein the fluorescence intensity information is numerical data output by a fluorescence intensity reader having means for reading out fluorescence intensity and converting the fluorescence intensity to a numerical value.

21. The apparatus according to claim 18, wherein one or more comparison condition set is established, each of which involves the condition involving a change in the physiological state of organism cells and the control condition, wherein the expression level data set of genes is input with respect to each of the conditions contained in the comparison condition set, and the expression level fold change of each same gene in the comparison condition set is calculated.

22. The apparatus according to claim 18, wherein the target gene is a gene involved in metabolite production.

23. The apparatus according to claim 22, wherein the gene involved in metabolite production is a gene involved in secondary metabolite production.

24. The apparatus according to claim 22, wherein the established comparison condition set involves at least a metabolite production inducing condition and a non-inducing condition or a metabolite production inhibiting condition and non-inhibiting condition.

25. The apparatus according to claim 24, wherein the metabolite is a secondary metabolite.

26. The apparatus according to claim 18, wherein the virtual gene cluster constructing means constructs virtual gene clusters comprising, respectively, sets of genes extracted such that the number of genes is increased one by one from two consecutive genes on the genomic DNA until reaching the maximum possible number of genomic genes contained in a gene cluster and such that, with respect to each of the numbers of genes to be extracted, a starting point of the extraction is shifted one by one from a gene at one end of linear genomic DNA or from any gene in circular genomic DNA, in the order in which the genes are arranged on the genomic DNA.

27. The apparatus according to claim 18, wherein the scoring of the virtual gene clusters is performed according to the following calculation formula a):
Calculation formula a)
$$M = Σ \frac{m - \overline{m}}{σ ( m )}$$
wherein M represents the score of each virtual gene cluster; m represents the expression level fold change of each gene contained in each virtual gene cluster to be scored; m̅ represents an average of the expression level fold changes (m values) of all genes contained in all virtual gene clusters; and σ(m) represents a standard deviation of the expression level fold changes (m values) of all genes contained in all virtual gene clusters.

28. The apparatus according to claim 27, further comprising an annotation assigning means for selecting particular genes from among the genes arranged on the genomic DNA, wherein in the scoring of the gene clusters, the respective expression level fold changes of genes selected on the basis of an assigned annotation are calculated according to the following weighted calculation formula:
$$w \frac{m - \overline{m}}{σ ( m )}$$
wherein m represents the expression level fold change of the gene on the genomic DNA presumed to have a target gene function or presumed to have a little or no chance of having a target gene function; m̅ represents an average of the expression level fold changes (m values) of all genes contained in all virtual gene clusters; σ(m) represents a standard deviation of the expression level fold changes (m values) of all genes contained in all virtual gene clusters; and w represents any real number as a weight.

29. The apparatus according to claim 28, wherein the annotation assigning means assigns an annotation differing depending on the type of each gene function.

30. The apparatus according to claim 29, wherein the genes selected on the basis of an annotation are genes in one or more of the following groups 1) to 3):
1) genes of enzymes belonging to an enzyme class putatively involved in secondary metabolite production;
2) transporter genes; and
3) transcription factor-encoding genes.

31. The apparatus according to claim 27, wherein the apparatus further has an annotation assigning means and means for picking out, from the constructed virtual gene clusters, virtual gene clusters containing the genes selected on the basis of an annotation, and only the picked-out virtual gene clusters are scored,
wherein the annotation assigning means is an assigning means for selecting particular genes from among the genes arranged on the genomic DNA, wherein in the scoring of the gene clusters, the respective expression level fold changes of genes selected on the basis of an assigned annotation are calculated according to the following weighted calculation formula:
$$w \frac{m - \overline{m}}{σ ( m )}$$
wherein m represents the expression level fold change of the gene on the genomic DNA presumed to have a target gene function or presumed to have a little or no chance of having a target gene function; m̅ represents an average of the expression level fold changes (m values) of all genes contained in all virtual gene clusters; σ(m) represents a standard deviation of the expression level fold changes (m values) of all genes contained in all virtual gene clusters; and w represents any real number as a weight.

32. The apparatus according to claim 18, further comprising an annotation assigning means for selecting particular genes from among the genes arranged on the genomic DNA, wherein the virtual gene cluster constructing means constructs the virtual gene clusters from only genes selected on the basis of an annotation or from one or more type(s) of genes including at least the genes, on the condition that the genes in each gene cluster are positioned in the vicinity on the genomic DNA.

33. The apparatus according to claim 32, wherein the annotation assigning means assigns an annotation according to the type of each gene function.

34. The apparatus according to claim 33, wherein the genes selected on the basis of an annotation are genes in one or more of the following groups 1) to 3):
1) genes of enzymes belonging to an enzyme class putatively involved in secondary metabolite production;
2) transporter genes; and
3) transcription factor-encoding genes.

35. The apparatus according to claim 32, wherein the scoring of the virtual gene clusters is performed according to the following calculation formula a):
Calculation formula a)
$$M = Σ \frac{m - \overline{m}}{σ ( m )}$$
wherein M represents the score of each virtual gene cluster; m represents the expression level fold change of each gene selected by annotation assignment, contained in each virtual gene cluster to be scored; m̅ represents an average of the expression level fold changes (m values) of all genes selected by annotation assignment, contained in all virtual gene clusters; and σ(m) represents a standard deviation of the expression level fold changes (m values) of all genes selected by annotation assignment, contained in all virtual gene clusters.

36. The apparatus according to claim 18, further comprising means for selecting, as target gene cluster candidates, virtual gene clusters each having a score diverging from the overall score distribution of the virtual gene clusters.

37. The apparatus according to claim 36, wherein the apparatus stores, as the target gene cluster candidate selecting means, a program of calculating an index I (χ) indicating the degree of divergence from the overall score distribution of the virtual gene clusters according to the following calculation formula b):
χ=−M log P Calculation formula b)
wherein χ represents the index I indicating the degree of divergence of each virtual gene cluster; M represents the score of each virtual gene cluster; and P represents the frequency of appearance of each score M, wherein the cumulative total frequency of appearance of scores M is defined as 1 in the frequency distribution of the scores of all virtual gene clusters.

38. The apparatus according to claim 37, wherein the apparatus stores, as the target gene cluster candidate selecting means, a program of calculating an index II (υ) indicating the degree of divergence from the overall score distribution of the gene clusters according to the following calculation formula c):
υ=(M− M̅)^{d′}/(ασ(M))^{d′} Calculation formula c)
wherein υ represents the index II indicating the degree of divergence of each virtual gene cluster; M represents the score of each virtual gene cluster; M̅ represents an average of the scores (M values) of all virtual gene clusters; σ(M) represents a standard deviation of the scores (M values) of all virtual gene clusters; a represents any positive real number; and d′ represents the positive even number of dimensions.

39. The apparatus according to claim 37, wherein the apparatus stores a program of further narrowing down the target gene cluster candidates by excluding at least virtual clusters wherein b is less than 100 on the basis of calculation results according to the following calculation formula d):
χ×υ>b Calculation formula d)
wherein χ represents the index I of each virtual gene cluster calculated according to the calculation formula b) described in claim 37; υ represents the index II of each virtual gene cluster calculated according to the calculation formula c) described in claim 38; and b represents any positive real number as a threshold.

40. An apparatus for predicting the presence or absence of a target gene cluster in the genome or the gene size of the target gene cluster if present from a gene cluster distribution index (ε), the apparatus comprising:
a) means for inputting the respective expression levels of genes arranged on the genomic DNA, the expression levels being obtained under a condition involving a change in the physiological state of organism cells and under a control condition;
b) an expression level fold change calculating means for calculating the ratio between the input expression levels of each same gene under these two conditions;
c) means for individually scoring virtual gene cluster units each comprising two or more genes arranged on the genomic DNA, by summing the respective calculated expression level fold changes of the genes; and
d) means for calculating a gene cluster distribution index (ε) with respect to each of the numbers of genes contained in the gene clusters, from the obtained scores of the virtual gene clusters,
wherein:
the apparatus further comprises means for constructing virtual gene clusters wherein the virtual gene clusters comprises, respectively, sets of genes extracted such that the number of genes is increased one by one from two consecutive genes on the genomic DNA until reaching the maximum possible number of genomic genes contained in a gene cluster and such that, with respect to each of the numbers of genes to be extracted, a starting point of the extraction is shifted one by one from a gene at one end of linear genomic DNA or from any gene in circular genomic DNA, in the order in which the genes are arranged on the genomic DNA;
the virtual gene cluster unit scoring means comprises an operational unit based on the following calculation formula a); and the gene cluster distribution index (6) calculating means is based on the following calculation formula e):
Calculation formula a)
$$M = Σ \frac{m - \overline{m}}{σ ( m )}$$
wherein M represents the score of each virtual gene cluster; m represents the expression level fold change of each gene contained in each virtual gene cluster to be scored; m̅ represents an average of the expression level fold changes (m values) of all genes contained in all virtual gene clusters; and σ(m) represents a standard deviation of the expression level fold changes (m values) of all genes contained in all virtual gene clusters, and
ε=Σ(M− M̅)^{d}/nσ(M)^{d} Calculation formula e)
wherein εrepresents a gene cluster score distribution index determined with respect to each of the numbers of genes; M represents the score of each virtual gene cluster contained in each group of the number of genes when all virtual gene clusters are grouped with respect to each of the numbers of genes; M̅ represents an average of the scores of all virtual gene clusters; n represents the total number of virtual gene clusters; σ(M) represents a standard deviation of the scores (M values) of all virtual gene clusters; and d represents the positive even number of dimensions arbitrarily set.

41. The apparatus according to claim 40, wherein the gene cluster distribution index ε value when the number of genes is k (ε(k)) and the ε values when the number of genes is k plus one or minus one (ε(k−1) and ε(k+1)) satisfy the following relationship, the target gene cluster is confirmed to be present in the genome, to produce an output indicating that the number of genes contained in the target gene cluster is estimated as k:
ε(k)>ε(k−1) and ε(k)>ε(k+1).

42. A program executing a virtual gene cluster constructing means described in claim 26, comprising executing the following means 1) or 2) on the basis of the positional information set of the genomic genes:
1) in the case of linear genomic gene
a) means for constructing sets of genes, wherein a gene positioned at one end of the genomic DNA is designated as a starting point, and consecutive genes on the genomic DNA are combined such that the number of genes is increased one by one in a direction toward the other end from two until reaching the maximum possible number of genes contained in a gene cluster, to construct sets of genes, the sets of genes comprising the gene designated as a starting point and being different in the number of the genes, and
b) means for constructing virtual gene clusters, wherein the gene designated as a starting point is shifted one by one in a direction toward the other end while sets of genes comprising a new starting-point gene and being differ in the number of genes are constructed as same as the means a, and the constructed sets are combined with the sets of genes of the means a to construct virtual gene clusters consisting of sets of combined genes; or
2) in the case of circular genomic gene
means for sequentially performing the same process as the means 1)a and 1)b, wherein any gene on the genomic DNA is designated as a starting point, and the process is terminated when the gene designated as the initial starting point serves as a starting point again.

43. A virtual gene cluster scoring program for scoring virtual gene clusters constructed by a program according to claim 42, according to the following calculation formula a):
Calculation formula a)
$$M = Σ \frac{m - \overline{m}}{σ ( m )}$$
wherein M represents the score of each virtual gene cluster; m represents the expression level fold change of each gene contained in each virtual gene cluster to be scored; m̅ represents an average of the expression level fold changes (m values) of all genes contained in all virtual gene clusters; and σ(m) represents a standard deviation of the expression level fold changes (m values) of all genes contained in all virtual gene clusters.

44. The scoring program according to claim 43, wherein in the scoring of the gene clusters, the respective expression level fold changes of genomic genes selected on the basis of an assigned annotation are calculated according to the following weighted calculation formula:
$$w \frac{m - \overline{m}}{σ ( m )}$$
wherein m represents the expression level fold change of the gene on the genomic DNA presumed to have a target gene function or presumed to have a little or no chance of having a target gene function; m̅ represents an average of the expression level fold changes (m values) of all genes contained in all virtual gene clusters; σ(m) represents a standard deviation of the expression level fold changes (m values) of all genes contained in all virtual gene clusters; and w represents any real number as a weight.

45. The scoring program according to claim 43, wherein the scoring program executes the scoring of the gene clusters by:
selecting genomic genes on the basis of an assigned annotation; picking out, from the constructed gene clusters, virtual gene clusters containing the selected genomic genes; and
scoring only the picked-out virtual gene clusters.

46. A program executing a virtual gene cluster constructing means described in claim 32, wherein the program constructs virtual gene clusters from only genes selected on the basis of an annotation or from one or more type(s) of genes including at least the genes, on the condition that the genes in each gene cluster are positioned in the vicinity on the genomic DNA.

47. A virtual gene cluster scoring program for scoring virtual gene clusters constructed by a program according to claim 46, according to the following calculation formula a):
Calculation formula a)
$$M = Σ \frac{m - \overline{m}}{σ ( m )}$$
wherein M represents the score of each virtual gene cluster; m represents the expression level fold change of each gene selected by annotation assignment, contained in each virtual gene cluster to be scored; m̅ represents an average of the expression level fold changes (m values) of all genes selected by annotation assignment, contained in all virtual gene clusters; and σ(m) represents a standard deviation of the expression level fold changes (m values) of all genes selected by annotation assignment, contained in all virtual gene clusters.

48. A program for calculating the degree of divergence of the score of each virtual gene cluster calculated by a scoring program according to claim 43 from the overall score distribution of the virtual gene clusters, wherein the program calculates an index I (χ) according to the following calculation formula b):
χ=−M log P Calculation formula b)
wherein χ represents the index I indicating the degree of divergence of each virtual gene cluster; M represents the score of each virtual gene cluster; and P represents the frequency of appearance of each score M, wherein the cumulative total frequency of appearance of scores M is defined as 1 in the frequency distribution of the scores of all virtual gene clusters.

49. A program for calculating the degree of divergence of the score of each virtual gene cluster calculated by a scoring program according to claim 43 from the overall score distribution of the virtual gene clusters, wherein the program calculates an index II (υ) according to the following calculation formula c):
υ=(M− M̅)^{d′}/(ασ(M))^{d′} Calculation formula c)
wherein υ represents the index II indicating the degree of divergence of each virtual gene cluster; M represents the score of each virtual gene cluster; M̅ represents an average of the scores (M values) of all virtual gene clusters; σ(M) represents a standard deviation of the scores (M values) of all virtual gene clusters; a represents any positive real number; and d′ represents the positive even number of dimensions.

50. A program for individually scoring virtual gene cluster units each comprising two or more genes arranged on the genomic DNA, by summing the respective expression level fold changes of genomic genes caused between under a condition involving a change in the physiological state of organism cells and under a control condition, and means for calculating, on the basis of the obtained scores of the hypothetic gene clusters, a gene cluster distribution index (ε) with respect to each of the numbers of genes contained in the gene clusters and predicting the presence or absence of a target gene cluster in the genome or the gene size of the target gene cluster if present from the gene cluster distribution index (ε),
wherein the program executes at least the following means (A) to (C):
(A) means for constructing virtual gene clusters by the following means 1) or 2) on the basis of the positional information set of the genomic genes:
1) in the case of linear genomic gene
a) means for constructing sets of genes, wherein a gene positioned at one end of the genomic DNA is designated as a starting point, and consecutive genes on the genomic DNA are combined such that the number of genes is increased one by one in a direction toward the other end from two until reaching the maximum possible number of genes contained in a gene cluster, to construct sets of genes, the sets of genes comprising the gene designated as a starting point and being different in the number of the genes, and
b) means for constructing virtual gene clusters, wherein the gene designated as a starting point is shifted one by one in a direction toward the other end while sets of genes comprising a new starting-point gene and being differ in the number of genes are constructed as same as means a, and the constructed sets are combined with the sets of genes of the means a to construct virtual gene clusters consisting of sets of combined genes; or
2) in the case of circular genomic gene
means for sequentially performing the same process as the means 1)a and 1)b, wherein any gene on the genomic DNA is designated as a starting point, and the process is terminated when the gene designated as the initial starting point serves as a starting point again;
(B) means for individually scoring the virtual gene clusters constructed by the unit (A) according to the following calculation formula a):
Calculation formula a)
$$M = Σ \frac{m - \overline{m}}{σ ( m )}$$
wherein M represents the score of each virtual gene cluster; m represents the expression level fold change of each gene contained in each virtual gene cluster to be scored; m̅ represents an average of the expression level fold changes (m values) of all genes contained in all virtual gene clusters; and σ(m) represents a standard deviation of the expression level fold changes (m values) of all genes contained in all virtual gene clusters; and
(C) means for calculating a gene cluster distribution index (ε) with respect to each of the numbers of genes contained in the virtual gene clusters according to the following calculation formula e) from the scores of the virtual gene clusters obtained by the means (B):
ε=Σ(M− M̅)^{d}/nσ(M)^{d} Calculation formula e)
wherein ε represents a gene cluster score distribution index determined with respect to each of the numbers of genes; M represents the score of each virtual gene cluster contained in each group of the number of genes when all virtual gene clusters are grouped with respect to each of the numbers of genes; M̅ represents an average of the scores of all virtual gene clusters; n represents the total number of virtual gene clusters; a (M) represents a standard deviation of the scores (M values) of all virtual gene clusters; and d represents the positive even number of dimensions arbitrarily set.

51. The program according to claim 50, wherein when the gene cluster distribution index ε value when the number of genes is k (ε(k)) and the ε values when the number of genes is k plus one or minus one (ε(k−1) and ε(k+1)) satisfy the following relationship, the target gene cluster is confirmed to be present in the genome, to produce an output indicating that the number of genes contained in the target gene cluster is estimated as k:
ε(k)>ε(k−1) and ε(k)>ε(k+1).
